(19) United States
(12) Patent Application Publication
(10) Pub. No.: US 2006/0172429 A1
(43) Pub. Date: Aug. 3, 2006

(54) Methods of identification of biomarkers with mass spectrometry techniques

(76) Inventors: Erik Jonathan Nilsson, Seattle, WA (US); Brian Stephens Pratt, Seattle, WA (US); Bryan Joseph Prazen, Seattle, WA (US)

Correspondence Address: WILSON SONSINI GOODRICH & ROSATI, 650 PAGE MILL ROAD, PALO ALTO, CA, 94304-1050, US

(21) Appl. No.: 11/345,612

(22) Filed: Jan. 31, 2006

Related U.S. Application Data
(60) Provisional application No. 60/648,987, filed on Jan. 31, 2005.

(51) Int. Cl. G01N 24/00

(52) U.S. Cl. 436/71

(57) ABSTRACT

The present invention provides methods for identifying various biological states. Methods for diagnosis of diseases, in particular cardiovascular and brain diseases, are provided herein. One aspect of the invention is the analysis of lipoprotein complexes with summary survey scan mass spectrum for the analysis of biological states. Another aspect of the invention is the use of matrix assisted laser desorption ionization (MALDI) mass spectrometer to analysis lipoprotein complexes for the diagnosis of cardiovascular and brain diseases. Yet another aspect of the invention is a method of diagnosis of brain diseases by evaluating the characteristics of lipoprotein complexes.

### CROSS-REFERENCE

This application claims the benefit of U.S. Provisional Application No. 60/648,987, filed Jan. 31, 2005, which is incorporated herein by reference in its entirety.

### STATEMENT AS TO FEDERALLY SPONSORED RESEARCH

This invention was made with the support of the United States government under grant numbers 1R43HL079807-01 and 1R43GM071271-01 by National Institute of Health and grant number DMI-0320427 from National Science Foundation.

### BACKGROUND OF THE INVENTION

Coronary artery disease (CAD) poses a significant health risk to the population. Afflicting 13 million Americans, CAD, a subset of cardiovascular disease, is responsible for half a million US deaths each year. CAD occurs when atherosclerosis of the coronary arteries decreases oxygen supply to the heart. The reduced oxygen supply can cause a heart attack. Over time, CAD can weaken the heart muscle, contributing to heart failure. Because CAD is a problem for an increasingly large number of people, detection of CAD is of particular interest to researchers and as well as general medical practitioners. Other diseases for which suitable diagnostics are lacking include brain disease and metabolic diseases. Low cost and expedient analysis and classification of biological sample data as healthy or diseased will benefit a large group of people.

### SUMMARY OF THE INVENTION

The present invention provides methods for identifying biological states, in particular for the diagnosis, prognosis, and prediction of diseases. The methods are preferably for cardiovascular and brain diseases, but are suitable for several other diseases. In preferred embodiments, the methods are performed with lipoprotein complex fractions from blood, serum, plasma, or other suitable biological samples. Preferably, the lipoprotein complexes are analyzed with mass spectrometer. Preferred mass spectrometer techniques are survey scan mass spectrum and assisted laser desorption ionization (MALDI). Typically, the levels of one or more lipoproteins are analyzed and/or one or more characteristic of a lipoprotein is analysed.

One aspect of the invention is a method of identifying a biomarker pattern for a biological state comprising obtaining a biological sample, said biological sample obtained from a subject in a first biological state; running said biological sample through a mass spectrometer, wherein said mass spectrometer collects survey mass spectra; summarizing two or more survey mass spectra from said run to obtain a summary survey scan mass spectrum; performing pattern recognition on said summary survey scan mass spectrum to identify a biomarker pattern; wherein said biomarker pattern is suitable for distinguishing said first biological state. Preferred biological states being evaluated include a disease state or a precursor to a disease state. The mass spectrometer is preferably run in survey and/or tandem mode. Also, further analysis of the biological sample can be further performed with MALDI. Typically, the pattern recognition information is used to identify a protein from said biomarker pattern. This identification of proteins can be performed with tandem mass spectrometer or accurate mass tags. The identified biomarker pattern and/or the identified proteins can be used for the diagnosis of disease states. Protein identification is preferably performed with an immunoassay. Suitable biological samples include blood, blood serum, blood plasma, or cerebrospinal fluid. Preferred fractions of the biological samples include a lipoprotein fraction. The lipoprotein fraction is typically digested, for example with one or more enzymes, prior to running through said mass spectrometer. Biological states that are studies include a cardiovascular disease or a brain disease. Cardiovascular diseases include for example, atherosclerosis, coronary artery disease, peripheral artery disease, myocardial infarction, heart failure, or stroke. Brain diseases include for example, Alzheimer's disease, Parkinson's disease, glioma, medulloblastoma, neuronal cancer, glial cancer, or glioblastoma.

Yet another aspect of the invention is methods for the diagnosis of cardiovascular diseases. One embodiment is a method of diagnosing a cardiovascular disease comprising evaluating a characteristic of a lipoprotein complex fraction of a biological sample and diagnosing a cardiovascular disease, wherein said diagnosis is based on said characteristic of said lipoprotein complex. Yet another embodiment is a method of diagnosing a cardiovascular disease comprising evaluating a characteristic of a lipoprotein complex fraction of a biological sample from a subject, said evaluation comprising running said biological sample through a by matrix assisted laser desorption ionization (MALDI) mass spectrometer to obtain a mass spectrum and performing pattern recognition on said mass spectrum to obtain a biomarker pattern for said characteristic of said lipoprotein complex and diagnosing a cardiovascular disease, wherein said diagnosis is based on said biomarker pattern. Preferably, the cardiovascular disease is a predisposition to a myocardial infarction, a stroke, or an atherosclerotic lesion. The diagnosis can also comprise a prediction of a potential response to a therapeutic intervention. Characteristics of lipoprotein that are evaluated include an oxidative state of the lipoprotein complex or a pattern of peptides present on the lipoprotein complex. The lipoprotein complex can be a high density lipoprotein, a very high density lipoprotein, a chylomicron, and/or a low density lipoprotein.

Yet another aspect of the invention is a method of diagnosing a brain disease comprising evaluating a characteristic of a lipoprotein complex fraction of a biological sample and diagnosing a brain disease, wherein said diagnosis is based on said characteristic of said lipoprotein complex. The characteristic can be an oxidative state of said lipoprotein complex or a pattern of peptides present on said lipoprotein complex. Preferably, the an oxidative state of high density lipoprotein is evaluated. The evaluation of the lipoprotein complex fraction can be performed with an immunoassay, a protein chip, multiplexed immunoassay, complex detection with aptamers, or chromatographic separation with spectrophotometric detection. The brain disease diagnosed is preferably a cancer or a neurodegenerative disease. Neurodegenerative diseases include, but not limited to, Alzheimer's disease or Parkinson's disease. Brain cancers include, but are not limited to, glioma, medulloblastoma, neuronal cancer, glial cancer, glioblastoma. Preferred lipoprotein complexes analyzed include a high density lipoprotein, a very high density lipoprotein, and/or a low density lipoprotein. Preferably the evaluation of said lipoprotein complex fraction comprises running said lipoprotein complex fraction through a mass spectrometer, wherein said mass spectrometer is run in survey mode; summarizing two or more mass spectrum measurements from said survey run to obtain a summarized output spectrum; and performing pattern recognition on said summarized output spectrum to evaluate a characteristic of said lipoprotein complex. The evaluation of the lipoprotein complex fraction for the diagnosis of brain disease can be performed with MALDI.

A preferred embodiment of the invention is a method of identifying a cardiovascular disease state of a patient comprising extracting high density lipoprotein from a biological sample from a patient; running said high density lipoprotein through a mass spectrometer to obtain a mass spectrum; performing pattern recognition on said mass spectrum to identify a biomarker pattern; and identifying a cardiovascular state of said patient based on the identification of said biomarker pattern. The method can be used for prediction of the occurrence of a myocardial infarction, atherosclerosis, coronary artery disease, peripheral artery disease, myocardial infarction, heart failure, or stroke based on the identification of said biomarker pattern.

The invention includes diagnosis products for diagnosing disease states. Another aspect is a computer-readable medium comprising a medium suitable for transmission of a result of an analysis of a biological sample; said medium comprising information regarding a state of a subject, wherein said information is derived using one or more methods described herein. Yet another aspect of the invention is the diagnosis of patients performed by health care providers. In some embodiments, a health care provider review information obtained with one or more techniques described herein and provides a diagnosis based on this information to the patient, a health care provider, a health care manager, or an insurance company.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a flow diagram for summarizing a measurement, according to one embodiment of the invention.

FIG. 2 illustrates a flow diagram for summarizing a mass spectrometer survey scan, according to one embodiment of the invention.

FIG. 3 illustrates a flow diagram for summarizing a MudPIT proteomics measurement, according to one embodiment of the invention.

FIG. 4 illustrates a flow diagram to resolve more than two classes utilizing pattern recognition, according to one embodiment of the invention.

FIG. 5 illustrates a flow diagram to process and analyze blood samples according to various embodiments of the invention.

FIG. 6 displays a summarized mass spectrometer survey scan data set, according to one embodiment of the invention.

FIG. 7 displays a regression vector related to the data shown in FIG. 6.

FIG. 8 shows a result of applying pattern recognition to the data of FIG. 6 utilizing principal component (PCA) analysis, according to one embodiment.

FIG. 9 shows a result of applying pattern recognition to the data of FIG. 6 utilizing partial least squares (PLS) analysis according, to one embodiment.

FIG. 10 shows a result of applying pattern recognition to the data of FIG. 6 according to one embodiment.

FIG. 11 shows identification of three classes from a data set using principal component (PCA) pattern recognition analysis, according to one embodiment.

FIG. 12 shows a calibration vector for a partial least squares (PLS) pattern recognition analysis of the data of FIG. 11.

FIG. 13 shows identification of three classes from the data of FIG. 11 using a partial least squares (PLS) pattern recognition analysis, according to one embodiment.

FIG. 14A-14E shows a list of proteins organized by their pattern of regulation, according to one embodiment.

FIG. 15A-15J shows a list of proteins and the corresponding peptides representative of the data from FIG. 11, according to one embodiment.

FIG. 16A-16E shows a listing of the program used to produce the protein information, according to one embodiment.

FIG. 17 depicts a contour map showing survey scan mass spectra of a single reverse-phase HPLC separation of one sample.

FIG. 18 depicts a summary survey scan mass spectrum of a CAD sample. Summary survey scan mass spectra were created by combining the signals of SCX scans 2-10 across the entire HPLC chromatographic profile, to arrive at a single spectrum for each sample.

FIG. 19 depicts a PCA analysis of HDL samples. With just two principal components, CAD subjects on the lower right can be distinguished from the same CAD subjects after treatment with statins (left) or control subjects (center).

FIG. 20 depicts a PLS regression vector for the control sample class. A regression vector for each of the three classes is created during the PLS calibration step. The regression vectors have the same dimension as the summary survey scan mass spectra. The class of an unknown sample is predicted by multiplying the regression vectors by the summary survey scan mass spectrum of the unknown sample. If the spectrum multiplied by a regression vector of a class exceeds the decision value the unknown sample is considered a member of the given class.

FIG. 21 depicts a MALDI mass spectrum of an HDL sample.

FIG. 22 shows a 3D trace showing the total ion current survey scan chromatogram for a typical sample.

FIG. 23 depicts the 2D scores plot showing PCA result from the analysis of CAD samples and control samples. Each sample is represented by a single data point on a plot of this type. PCA determines whether the data cluster or self-organize into meaningful groups. The data sets are plotted according to the first two scores in the PCA model. PC2 separates the subjects with CVD from the healthy age- and sex-matched control classes. These classes are circled on the plots. This plot indicates that a difference between the classes is present in the data.

FIG. 24 shows PLS regression vector from the two-class (CAD and control) model. A regression vector for each of the classes is created during the PLS calibration step. The regression vectors have the same dimension as the summary survey scan mass spectra. The class of an unknown sample is predicted by multiplying the regression vectors by the summary survey scan mass spectra of the unknown sample. Large signals on the regression vectors indicate masses that are influential in determining the class of a sample. If the spectrum multiplied by a regression vector of a class exceeds the decision value the unknown sample is considered a member of the given class.

FIG. 25 shows a projection of the CAD samples after one year of treatment with statins onto the PCA model built with CAD and healthy control samples: A trend is shown where the post-treatment samples are closer to the control samples.

FIG. 26 depicts a PLS regression vector from the three class model containing CAD samples, healthy control samples and post-treatment CAD samples.

FIG. 27 depicts scores plot from PCA of 18 MALDI-MS spectra of trypsinized HDL isolated from control patients and patients with established CAD. The box containing stars depicts replicate spectra of a CAD sample.

FIG. 28 depicts PLS regression vector from the MALDI-MS two-class model containing CAD samples and healthy control samples.

FIG. 29 depicts projection of the CAD samples after one year of treatment with statins onto the PCA model built with CAD and healthy control samples. A trend is shown where the post-treatment samples are closer to the control samples than pre-treatment samples.

FIG. 30 depicts an apparatus suitable for use in the methods of the invention.

### DETAILED DESCRIPTION OF THE INVENTION

In one aspect, the present invention provides methods for identifying biological states, including the diagnosis of disease states. These methods involve the detection, analysis, and classification of biological patterns in biological samples. Biological patterns are typically composed of signals from markers such as, but not limited to, proteins, peptides, protein fragments, small molecules, sugars, lipids, fatty acids, or any other component found in a biological sample. The signals from the markers could be the presence or absence of the marker, level of the marker, and/or one or more characteristics of the marker. A characteristic of a marker is typically due to one ore more physical and/or chemical properties of a marker. Examples of characteristics of markers include, but are not limited to, oxidative state, interaction with other entities, such as carbohydrates and/or proteins, and different modifications of the entities, such as glycosylation. The term “protein” as used herein refers to an organic compound comprising two or more amino acids covalently joined by peptide bonds. Proteins include, but are not limited to, peptides, oligopeptides, glycosylated peptides, and polypeptides. The biological patterns used in the present invention are typically patterns of markers. Preferably, the markers identified and used in the present invention used to study cardiovascular states and brain states. The terms “markers” and “biomarkers” are used herein interchangeably. It is preferred that the biomarkers comprise one or more proteins. The method comprises detecting one or more biomarker and preferably detecting a pattern of biomarkers. Preferably the number of markers in these patterns can be one, more than about 5, more preferably more than about 25, even more preferably more than about 45, and even more preferably more than about 100.

The term “biological state” is used herein to refer to the condition of a biological environment. Typically, a “biological state” is the result of the occurrence of a series of biological processes. The biological processes of the biological state are influenced according to some biological mechanism by one or more other biological processes in the biological state. As the biological processes change relative to each other, the biological state also undergoes changes. One measurement of a state is the relationship of a collection of cellular constituents to each other or to a standard. Biological states, as referred to herein, are well known in the art. Biological states depend on various biological mechanisms by which the biological processes influence one another. A biological state can include the state of an individual cell, an organ, a tissue, and a multi-cellular organism. A biological state can also include the state of a nutrient or hormone concentration in the plasma, interstitial fluid, intracellular fluid, or cerebrospinal fluid; e.g. the states of hypoglycemia or hypoinsulinemia are low blood sugar or low blood insulin. These conditions can be imposed experimentally, or may be conditions present in a patient type. A biological state can also include a “disease state,” which is taken to mean the result of the occurrence of a series of biological processes, wherein one or more of the biological processes of the state play a role in the cause or the symptoms of the disease. A disease state can be of a diseased cell, a diseased organ, a diseased tissue, or a diseased multi-cellular organism. Exemplary diseases include diabetes, asthma, obesity, and rheumatoid arthritis. A diseased multi-cellular organism can be an individual human patient, a specific group of human patients, or the general human population as a whole. A disease state can also include a state in which the subject has a predisposition to a particular disease. A biological state of interest also includes the state of various patient populations, prediction of treatment outcomes, and predisposition to diseases, such as cardiovascular diseases. Thus, the term diagnosis of disease or disease states as used herein is intended to include identifying the presence of a disease, prediction of the possible future occurrence of a disease, prognosis of a disease, potential seriousness of a disease, predicting the outcome of a disease, predicting the possible response to a therapeutic intervention, predict the recurrence of a disease, and determining whether an individual is responding to an ongoing therapeutic intervention. The methods disclosed herein are intended to be useful for diagnosis of any suitable disease. In particular diseases suitable for diagnosis with lipoprotein fractions can be diagnosed with the methods described herein.

The markers may be detected using any suitable conventional analytical technique including but not limited to, immunoassays, protein chips, multiplexed immunoassays, complex detection with aptamers, chromatographic separation with spectrophotometric detection and preferably mass spectroscopy. It is preferred when identifying—biological patterns—that the analysis uses—mass spectrometry systems. In some embodiments, the samples are prepared and separated with fluidic devices, preferably microfluidic devices, and delivered to the mass spectrometry system by electrospray ionization (ESI). In some embodiments, the delivery happens “on-line”, e.g. the separations device is directly interfaced to a mass spectrometer and the spectra are collected as fractions move from the column, through the ESI interface into the mass spectrometer. In other embodiments, fractions are collected from the separations device (e.g. “off-line”) and those fractions are later run using direct-infusion ESI mass spectrometry. In yet another embodiment, the samples are prepared and separated with fluidic devices, preferably microfluidic devices, and spotted on a MALDI plate for laser-desorption ionization.

The identification and analysis of markers, especially cardiovascular and brain disease markers, have numerous therapeutic and diagnostic purposes. Clinical applications include, for example, detection of disease; distinguishing disease states to inform prognosis, selection of therapy, and/or prediction of therapeutic response; disease staging; identification of disease processes; prediction of efficacy of therapy; monitoring of patients trajectories (e.g., prior to onset of disease); prediction of adverse response; monitoring of therapy associated efficacy and toxicity; prediction of probability of occurrence; recommendation for prophylactic measures; and detection of recurrence. Also, these markers can be used in assays to identify novel therapeutics. In addition, the markers can be used as targets for drugs and therapeutics, for example antibodies against the markers or fragments of the markers can be used as therapeutics. The present invention also includes therapeutic and prophylactic agents that target the biomarkers described herein. In addition, the markers can be used as drugs or therapeutics themselves.

The biological samples tested could be a biological fluid or tissue or cells. Biological fluids include but are not limited to serum, plasma, whole blood, nipple aspirate, pancreatic fluid, trabecular fluid, lung lavage, urine, cerebrospinal fluid, saliva, sweat, pericrevicular fluid, semen, prostatic fluid, pre-ejaculate fluid, nasal discharge, and tears.

One embodiment of the invention is a method for detection and diagnosis of cardiovascular disease comprising detecting at least one or more biomarkers described herein in a subject sample, and correlating the detection of one or more biomarkers with a diagnosis of a cardiovascular disease, wherein the correlation takes into account the detection of one or more biomarker in each diagnosis, as compared to normal subjects, wherein the biomarkers are selected from biomarkers depicted in Tables 1 and 2 below. In preferred methods, the step of correlating the measurement of the biomarkers with cardiovascular disease status is performed by a software algorithm. Preferably, the data generated is transformed into computer readable form; and an algorithm is executed that classifies the data according to user input parameters, for detecting signals that represent markers present in cardiovascular disease patients and are lacking or present at different levels in normal subjects.

Purified markers for screening and aiding in the diagnosis of cardiovascular diseases and/or generation of antibodies for further diagnostic assays are provided for. Purified markers are selected from the biomarkers of Tables 1 or 2.

The invention further provides for kits for aiding the diagnosis of cardiovascular disease, comprising at least one agent to detect the presence of one or more biomarkers, wherein the agent detects one or more biomarker selected from the biomarkers of Tables 1 and/or 2. Preferably, the kit comprises written instructions for use of the kit for detection of cardiovascular disease and the instructions provide for contacting a test sample with the agent and detecting one or more biomarkers retained by the agent. A kit for diagnosis could also include a computer readable medium with information regarding the patterns of biomarkers in normal and/or cardiovascular disease patients with or without instructions for the use of the information on the computer readable medium to diagnose cardiovascular diseases.

The invention described herein, is an approach to high-throughput analysis of protein samples. Proteins bound to HDL (high-density lipoprotein), are examined via multidimensional liquid chromatography tandem mass spectrometry. The resulting data is processed with a method described herein, which utilizes the survey scan information from multidimensional separation tandem mass spectrometry type experiments to classify samples and has the potential to identify important proteins. In one aspect of the invention, proteins bound to specific blood components, such as HDL (high-density lipoprotein), are examined via mass spectrometry (MS). The resulting data are processed with a pattern recognition technique, to identify abnormal protein patterns in HDL that predict heart disease.

Not intending to be limiting with respect to the mechanism, it is believed that the vast number of candidate proteins in blood can overwhelm both the identification of marker proteins and the necessary validation process. Hence, it is considered beneficial to reduce the complexity of such an analysis by focusing on the most relevant subset of blood proteins.

Preferably, the methods described herein evaluate and/or identify biomarker patterns in fractions and/or sub-fractions of biological samples. The components of the biomarker patterns could be detected, i.e., present or absent, the levels could be obtained, and/or their characteristics could be evaluated.

Lipoprotein Complexes as Markers

Preferably, the methods described herein are performed on fractions of the biological sample being tested. Also, further sub-fractions of the fractions can be tested. The different fractions and/or sub-fractions could be combined in varying combinations and then tested. The fraction and sub-fractions could include a particular population of cells from the biological sample or a particular group or class of chemical entities. Examples of cellular populations could be red blood cells, white blood cells, platelets, fraction of cells from a tumor, a group of cells from an atherosclerotic lesion, cells from an Alzheimer's lesion, etc. Another suitable fraction could include a complex of proteins, complex of carbohydrates, or complex of lipids. In a preferred embodiment, the fractions tested are lipoprotein fractions.

Lipoproteins are complexes of lipid and protein. Cholesterol, a building block of the outer layer of cells (cell membranes), is transported through the blood in the form of water-soluble carrier molecules known as lipoproteins. The lipoprotein particle is composed of an outer shell of phospholipid, which renders the particle soluble in water; a core of fats called lipid, including cholesterol and a surface apoprotein molecule that allows tissues to recognize and take up the particle. Lipoproteins differ in their content of proteins and lipids. They are classified based on their density: chylomicron (largest; lowest in density due to high lipid/protein ratio); VLDL (very low density lipoprotein); IDL (intermediate density lipoprotein); LDL (low density lipoprotein); and HDL (high density lipoprotein, highest in density due to high protein/lipid ratio). The lipoprotein fractions and sub-fractions tested herein could include one or more kinds of lipoproteins.

Chylomicrons and very low density lipoproteins (VLDL) transport both dietary and endogenous triacylglycerols (TAGs) around the body. Low density (LDL) and high density lipoproteins (HDL) transport both dietary and endogenous cholesterol around the body. HDL and very high density lipoproteins (VHDL) transport both dietary and endogenous phospholipids around the body. The lipoproteins consist of a core of hydrophobic lipids surrounded by a shell of polar lipids, which is surrounded by a shell of protein. The proteins that are used in lipid transport are synthesised in the liver, and are called apolipoproteins and as many as 8 apolipoproteins may be involved in forming a lipoprotein structure. The proteins are named Apo A-1, Apo A-2, Apo B-48, Apo C-3 etc. Other suitable proteins are known in the art. The lipoprotein particles are polydisperse and contain triglycerides, free and esterified cholesterol, phospholipids and proteins.

High-density lipoprotein (HDL) is a complex of lipids and proteins that functions in part as a cholesterol transporter in the blood. It contains two major proteins, apolipoprotein A-I (apoA-I) and apolipoprotein A-II (apoA-II), and a host of less abundant proteins. It has been observed that HDL from humans with established CAD is oxidatively modified in ways that impair some of its atheroprotective functions. Moreover, subjects with established CAD have elevated levels of oxidized HDL in their blood. These observations suggest that oxidative modification and other alterations in the protein composition of HDL might be detrimental and promote cardiovascular disease. They also suggest that alterations in HDL's protein composition might identify people at risk for CAD. This general approach should also be applicable to a wide range of other diseases.

HDL mediates cholesterol efflux: A sign of the early atherosclerotic lesion is the appearance of cholesterol-laden macrophages in the intima of the artery wall. Many lines of evidence indicate that HDL protects the artery wall against the development of atherosclerosis. This atheroprotective effect is attributed mainly to HDL's ability to mobilize excess cholesterol from arterial macrophages. HDL phospholipids passively absorb cholesterol that diffuses from the plasma membrane. HDL components also remove cellular cholesterol by active mechanisms, including the apoA-1-ABCA1 pathway.

HDL Apolipoproteins and ABCA1 Partner to Remove Cellular Cholesterol: HDL apolipoproteins remove cellular cholesterol, and other metabolites by a cholesterol-inducible active transport process mediated by a cell membrane protein called ATP-binding cassette transporter A1 (ABCA1). ABCA1 moves phospholipids to the cell surface, where they form complexes with apolipoproteins. Because the complexes are soluble, they disassociate from the cell and become embedded in HDL.

Oxidized HDL and apoA-I Impair ABCA1-Dependent Cholesterol Efflux: Oxidized HDL loses its ability to remove cholesterol from cultured cells. Oxidation of HDL and apoA-I impairs ABCA1-dependent cholesterol efflux.

Unoxidized HDL May Protect Against Damage to LDL: Many lines of evidence support the hypothesis that oxidation converts LDL (low-density lipoprotein), the major carrier of blood cholesterol, into an atherogenic form. Unmodified HDL protects LDL from oxidative modification by multiple pathways. But as noted above, oxidation causes HDL to lose some capabilities. It is therefore plausible that oxidation may impair HDL's ability to protect LDL, suggesting that only unoxidized HDL prevents damage to LDL and thereby prevents damage by oxidized LDL to the artery wall.

Information about changes in HDL's protein content can provide rich insights into the etiology of various brain diseases and the health of individual patients. HDL proteomics can provide information about the health of HDL itself. Also, HDL collects material from various brain structures. The collected material includes proteins, which may be sensitive markers for brain health. Damage to HDL can cause damage to neurons. HDL is implicated in Alzheimer's disease (AD). Thus, damaged HDL may be correlated with brain diseases. Since HDL interacts with tumor cells, one can expect that protein signals from the tumor may be carried by HDL. Other lipoproteins such as LDL may contain similarly rich information, and it is possible that other fractions of CSF are similarly informative. Without limiting the scope of the present invention, multiple lipoprotein fractions can be evaluated by the methods described herein.

Cardiovascular risk factors including hypertension, APOE genotype, and cholesterol levels affect AD risk. High cholesterol levels have been found to be associated with an increased risk of AD or cognitive impairment in several cross- and sectional prospective studies. Cholesterol levels were influenced by APOE genotype, sex, age, and stage of AD. Blood lipids are modifiable by dietary or pharmacologic intervention, and the lipoprotein cholesterol profile is an established marker of the effects of cholesterol-lowering medications and the associated reduction in cardiac risk. Plasma 24S-hydroxycholesterol reflects brain cholesterol homeostasis more closely than plasma total cholesterol. Excess brain cholesterol is converted to 24S-hydroxycholesterol, a brain-specific oxysterol which readily crosses the blood-brain barrier. 24S-hydroxycholesterol levels in plasma represent a balance between production in the brain and metabolism in the liver. Plasma levels show a weak, if any, correlation with cerebrospinal fluid (CSF) levels.

The APOE ε4 allele is associated with increased risk of AD, earlier age of AD onset, increased amyloid plaque load, and elevated levels of Aβ40 in the AD brain. High Lp(a) levels are associated with atherosclerosis, coronary artery disease, and cerebrovascular disease. Apolipoprotein (a) was detected in primate brain, suggesting that Lp(a) particles (which can also carry apoE) are involved in cerebral lipoprotein metabolism. Homocysteine is a thiol-containing amino acid involved in the methionine cycle as the demethylation product of methionine (which can subsequently be remethylated in vitamin B12-dependent and folate-dependent processes) and in the transulfuration pathway (in which it is irreversibly converted to cystathione in a vitamin B6-dependent process). Elevated homocysteine is a risk factor for cardiovascular disease, and seems to be an independent risk factor for AD.

Without limiting the scope of the present invention, other markers can also be diagnosed using the method and apparatuses described herein. By way of example only, plasma and serum biochemical markers that are proposed for Alzheimer disease (AD) based on pathophysiologic processes such as amyloid plaque formation [amyloid β-protein (Aβ), Aβ autoantibodies, platelet amyloid precursor protein (APP) isoforms], inflammation (cytokines), oxidative stress (vitamin E, isoprostanes), lipid metabolism (apolipoprotein E, 24S-hydroxycholesterol), and vascular disease [homocysteine, lipoprotein (a)]. See M. C. Irizarry, “Biomarkers of Alzheimer Disease in Plasma” NeuroRx 2004, 1(2), 226-234.

Cardiovascular Disease

Without limiting the scope of the invention, the methods described herein, can be used for the diagnosis of diseases such as, CVD in a patient. Cardiovascular disease (CVD) includes, but is not limited to, the following:

Atherosclerosis: Atherosclerosis is the buildup of plaque on the inner wall of an artery. It is implicated in most CVD. Stable plaque causes arteries to narrow and harden. Unstable plaque can cause blood clots, leading to strokes, heart attack, and other disorders.

Coronary artery disease (CAD): Coronary artery disease also called coronary heart disease is the leading cause of CVD mortality. It occurs when atherosclerosis of the coronary arteries (which supply blood to the heart) decreases the oxygen supply to the heart, often resulting in a heart attack when cardiac muscle is deprived of oxygen. Over time, coronary artery disease can weaken the heart muscle, contributing to heart failure.

Peripheral artery disease (PAD): It is a condition similar to coronary artery disease and carotid artery disease. In PAD, fatty deposits build up in the inner linings of the artery walls. These blockages restrict blood circulation, mainly in arteries leading to the kidneys, stomach, arms, legs and feet. In its early stages a common symptom is cramping or fatigue in the legs and buttocks during activity. Such cramping subsides when the person stands still. This is called “intermittent claudication.” People with PAD often have fatty buildup in the arteries of the heart and brain. Because of this association, people with PAD have a higher risk of death from heart attack and stroke. Treatments include, by way of example only, medicines to help improve walking distance, antiplatelet agents, and cholesterol-lowering agents (statins). In a minority of patients, angioplasty or surgery may be necessary.

Myocardial infarction: Also called a heart attack, myocardial infarction (MI), occurs when the supply of blood and oxygen to an area of heart muscle is blocked, usually by a clot in a coronary artery.

Other Cardiovascular disease: Heart failure, where the heart cannot pump enough blood throughout the body. Strokes are an interruption of blood supply to part of the brain. Better understanding of the nature and causes of atherosclerosis may lead to new treatments for CVD ailments. Particularly for CAD and MI, surrogate biomarkers for the severity of atherosclerotic lesions may facilitate the selection of appropriate treatment options and hence produce better therapeutic outcomes. High HDL levels associate with decreased risk of atherosclerosis and CAD. In contrast, a low level of HDL is the major cause of MI in men under age 50. It also is a major risk factor in diabetes, a metabolic disorder that greatly increases the risk of CAD.

Neurological Disorders

Without limiting the scope of the invention, the methods described herein, can be used for the diagnosis of neurological diseases in a patient. Neurological disorders include, but not limited to, the following:

CNS cancers: Disclosed herein are methods to diagnose CNS cancers. Brain and spinal cord tumors are abnormal growths of tissue found inside the skull or the bony spinal column, which are the primary components of the central nervous system (CNS). Benign tumors are noncancerous, and malignant tumors are cancerous. Tumors are classified according to the kind of cell from which the tumor seems to originate. The common primary brain tumor in adults comes from cells in the brain called astrocytes that make up the blood-brain barrier and contribute to the nutrition of the central nervous system. These tumors are called gliomas (astrocytoma, anaplastic astrocytoma, or glioblastoma multiforme) and account for 65% of all primary central nervous system tumors. Some of the tumors are, by way of example only, pontine gliomas, Oligodendroglioma, Ependymoma, Meningioma, Lymphoma, Schwannoma, and Medulloblastoma.

Neuroepithelial Tumors of the CNS

Astrocytic tumors include, by way of example only, astrocytoma; anaplastic (malignant) astrocytoma, such as hemispheric, diencephalic, optic, brain stem, cerebellar; glioblastoma multiforme; pilocytic astrocytoma, such as hemispheric, diencephalic, optic, brain stem, cerebellar; subependymal giant cell astrocytoma; and pleomorphic xanthoastrocytoma. Oligodendroglial tumors include, by way of example only, oligodendroglioma; and anaplastic (malignant) oligodendroglioma. Ependymal cell tumors include, by way of example only, ependymoma; anaplastic ependymoma; myxopapillary ependymoma; and subependymoma. Mixed gliomas, include, by way of example only, mixed oligoastrocytoma; anaplastic (malignant) oligoastrocytoma; and others (e.g. ependymo-astrocytomas). Neuroepithelial tumors of uncertain origin include, by way of example only, polar spongioblastoma; astroblastoma; and gliomatosis cerebri. Tumors of the choroid plexus include, by way of example only, choroid plexus papilloma; and choroid plexus carcinoma (anaplastic choroid plexus papilloma). Neuronal and mixed neuronal-glial tumors include, by way of example only, gangliocytoma; dysplastic gangliocytoma of cerebellum (Lhermitte-Duclos); ganglioglioma; anaplastic (malignant) ganglioglioma; desmoplastic infantile ganglioglioma, such as desmoplastic infantile astrocytoma; central neurocytoma; dysembryoplastic neuroepithelial tumor; olfactory neuroblastoma (esthesioneuroblastoma. Pineal Parenchyma Tumors include, by way of example only, pineocytoma; pineoblastoma; and mixed pineocytoma/pineoblastoma. Tumors with neuroblastic or glioblastic elements (embryonal tumors) include, by way of example only, medulloepithelioma; primitive neuroectodermal tumors with multipotent differentiation, such as medulloblastoma; cerebral primitive neuroectodermal tumor; neuroblastoma; retinoblastoma; and ependymoblastoma.

Other CNS Neoplasms

Tumors of the Sellar Region include, by way of example only, pituitary adenoma; pituitary carcinoma; and craniopharyngioma. Hematopoietic tumors include, by way of example only, primary malignant lymphomas; plasmacytoma; and granulocytic sarcoma. Germ Cell Tumors include, by way of example only, germinoma; embryonal carcinoma; yolk sac tumor (endodermal sinus tumor); choriocarcinoma; teratoma; and mixed germ cell tumors. Tumors of the Meninges include, by way of example only, meningioma; atypical meningioma; and anaplastic (malignant) meningioma. Non-menigothelial tumors of the meninges include, by way of example only, Benign Mesenchymal; Malignant Mesenchymal; Primary Melanocytic Lesions; Hemopoietic Neoplasms; and Tumors of Uncertain Histogenesis, such as hemangioblastoma (capillary hemangioblastoma). Tumors of Cranial and Spinal Nerves include, by way of example only, schwannoma (neurinoma, neurilemoma); neurofibroma; malignant peripheral nerve sheath tumor (malignant schwannoma), such as epithelioid, divergent mesenchymal or epithelial differentiation, and melanotic. Local Extensions from Regional Tumors include, by way of example only, paraganglioma (chemodectoma); chordoma; chodroma; chondrosarcoma; and carcinoma. Metastatic tumours, Unclassified Tumors and Cysts and Tumor-like Lesions, such as Rathke cleft cyst; Epidermoid; dermoid; colloid cyst of the third ventricle; enterogenous cyst; neuroglial cyst; granular cell tumor (choristoma, pituicytoma); hypothalamic neuronal hamartoma; nasal glial herterotopia; and plasma cell granuloma.

Amyotrophic Lateral Sclerosis: Motor neuron disease, also known as amyotrophic lateral sclerosis (ALS) or Lou Gehrig's disease, is a progressive disease that attacks motor neurons, components of the nervous system that connect the brain with the skeletal muscles. Skeletal muscles are the muscles involved with voluntary movement, like walking and talking. In ALS, the motor neurons deteriorate and eventually die, and though a person's brain is fully functioning and alert, the command to move never reaches the muscle. The patient may want to reach for a glass of water, for example, but is not able to do it because the lines of communication from the brain to the arm and hand muscles have been destroyed. The muscles eventually waste away from disuse, and a person in the late stages of Lou Gehrig's disease is completely paralyzed.

Ataxi: Broadly speaking, the word “ataxia” means unsteadiness and clumsiness, and has been given to the condition because those are usually the earliest symptoms. As the disorder progresses, people with ataxia usually lose the ability to walk, and can become totally disabled, having to depend on others for their care. This is because ataxia destroys both nerve and muscle cells. Vision (and in some cases hearing) and speech may also be affected.

Delirium: An etiologically nonspecific syndrome characterized by concurrent disturbances of consciousness and attention, perception, thinking, memory, psychomotor behaviour, emotion, and the sleep-wake cycle. It may occur at any age but is most common after the age of 60 years. A delirious state may be superimposed on, or progress into, dementia.

Dementia: Dementia describes a gradual decrease in cognitive abilities from a once-normal state over a period of time. This category is for sites about the dementias of old age and geriatics; Alzheimer's is one type of dementia.

Demyelinating Diseases: This category includes those diseases which predominantly affect the myelin (the structure that coats nerves). Examples include the leukodystrophies (in which the myelin in the brain is affected), demyelinating neuropathies (in which the myelin of peripheral nerves is affected) and multiple sclerosis.

Dysautonomia: It is a dysfunction of the autonomic nervous system (ANS). There are many types of dysautonomia. Some of the disorders are, by way of example only, Postural Orthostatic Tachycardia Syndrome (POTS), Neurocardiogenic Syncope, Mitral Valve Prolapse Dysautonomia, Pure Autonomic Failure and Multiple System Atrophy (Shy-Drager Syndrome).

Muscle Diseases: This category includes disorders affecting muscles—for example, myopathies, myositis, fibromyalgia, myotonias, perioidic paralyses, etc.

Neoplasms: This category is for all types of cancers and tumors that affect the brain, meninges (coverings of the brain), spinal cord and nerves.

Neurocutaneous Syndromes: This category includes those diseases that affect both the nervous system (brain, spinal cord or nerves) and the skin. Examples include Neurofibromatoses, Hippel-Lindau Disease, Sturge-Weber Syndrome, Ataxia Telangiectasia, Tuberous Sclerosis, etc.

Neurodegenerative Diseases: This category includes those diseases which are caused by degeneration of some part of the brain, spinal cord or nerves. Examples include, but not limited to, Alpers', Alzheimer's, Batten, Cockayne Syndrome, Corticobasal Degeneration, Lewy Body, Motor Neuron Disease, Multiple System Atrophy, Olivopontocerebellar Atrophy, Parkinson's, Postpoliomyelitis Syndrome, Prion Diseases, Progressive Supranuclear Palsy, Rett Syndrome, Shy-Drager Syndrome, and Tuberous Sclerosis. Parkinson's disease is the loss of brain cells that produce dopamine—a chemical which helps control muscle activity. A chronic, progressive, motor system disorder, it has four primary symptoms: tremors or shaking of the hands, arms, legs, jaw and face; stiffness or rigidity of the limbs and trunk; excessive slowness of movement, a condition called bradykinesia; and instability, poor balance and loss of coordination. These symptoms become more pronounced as the disease progresses, and patients ultimately experience difficulty with such simple tasks as walking and speaking. The disease is one of a group of similar disorders called Parkinsonism, all of which are related to the loss of dopamine-producing cells in the brain. The common of these, Parkinson's disease is also known as primary Parkinsonism or idiopathic Parkinson's disease. The other forms of Parkinsonism either have known or suspected causes, or occur as secondary symptoms of other neurological disorders.

Hydrocephalus: Hydrocephalus comes from the Greek: hydro means water, cephalus means head. Hydrocephalus is an abnormal accumulation of cerebrospinal fluid (CSF) within cavities called ventricles inside the brain. CSF is produced in the ventricles, circulates through the ventricular system, and is absorbed into the bloodstream. CSF is in constant circulation and has many important functions. It surrounds the brain and spinal cord and acts as a protective cushion against injury. CSF contains nutrients and proteins necessary for the nourishment and normal function of the brain. It carries waste products away from surrounding tissues. Hydrocephalus occurs when there is an imbalance between the amount of CSF that is produced and the rate at which it is absorbed. As CSF builds up, it causes the ventricles to enlarge, and the pressure inside the head to increase.

Neurologic Manifestations: This category is for various symptoms and complaints that are usually caused by a neurological problem. For example, dizziness, headache, paralysis, seizures, pain, ataxia or gait problems, etc. Examples include, but not limited to, Anosmia, Ataxia, Chronic Pain, Gerstmann Syndrome, Headache, Homer Syndrome, Paresthesia, Syncope, Transient Global Amnesia, and Transverse Myelitis.

Ocular Motility Disorders: Examples include, Adie Syndrome, Duane Retraction Syndrome, Miller Fisher Syndrome, Ophthalmoplegia, Pathologic Nystagmus, and Strabismus.

Peripheral Nervous System: This category includes disorders affecting the peripheral nerves like the various neuropathies, plexus disorders etc. Disorders of the cranial nerves can be included here.

Stroke: A stroke is a sudden interruption of blood flow to a region of the brain, due either to a blockage in, or the bursting of, one of the vessels supplying that region. The interruption of blood flow leads to the injury and death of brain cells, and can thus result in paralysis, cognitive impairment, and other significant disabilities.

Metabolic Diseases

Without limiting the scope of the invention, the methods described herein, can be used for the diagnosis of metabolic diseases in a patient. A metabolic disease is a disease caused by malfunction in the human total metabolism. Total metabolism (also called metabolism) is all of a certain living organism's chemical processes. The organism's metabolism can be dichotomized into the synthesis of organic molecules (anabolism) and their breakdown (catabolism). The halt of metabolism in a living organism is usually defined as its death.

Metabolic diseases include but not limited to, aspartylglusomarinuria, biotinidase deficiency, carbohydrate deficient glycoprotein syndrome (CDGS), Crigler-Najjar syndrome, cystinosis, diabetes insipidus, Fabry, fatty acid metabolism disorders, galactosemia, Gaucher, glucose-6-phosphate dehydrogenase (G6PD), glutaric aciduria, Hurler, Hurler-Scheie, Hunter, hypophosphatemia, 1-cell, Krabbe, lactic acidosis, long chain 3 hydroxyacyl CoA dehydrogenase deficiency (LCHAD), lysosomal storage diseases, mannosidosis, maple syrup urine, Maroteaux-Lamy, metachromatic leukodystrophy, mitochondrial, Morquio, mucopolysaccharidosis, neuro-metabolic, Niemann-Pick, organic acidemias, purine, phenylketonuria (PKU), Pompe, porphyria, pseudo-Hurler, pyruvate dehydrogenase deficiency, Sandhoff, Sanfilippo, Scheie, Sly, Tay-Sachs, trimethylaminuria (Fish-Malodor syndrome), urea cycle conditions, and vitamin D deficiency rickets. Other examples include, Acid-Base Imbalance, Acidosis, Alkalosis, Alkaptonuria, alpha-Mannosidosis, Amino Acid Metabolism, Inbom Errors, Amyloidosis, Anemia, Iron-Deficiency, Ascorbic Acid Deficiency, Avitaminosis, Beriberi, Biotinidase Deficiency, Carbohydrate-Deficient Glycoprotein Syndrome, Carnitine Disorders (not on MeSH), Cystinosis, Cystinuria, Dehydration, Fabry Disease, Fatty Acid Oxidation Disorders (not on MeSH), Fucosidosis, Galactosemias, Gaucher Disease, Gilbert Disease, Glucosephosphate Dehydrogenase Deficiency, Glutaric Acidemia (not on MeSH), Glycogen Storage Disease, Hartnup Disease, Hemochromatosis, Hemosiderosis, Hepatolenticular Degeneration, Histidinemia (not on MeSH), Homocystinuria, Hyperbilirubinemia, Hereditary, Hypercalcemia, Hyperinsulinism, Hyperkalemia, Hyperlipidemia, Hyperoxaluria, Hypervitaminosis A, Hypocalcemia, Hypoglycemia, Hypokalemia, Hyponatremia, Hypophosphatasia, Insulin Resistance, Iodine Deficiency, Iron Overload, Jaundice, Chronic Idiopathic, Leigh Disease, Lesch-Nyhan Syndrome, Leucine Metabolism Disorders, Lysosomal Storage Diseases, Magnesium Deficiency, Maple Syrup Urine Disease, MELAS Syndrome, Menkes Kinky Hair Syndrome, Metabolic Diseases, Metabolic Syndrome X, Metabolism, Inborn Errors, Mitochondrial Diseases, Mucolipidoses, Mucopolysaccharidoses, Niemann-Pick Disease, Nutrition Disorders, Nutritional and Metabolic Diseases, Obesity, Ornithine Carbamoyltransferase Deficiency Disease, Osteomalacia, Pellagra, Peroxisomal Disorders, Phenylketonurias, Porphyrias, Progeria, Pseudo-Gaucher Disease (not on MeSH), Refsum Disease, Reye Syndrome, Rickets, Sandhoff Disease, Starvation, Tangier Disease, Tay-Sachs Disease, Tetrahydrobiopterin Deficiency (not on MeSH), Trimethylaminuria (Fish Odor Syndrome; not on MeSH), Tyrosinemias, Urea Cycle Disorders (not on MeSH), Water-Electrolyte Imbalance, Wernicke Encephalopathy, Vitamin A Deficiency, Vitamin B 12 Deficiency, Vitamin B Deficiency, Wolman Disease and Zellweger Syndrome.

Metabolic diseases include endocrinological diseases, which are metabolic diseases related to the endocrine system. Endocrinological diseases include, but are not limited to, the following: Adrenal disorders such as Addison's disease, Congenital adrenal hyperplasia (adrenogenital syndrome), Mineralocorticoid deficiency, Conn's syndrome, Cushing's syndrome, Pheochromocytoma; Glucose homeostasis disorders such as Diabetes mellitus, Hypoglycemia, Idiopathic hypoglycemia, Insulinoma; Metabolic bone disease such as, Osteoporosis, Osteitis deformans (Paget's disease of bone), Rickets and osteomalacia; Pituitary gland disorders such as, Diabetes insipidus, Hypopituitarism (or Panhypopituitarism) Pituitary tumours such as, Pituitary adenomas, Prolactinoma (or Hyperprolactinaemia), Acromegaly, gigantism, Cushing's disease; Parathyroid gland disorders such as, Primary hyperparathyroidism, Secondary hyperparathyroidism, Tertiary hyperparathyroidism, Hypoparathyroidism, Pseudohypoparathyroidism; Sex hormone disorders such as, Disorders of sexual differentiation or intersex disorders, Hermaphroditism, Gonadal dysgenesis, Androgen insensitivity syndromes; Hypogonadism such as, Gonadotropin deficiency, Kallmann syndrome, Klinefelter syndrome, Ovarian failure, Testicular failure, Turner syndrome; Disorders of Gender such as, Gender identity disorder; Disorders of Puberty such as, Delayed puberty, Precocious puberty; Menstrual function or fertility disorders such as, Amenorrhoea, Polycystic ovary syndrome; Thyroid disorders such as, Hyperthyroidism and Graves-Basedow disease, Hypothyroidism, Thyroiditis, Thyroid cancer; Tumors of the endocrine glands such as Multiple endocrine neoplasia, MEN type 1, MEN type 2a, MEN type 2b, Autoimmune polyendocrine syndromes, and Incidentaloma.

Methods of Identification and Measurment of Lipoprotein Complexes

Collection, Preparation, and Separation of Biological Sample

Biological samples are obtained from individuals with varying phenotypic states. Samples may be collected from a variety of sources in a given patient. Samples collected are preferably bodily fluids such as blood, serum, sputum, including, saliva, plasma, nipple aspirants, synovial fluids, cerebrospinal fluids, sweat, urine, fecal matter, pancreatic fluid, trabecular fluid, cerebrospinal fluid, tears, bronchial lavage, swabbings, bronchial aspirants, semen, prostatic fluid, precervicular fluid, vaginal fluids, pre-ejaculate, etc. In an embodiment, a sample collected may be approximately 1 to approximately 5 ml of blood. In another embodiment, a sample collected may be approximately 10 to approximately 15 ml of blood.

In some instances, samples may be collected from individuals repeatedly over a longitudinal period of time (e.g., about once a day, once a week, once a month, biannually or annually). Obtaining numerous samples from an individual over a period of time can be used to verify results from earlier detections and/or to identify an alteration in biological pattern as a result of, for example, disease progression, drug treatment, etc. Samples can be obtained from humans or non-humans. In a preferred embodiment, samples are obtained from humans. In an embodiment, serum is derived from collected blood and then analyzed. Preferably, blood may be processed into serum and frozen at e.g., −80° C. until further use.

Sample preparation and separation can involve any of the following procedures, depending on the type of sample collected and/or types of biological molecules searched: concentration, dilution, adjustment of pH, removal of high abundance polypeptides (e.g., albumin, gamma globulin, and transferin, etc.); addition of preservatives and calibrants, addition of protease inhibitors, addition of denaturants, desalting of samples; concentration of sample proteins; protein digestions; and fraction collection. The sample preparation can also isolate molecules that are bound in non-covalent complexes to other protein (e.g., carrier proteins). This process may isolate only those molecules bound to a specific carrier protein (e.g., albumin), or use a more general process, such as the release of bound molecules from all carrier proteins via protein denaturation, for example using an acid, followed by removal of the carrier proteins. Preferably, sample preparation techniques concentrate information-rich proteins (e.g., proteins that have “leaked” from diseased cells) and deplete proteins that would carry little or no information such as those that are highly abundant or native to serum. Sample preparation can take place in a multiplicity of devices including preparation and separation devices or on a combination separation device.

Removal of undesired proteins (e.g., high abundance, uninformative, or undetectable proteins) can be achieved using high affinity reagents, high molecular weight filters, ultracentrifugation and/or electrodialysis. High affinity reagents include antibodies or other reagents (e.g. aptamers) that selectively bind to high abundance proteins. Sample preparation could also include ion exchange chromatography, metal ion affinity chromatography, gel filtration, hydrophobic chromatography, chromatofocusing, adsorption chromatography, isoelectric focusing and related techniques. Molecular weight filters include membranes that separate molecules on the basis of size and molecular weight. Such filters may further employ reverse osmosis, nanofiltration, ultrafiltration and microfiltration.

Ultracentrifugation is another method for removing undesired polypeptides. Ultracentrifugation is the centrifugation of a sample at about 60,000 rpm while monitoring with an optical system the sedimentation (or lack thereof) of particles. Finally, electrodialysis is a procedure which uses an electromembrane or semipermeable membrane in a process in which ions are transported through semi-permeable membranes from one solution to another under the influence of a potential gradient. Since the membranes used in electrodialysis may have the ability to selectively transport ions having positive or negative charge and reject ions of the opposite charge, or to allow species to migrate through a semipermable membrane based on size and charge, electrodialysis is useful for concentration, removal, or separation of electrolytes.

After samples are prepared, components that may comprise a biological marker or pattern of interest may be separated. Separation can take place in the same location as the preparation or in another location. Samples can be removed from an initial manifold location to a microfluidics device using various means, including an electric field. Separation can involve any procedure known in the art, such as capillary electrophoresis (e.g., in capillary or on-chip) or chromatography (e.g., in capillary, column or on a chip).

Electrophoresis is a method which can be used to separate ionic molecules such as polypeptides according to their mobilities under the influence of an electric field. Electrophoresis can be conducted in a gel, capillary, or in a microchannel on a chip. In a capillary or microchannel, the mobility of a species is determined by the sum of the mobility of the bulk liquid in the capillary or microchannel, which can be zero or non-zero, and the electrophoretic mobility of the species, determined by the charge on the molecule and the frictional resistance the molecule encounters during migration. For molecules of regular geometry, the frictional resistance is often directly proportional to the size of the molecule, and hence it is common in the art for the statement to be made that molecules are separated by their charge and size. Examples of gels used for electrophoresis may include starch, acrylamide, polyethylene oxides, agarose, or combinations thereof. A gel can be modified by its cross-linking, addition of detergents, or denaturants, immobilization of enzymes or antibodies (affinity electrophoresis) or substrates (zymography) and incorporation of a pH gradient. Examples of capillaries used for electrophoresis include capillaries that interface with an electrospray.

Capillary electrophoresis (CE) is preferred for separating complex hydrophilic molecules and highly charged solutes. Advantages of CE include its use of small sample volumes (sizes ranging from 0.1 to 10 μl), fast separation, reproducibility, ease of automation, high resolution, and the ability to be coupled to a variety of detection methods, including mass spectrometry. CE technology, in general, relates to separation techniques that use narrow bore capillaries, commonly made of fused silica, to separate a complex array of large and small molecules. High voltages are used to separate molecules based on differences in charge, size and/or hydrophobicity. CE technology can also be implemented on microfluidic chips. Depending on the types of capillary and buffers used, CE can be further segmented into separation techniques such as capillary zone electrophoresis (CZE), capillary isoelectric focusing (CIEF), capillary isotachophoresis (cITP) and capillary electrochromatography (CEC). Coupling of CE techniques to electrospray ionization may involve the use of volatile solutions, for example, aqueous mixtures containing a volatile acid and/or base and an organic such as an alcohol or acetonitrile.

Capillary isotachophoresis (cITP) is a technique in which the analytes move through the capillary at a constant speed but are nevertheless separated by their respective mobilities. This type of separation is accomplished in a heterogeneous buffer system where the buffers are different upstream and downstream of the sample zone. For a separation of positively-charged analytes, the buffer cation of the first buffer has a mobility and conductivity greater than that of the analytes, and the buffer cation of the second buffer has mobility and conductivity less than that of the analytes. The voltage gradient per unit length of capillary depends on the conductivity, and therefore the voltage gradient is heterogeneous along the length of the capillary; higher in regions of low conductivity and lower in regions of high conductivity. At steady state, the analytes are focused in zones according to their mobility: if an analyte diffuses into a neighboring zone, it encounters a different field and will either speed up or slow down to rejoin its original zone. An advantage of cITP is that it can be used to concentrate a relatively wide zone of low concentration into a narrow zone of high concentration, thereby improving the limit of detection. Through the appropriate choice of buffers and injected zones, a hybrid separation technique often referred to as transient isotachophoresis-zone electrophoresis (tITP/ZE) can be performed. In tITP/ZE the conditions for isotachophoresis are present only transiently, after which the conditions are set up for zone electrophoresis. In this way, dilute samples can be concentrated and then separated into individual peaks.

Capillary zone electrophoresis (CZE), also known as free-solution CE (FSCE), is one of the simplest forms of CE. The separation mechanism of CZE is based on differences in the electrophoretic mobility of the species, determined by the charge on the molecule, and the frictional resistance the molecule encounters during migration which is often directly proportional to the size of the molecule. The separation typically relies on the charge state of the proteins, which is determined by the pH of the buffer solution.

Capillary isoelectric focusing (CIEF) allows weakly-ionizable amphoteric molecules, such as polypeptides, to be separated by electrophoresis in a pH gradient. A solute migrates to the point in the pH gradient where its net charge is zero. The pH of the solution at the point of zero net charge equals the isoelectric point (pI) of the solute. Because the solute is net neutral at the isoelectric point, its electrophoretic migration is no longer affected by the electric field, and the sample focuses into a tight zone. In CIEF, after all the solutes have focused at their pI's, the bulk solution is often moved past the detector by pressure or chemical means.

CEC is a hybrid technique between traditional liquid chromatography (HPLC) and CE. In essence, CE capillaries are packed with beads (as in traditional HPLC) or a monolith, and a voltage is applied across the packed capillary which generates an electro-osmotic flow (EOF). The EOF transports solutes along the capillary towards a detector. Both chromatographic and electrophoretic separation occurs during their transportation towards the detector. It is therefore possible to obtain unique separation selectivities using CEC compared to both HPLC and CE. The beneficial flow profile of EOF reduces flow related band broadening and separation efficiencies of several hundred thousand plates per meter are often obtained in CEC. CEC also makes it is possible to use small-diameter packings and achieve very high efficiencies.

Chromatography is another type of method for separating a subset of polypeptides, proteins, or other analytes. Chromatography can be based on the differential adsorption and elution of certain analytes or partitioning of analytes between mobile and stationary phases. Liquid chromatography (LC), for example, involves the use of fluid carrier over a non-mobile phase. Conventional analytical LC columns have an inner diameter of roughly 4.6 mm and a flow rate of roughly 1 ml/min. Micro-LC typically has an inner diameter of roughly 1.0 mm and a flow rate of roughly 40 μl/min. Capillary LC generally utilizes a capillary with an inner diameter of roughly 300 μm and a flow rate of approximately 5 μl/min. Nano-LC is available with an inner diameter of 50 μm−1 mm and flow rates of 200 nl/min. Nano-LC can vary in length (e.g., 5, 15, or 25 cm) and have typical packing of C18, 5 μm particle size. Nano-LC provides increased sensitivity due to lower dilution of chromatographic sample. The sensitivity improvement of nano-LC as compared to analytical HPLC is approximately 3700 fold.

In some embodiments, the samples are separated using capillary electrophoresis separation. In some embodiments, the steps of sample preparation and separation are combined using microfluidics technology. A microfluidic device is a device that can transport fluids containing various reagents such as analytes and elutions between different locations using microchannel structures. Microfluidic devices provide advantageous miniaturization, automation and integration of a large number of different types of analytical operations. For example, continuous flow microfluidic devices have been developed that perform serial assays on extremely large numbers of different chemical compounds.

Identification Techniques for Lipoprotein Complexes

Various techniques have been developed for the analysis of biological samples. Some of the techniques include Liquid Chromatography (LC), Gas Chromatography (GC), Mass Spectrometry (MS), Multidimensional Protein identification Technology (MudPIT), etc. Analysis of biological samples utilizing these techniques and others has resulted in the combination or hyphenation of techniques, such as combining multiple stages of GC in series with one or more Mass Spectrometers (MS). In other examples, LC is hyphenated with LC and then subject to one or more dimensions of mass spectrometry analysis, etc. Such combination or hyphenation of techniques allows multidimensional biological data sets to be collected and analyzed. An existing method of utilizing chromatography (for example LC or GC) hyphenated with mass spectrometry, for example, is to operate a mass spectrometer in survey mode and then to use information obtained from the survey scan to guide the subsequent tandem mass spectrometry measurement.

Methods described herein, may use any of the techniques described herein for the identification of markers. Preferably the methods of the present invention are performed using a mass spectrometry (MS) system, such as a time-of-flight (TOF) mass spectrometry system. In preferred embodiments, the biological sample is delivered to the mass spectrometry system by electrospray ionization (EI) or by matrix assisted laser desorption ionization (MALDI). The sample tested could be a biological fluid or tissue or cells. Biological fluids may include but are not limited to serum, plasma, whole blood, nipple aspirate, pancreatic fluid, trabecular fluid, lung lavage, urine, cerebrospinal fluid, saliva, sweat, pericrevicular fluid, semen, prostatic fluid, pre-ejaculate fluid, nasal discharge, and tears.

Mass Spectrometry

MS is used in the methods described herein, to identify and measure proteins in complex samples. Intact proteins can be analyzed, but large proteins are usually broken up into smaller peptides, and the identity of the protein is inferred from the identities of its peptides. MS measures the mass of ionized molecules moving in an electromagnetic field. Consequently, molecules must have an electrical charge to be measured. Two main methods are used to ionize peptides for MS. ESI ionizes water droplets, so is used with liquid samples. MALDI ionizes solid material on a metal plate, so is used with dry samples. In certain embodiments, the methods utilize an ESI-MS detection device.

An ESI-MS combines the ESI system with mass spectrometry. Furthermore, an ESI-MS preferably utilizes a time-of-flight (TOF) mass spectrometry system. In TOF-MS, ions are generated by whatever ionization method is being employed, such as ESI, and a voltage potential is applied. The potential extracts the ions from their source and accelerates them towards a detector. By measuring the time it takes the ions to travel a fixed distance, the mass to charge ratio of the ions can be calculated. TOF-MS can be set up to have an orthogonal-acceleration (OA). OA-TOF-MS are advantageous and preferred over conventional on-axis TOF because they have better spectral resolution and duty cycle. OA-TOF-MS also has the ability to obtain spectra, e.g., spectra of proteins and/or protein fragments, at a relatively high speed. In addition to the MS systems disclosed above, other forms of ESI-MS include quadrupole mass spectrometry, ion trap mass spectrometry, orbitrap mass spectrometry, Fourier transform ion cyclotron resonance (FTICR-MS), and hybrid combinations of these mass analyzers.

Quadrupole mass spectrometry consists of four parallel metal rods arranged in four quadrants (one rod in each quadrant). Two opposite rods have a positive applied potential and the other two rods have a negative potential. The applied voltages affect the trajectory of the ions traveling down the flight path. Only ions of a certain mass-to-charge ratio pass through the quadrupole filter and all other ions are thrown out of their original path. A mass spectrum is obtained by monitoring the ions passing through the quadrupole filter as the voltages on the rods are varied.

Ion trap mass spectrometry uses rf fields to trap ions. A quadrupole ion trap uses three electrodes in a small volume. The mass analyzer consists of a ring electrode separating two hemispherical electrodes. A linear ion trap uses end electrodes to trap ions in a linear quadrupole. A mass spectrum is obtained by changing the electrode voltages to eject the ions from the trap. The advantages of the ion-trap mass spectrometer include compact size, and the ability to trap and accumulate ions to increase the signal-to-noise ratio of a measurement.

Orbitrap mass spectrometry uses spatially defined electrodes with DC fields to trap ions. Ions are constrained by the DC field and undergo harmonic oscillation. The mass is determined based on the axial frequency of the ion in the trap. FTICR mass spectrometry is a mass spectrometric technique that is based upon an ion's motion in a magnetic field. Once an ion is formed, it eventually finds itself in the cell of the instrument, which is situated in a homogenous region of a large magnet. The ions are constrained in the XY plane by the magnetic field and undergo a circular orbit. The mass of the ion can be determined based on the cyclotron frequency of the ion in the cell.

The first popular MS proteomics method was peptide mass mapping or peptide mass fingerprinting, developed in the early 1990s. See W. J. Henzel, T. M. Billeci, J. T. Stults and S. C. Wong “Identifying Proteins from Two-Dimensional Gels by Molecular Mass Searching of Peptide Fragments in Protein Sequence Databases” PNAS 1993, 90, 5011-5015 and J. R. Yates, 3rd, S. Speicher, P. R. Griffin and T. Hunkapiller “Peptide mass maps: a highly informative approach to protein identification.” Anal. Biochem. 1993, 214, 397-408. In this method, each peak in the mass spectrum represents a peptide, and the whole spectrum represents the original protein. A single peptide mass is insufficient to uniquely identify a protein, but all the detected peptide masses are often sufficient for unambiguous identification. One use of mass mapping is to identify digested protein spots cut from two-dimensional polyacrylamide gel electrophoresis (2D-PAGE) gels, typically with MALDI-TOF-MS, although ESI-MS can also be used. To identify proteins in a complex sample, whole proteins are first separated into individual species because it is difficult to identify a mixture of proteins using this approach. In “mass fingerprinting,” mass peaks in a survey scan are used to identify peptides. However, mass fingerprinting requires simple, highly purified samples; high mass accuracy such as obtained with a FTMS (Fourier Transform Mass Spectrometer) or both.

For a mixture of peptides, tandem MS (MS² or MS/MS) attempts to select molecular species from the sample and refragments them into smaller pieces. Measuring the mass of each piece identifies the peptide. See J. K. Eng, A. L. McCormack and J. R. Yates, III “An approach to correlate tandem mass spectral data of peptides with amino acid sequences in a protein database” Journal of the American Society for Mass Spectrometry 1994, 5, 976-989. A soft ionization MS spectrum called a survey scan is used to identify candidate masses for collision-induced dissociation (CID) MS/MS. One or more MS/MS spectra are then gathered, and the process is typically repeated, beginning with another survey scan. To analyze complex protein samples, MS/MS is usually directly coupled to liquid chromatography (LC). Thus, the sample measured by the spectrometer is constantly evolving. Peptides are identified by matching the MS/MS spectrum to a database of protein sequences, by various methods. See M. Mann and M. Wilm “Error-Tolerant Identification of Peptides in Sequence Databases by Peptide Sequence Tags” Anal. Chem. 1994, 66, 43904399; J. K. Eng, A. L. McCormack and J. R. Yates, III “An approach to correlate tandem mass spectral data of peptides with amino acid sequences in a protein database” Journal of the American Society for Mass Spectrometry 1994, 5, 976-989; D. L. Tabb, A. Saraf and J. R. Yates, III “GutenTag: high-throughput sequence tagging via an empirically derived fragmentation model” Anal. Chem. 2003, 75, 6415-6421; and Y. Han, B. Ma and K. Zhang, Proceedings of the 2004 IEEE Computational Systems Bioinformatics Conference, 2004. MS/MS analysis can also compare the relative quantities of proteins in samples. See S. P. Gygi, B. Rist, S. A. Gerber, F. Turecek, M. H. Gelb and R. Aebersold “Quantitative Analysis of Complex Protein Mixtures using Isotope-coded Affinity Tags” Nature Biotechnology 1999, 17, 994-999.

A method called MudPIT (multidimensional protein identification technique) first separates a peptide mixture with multidimensional LC and then analyzes the separated liquid via ESI-MS/MS. See A. J. Link, J. Eng, D. M. Schieltz, E. Carmack, G. J. Mize, D. R. Morris, B. M. Garvik and J. R. Yates, III “Direct analysis of protein complexes using mass spectrometry” Nature Biotechnology 1999, 17, 676-682 and D. A. Wolters, M. P. Washburn and J. R. Yates, III “An Automated Multidimensional Protein Identification Technology for Shotgun Proteomics” Anal. Chem. 2001, 73, 5683-5690. In proteomics, as exemplified by MudPIT proteomics, tandem mass spectrometer scans are used to identify peptides, while the survey scans are not used. Large data sets are produced from the mass spectrometer measurement scans, which can exceed the ability of currently existing computer equipment to process for pattern recognition and some other analytical purposes.

Another attempt at using a survey scan is Differential Mass Spectrometry (dMS). dMS is a method of binning the LC-MS data in the time and m/z (mass to charge) axes. One sample is then subtracted from the other. Such a method is limited to two samples and the sample conditions must be known apriori, i.e., control vs. diseased, etc. Binning in the m/z axis reduces m/z resolution, which can prevent identification of the phenomena of interest. dMS also requires replicates of the samples to be run on the instrument. Running replicates is necessary to account for measurement variations, which are due at least in part to variations in migration time with respect to the chromatography.

Analysis of Lipoprotein Complexes

Chromatography, inherently contains variations in the time it takes a given chemical to make its way (by migration, elution, or similar) through the chromatographic system. Variations in migration (or similar) time may complicate subsequent existing analysis methods, making analysis of the data difficult to understand and interpret. Often, variations in migration time may render the phenomena of interest undetectable.

It will be noted by those of skill in the art that “elute” and “migrate” are used to describe similar concepts in different situations. To render a clearer presentation to the reader, the term “migrate” is used in this discussion to indicate all phenomena involving the motion of chemicals under analysis into, within, or out of a chromatographic system, and “migration time” is used to indicate the time such motions take, or a measurement of the time such motions take.

Any type of chromatography, such as liquid chromatography can inherently contain variations in migration time of a sample through an apparatus. Various imperfections in the equipment used to supply and direct liquid or gas samples through small passageways may serve to create migration time variations. Additionally, the physics (viscosity, velocity profile of the flow, gravity, etc.) governing the flow of the sample through the passageways may also contribute to the variations in migration time. Additionally, apparatus such as chromatography columns may have varying performance characteristics due to age, wear, operating temperature, and so on. Additionally, the composition of the sample itself may cause varying performance, for example by overloading a chromatography column.

Analysis of sample data utilizing a hyphenated mass spectrometer measurement provides increased information on the composition of the sample under analysis and creates very large data sets which can be difficult to process. Additionally, variations in migration time through the chromatography portion of an apparatus may cause alteration in the amplitude of the mass peaks measured by a mass spectrometer. For example, comparing instrument response to two analyses of similar or identical samples, specific mass peaks corresponding to a migrating chemical may be shifted to earlier or later mass spectrum measurements and thus appear on earlier or later mass spectra. Much analysis of sample data is directed to attempts at categorizing a sample into an appropriate class. For example, it is desirable to classify samples to determine healthy from diseased, therapeutic drug response from pathological response, etc.

Methods described herein, include a method for processing the resulting data which utilizes the survey scan information from multidimensional separation tandem mass spectrometry type experiments to classify samples and has the potential to identify important proteins.

Pattern recognition MS: Pattern recognition techniques represent incomprehensibly large data sets in a comprehensible form, by extracting only relevant features. Pattern recognition allows a direct approach: using raw MS data to determine how similar or different samples are, then answering questions about proteins that distinguish the samples. Principal component analysis (PCA) and partial least squares discriminate analysis (PLS-DA) are two powerful linear algebra techniques for identifying factors that differentiate populations in a complex data set. PCA and PLS-DA are accepted pattern-recognition methods, and are the primary such methods used herein.

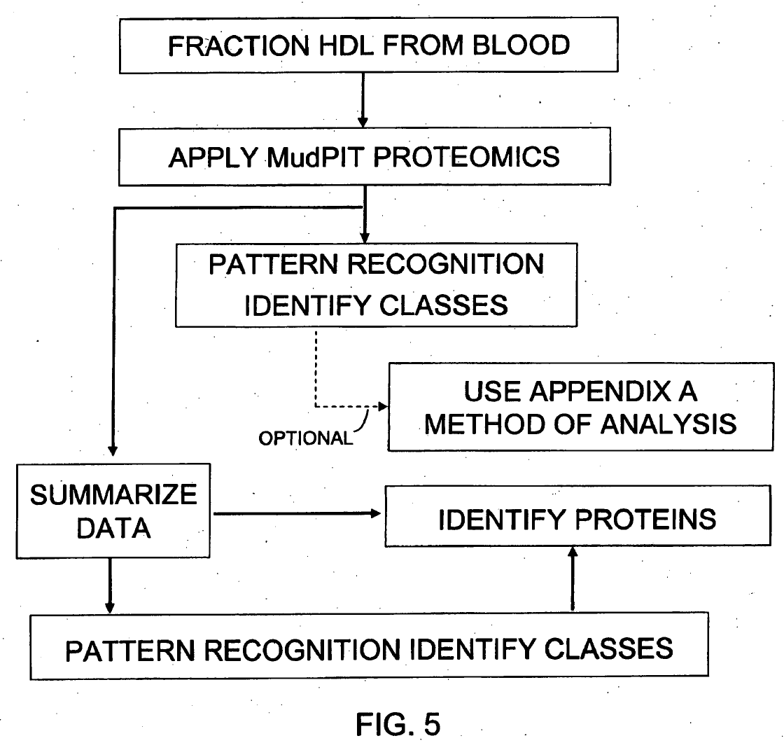

PCA is an unsupervised method. Unsupervised methods create pattern recognition models without a priori assumptions regarding relationships between individual samples. Unsupervised methods such as PCA are often used to explore and get a feel for large data sets. These methods offer the biologist an efficient and relatively straightforward map from which to chart future data analysis. As FIG. 5 shows, well-crafted application of PCA to proteomic MS data results in a visual picture of the relationship between samples.

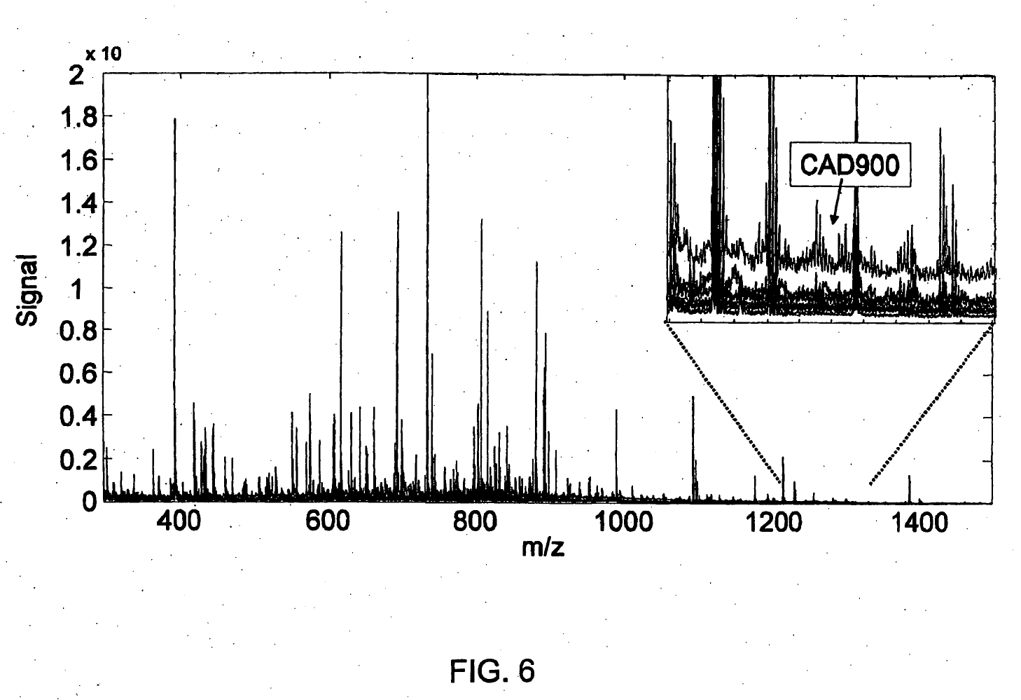

PLS-DA is a supervised pattern recognition technique. Supervised techniques use defined groups (such as case vs control) to “supervise” the creation of the pattern recognition model. Thus, PLS-DA can be used to determine if a new proteomics sample is a member of any of the previously defined classes of samples. Further, PLS-DA can reveal relationships between sample classes and identify distinguishing proteins. FIG. 6 shows a graph of peptide masses that distinguishes a sample class in the preliminary results, comprising a “mass signature” of the class relative to the other classes.

In PLS-DA analysis of proteomics MS data, patterns formed by the mass signatures of the peptides are identified. In this process, mass spectra generated from training samples are analyzed by supervised pattern recognition to identify a small subset of mass peaks that distinguish the classes of samples.

The experiments used to generate data for pattern recognition were extremely consistent in terms of protocol use. Data processing steps were identical for all samples. Furthermore, the scientists performing the analytical chemistry were blinded to case-control status, as were the data analysts. Importantly, even with the relatively small number of analyses in our preliminary experiments, the pattern-recognition models produced highly significant results. The model also produced information on mass peaks that varied between samples, and corresponding peptides were independently identified in MudPIT MS/MS analyses. Moreover, peptide peaks can be directly related to biologically significant information about the sample, and should be informative about biological mechanism.

Greater use can be made of pattern recognition for the analysis of proteomic data.

Summary survey scan mass spectrum (S³MS): When applying pattern-recognition to proteomics, variation in elution time may confuse the results. Data alignment techniques can diminish this problem, but alignment is computationally intensive and doesn't work well in all cases. An approach herein is called summary survey scan mass spectrum (S³MS). This technique integrates the survey spectra for each sample into a single summary spectrum, converting multidimensional separation MS data into a simpler format that is easily and quickly analyzed with well-understood pattern recognition techniques such as PCA and PLS-DA. Preferably, this technique integrates all of the survey spectra for each sample into a single summary spectrum. For ESI-MS, the S³MS is the baseline-corrected and normalized average of the survey scan mass signals along both axes of the 2-dimensional LC separation.

Not intending to be limited to one mechanism of action, it is believed the S³MS approach works because pattern recognition analysis requires precise data, but does not necessarily require selective signals. The signals of individual peptides can be overlapped, as long as the signal for a given peptide is the same from sample to sample. The survey scan mass spectral signals are the most precise, so they are preserved. The retention-time variation of HPLC and SCX results in lower precision hence those signals are summarized. Although pattern recognition of the summary survey scan mass spectra does not take advantage of the selectivity in the HPLC and SCX data, this method does use the separation of the sample to increase the dynamic range of the survey scan information and to improve the ionization characteristics of the mass spectrometer. MS/MS scan acquisition has low reproducibility of precursor ion selection, so MS/MS information is not included in the summary.

Profile expression before protein identification (PEPI): PEPI combines pattern recognition with novel instrument operation to substantially reduce analysis time and improve protein identification. First, several samples from all classes of interest (such as subjects with vs. without heart disease) are interrogated via either ESI-MS or MALDI-TOF-MS (with no MS/MS). The data are analyzed with pattern recognition, and the resulting regression vectors are examined for mass peaks that differentiate samples. In pattern recognition, a model is developed. The class of a new sample is predicted by multiplying regression vectors from the model by the signal of the new sample. Mass peaks in the regression vectors consist of candidate precursor masses for peptides that differentiate sample classes.

To identify the peptides responsible for these mass peaks, one or two samples from each class with MS/MS are reanalyzed, identifying proteins via conventional MS/MS methods. Dynamic exclusion is used to limit precursor ion mass to the list of mass peaks from the regression vectors. It is therefore possible to determine which proteins distinguish classes of interest. Identification of specific proteins that are enriched in specific populations of patients may point to mechanisms that are important in the pathogenesis of disease.

Because potential peptide masses are identified before MS/MS is started, MS/MS scanning is targeted at a more selective set of peptides. Identification of a peptide in only one sample is sufficient, if biologically similar samples are being compared. Consequently, this method is not only faster, but should also offer nearly complete coverage for proteins of interest. Control software limitations for some instruments will require that multiple MS/MS runs be acquired for complete coverage the m/z values of interest. Such instruments can still be used with this method, but instruments with more flexible control will show higher productivity. In any case, the proposed method should substantially improve instrument throughput over current methods.

The pattern information can also be used to identify proteins in the original MS spectra by mass mapping. Because pattern recognition will separate the signals of the peptides that distinguish the classes from the other peptides and because multiple spectra in multiple samples can be considered, these techniques may be much more effective than typical mass mapping of a complex mixture.

For ESI, PEPI should be 50-100 times faster than MudPIT for many experiments, and avoid MudPIT's MS/MS coverage problems. This approach should also offer nearly complete coverage of biologically relevant peptides in samples analyzed by MS/MS. We anticipate similar benefits from applying PEPI to MALDI.

Apparatuses and methods are described herein, for processing data obtained from a complex sample. In some embodiments, “summarizing techniques” for processing data to overcome variations in migration time are described. In some embodiments, classification of blood sample data into two or more classes is described to classify a control group from a group of people diagnosed with CAD. In some embodiments, classification of a control group from a diseased group (CAD) and a treated group is described. Classification of groups has been shown, in some embodiments, to quantify the success of treatment of a diseased group that underwent treatment using statins for one year. In some embodiments, processing of data using “summarizing techniques” of data from a mass spectrometer survey scan reduces the effect of variation in migration time on the survey scan. In some embodiments, “summarizing techniques” are applied to MudPIT proteomics measurements to reduce the effects of variation in migration time on the survey scan. In some embodiments, “summarizing techniques” ate used together with pattern recognition to identify proteins from mass spectrometer survey scan measurements. Apparatuses and methods described in WO 2005/096765, filed on Apr. 2, 2005, entitled, “Method and Apparatuses For Processing Biological Data,” is incorporated herein by reference for all purposes.

Complex samples include biological samples, complex natural samples, and process control samples. Biological samples include any sample that is part of an organism, a substance containing an organism, a fluid produced by an organism, such as blood, etc. A complex natural sample is a sample from “nature” for example, any sample from the natural environmental world: geological samples, air or water samples, soil samples, etc. Process control samples are samples taken from a manufacturing process to measure quality, purity, efficiency, control of contaminants or by-products, etc.

The three types of complex samples listed above are not firm classifications and a complex sample can be in more than one of these categories. For example, a sample from a brewery operation could be both a process control sample and a biological sample. No limitation is implied within the embodiments of the present invention by the complex sample. As used within this description of embodiments of the invention, “complex samples” may be referred to as a “biological sample,” a “complex biological sample” or similar terms; no limitation is intended thereby.

Chemical analysis of complex biological samples like the proteins within an organism, often require multiple analytic techniques to be combined or hyphenated; thereby, producing a data set that is too large to be stored in the addressable memory of a data processing system. Analysis of the output of many different kinds of measurement techniques can be performed with various embodiments of the present invention. Multiple measurement techniques are combined or hyphenated to produce multidimensional biological data sets.

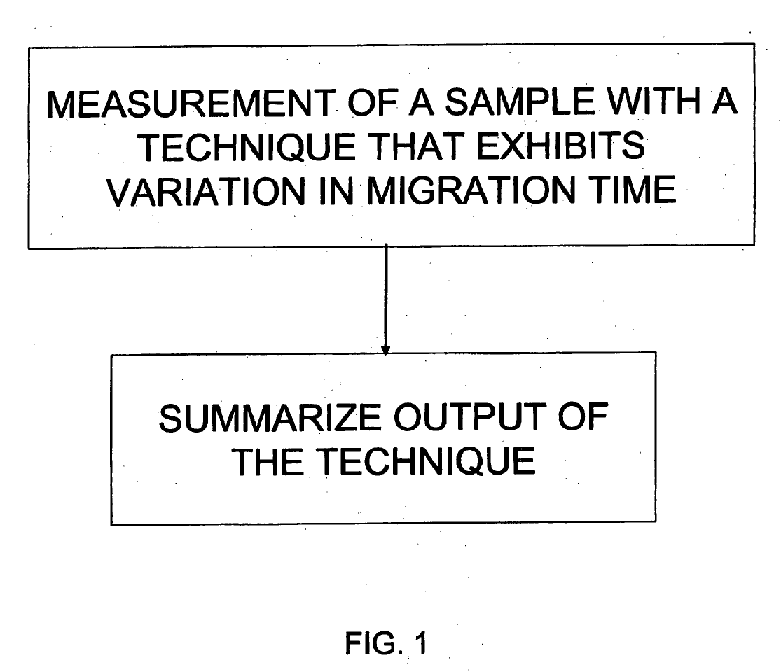

FIG. 1 illustrates a flow diagram for summarizing a measurement made from an analysis technique that has variations in migration time, according to some embodiments of the invention. Summarization is an effective approach for any multidimensional analysis technique, where one dimension has significantly higher precision than some other dimensions. In general, to summarize such data, one or more of the less precise dimensions are summed up, leaving the most precise and perhaps some other dimensions intact.

A complex sample, such as those described above, typically contains many different chemicals. One way to analyze such a sample is to separate the different chemicals with chromatography so that (for example with liquid chromatography) a small stream of liquid is produced containing the sample, but the sample is spread out in time in the liquid so that only a few chemicals appear in the stream at any one time. This stream is then put into a mass spectrometer which measures all of the chemicals in the stream at the time the sample is collected. Operating in survey mode, a mass spectrometer measures the stream at a plurality of points in time producing a series of mass spectrum measurements thereby. Each mass spectrum illustrates a mass distribution with respect to the constituent materials found in the sample at the time the sample was collected. The spectra taken together show the mass distribution of the samples found in the stream at the times the samples were collected.

In one embodiment, the individual mass spectrum measurements from the survey scan are added up to produce a summarized output spectrum For example, if mass spectrum 1 had an intensity of 10 for mass 400, and mass spectrum 2 had an intensity of 5 for mass 400, then the summary spectrum would have a value of 15 for mass 400. As is known to those of skilled in the art, the intensities are typically plotted on an arbitrary scale. “Mass” is typically measured indirectly using a value called-“m/z” mass to charge. The result of the summarizing is to reduce the effect that variations in migration time have on the resulting summarized mass spectra.

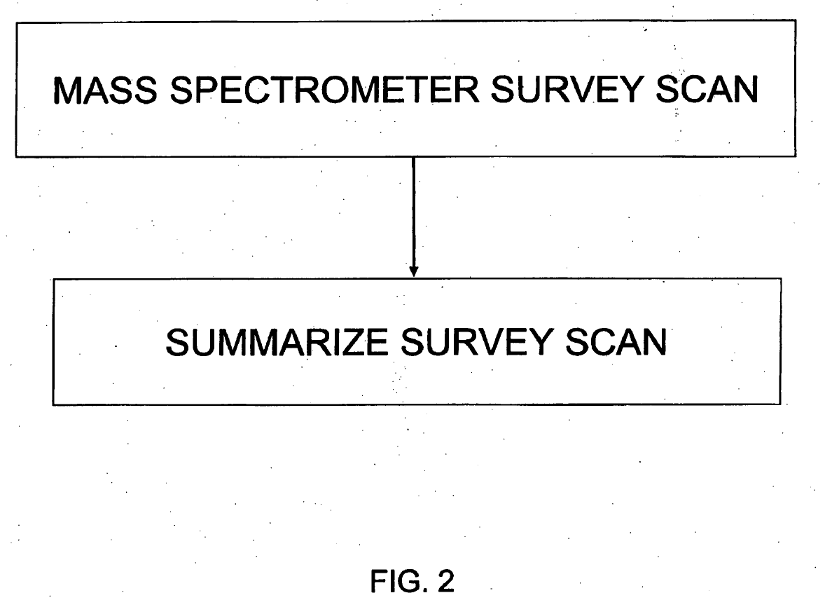

FIG. 2 illustrates a flow diagram for summarizing a mass spectrometer survey scan, according to some embodiments of the invention. In some embodiments, any number of the individual spectra from the survey scan can be summarized, from two all the way up to summarizing the entire survey scan. In some embodiments, the integration function used to produce the summarized spectrum can be a simple sum of the mass peaks, as described above, or a function can be applied across the spectra, such as a rolling average or weighted average. Signal processing, such as noise suppression, can be applied before integration, after integration, or both. The summarization process reduces the amount of data contained in the former survey scan spectra, while providing insensitivity to migration time variations that were present in the individual spectrums before summarization. A summarized survey scan, as in the embodiments of the present invention, provides information that was heretofore not available for analysis since there is more information in the summarized spectra than was available in any individual spectrum of the unsummarized survey scan. The information in the summarized spectra was formerly distributed across the survey scan spectra.

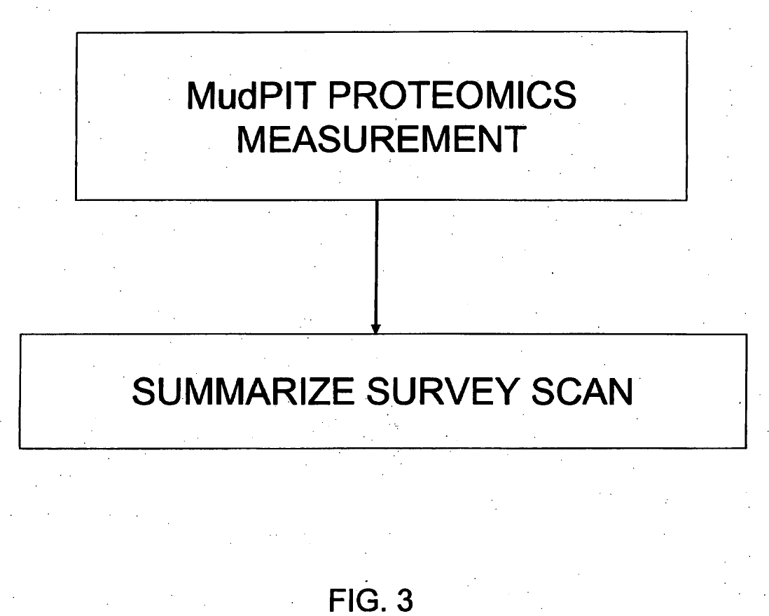

In various embodiments, the integration can be performed across a single separation dimension or across more than one separation dimension, as in classic MudPIT proteomics, where the mass spectrometer is preceded by a strong cation exchange separation and a more conventional micro liquid chromatography dimension. FIG. 3 illustrates a flow diagram for summarizing a MudPIT proteomics measurement, according to one embodiment of the invention.

In various embodiments, various kinds of alignment can be applied to the sample data, which may be desirable in some cases. However, one advantage of the summarization is that it is applicable to experiments where variation in the separation regime is too great to permit automated alignment of the data. Also, alignment algorithms are usually computationally intensive. Summarization allows this computationally intensive technique to be skipped and presents a smaller data set for pattern recognition. Smaller data sets generally allow pattern recognition algorithms to run faster, utilizing less computation resources, which allow results to be produced at a lower cost.

In various embodiments, the summarization techniques can be used with a tandem mass spectrometer measurement, where one or more survey scans are alternated with a constant or variable number of tandem scans on a mass window. The mass window is often, but need not be, small compared to the mass range of the survey scan. In one embodiment, MudPIT proteomics is an example of a hyphenated, tandem mass spectrometer technique.

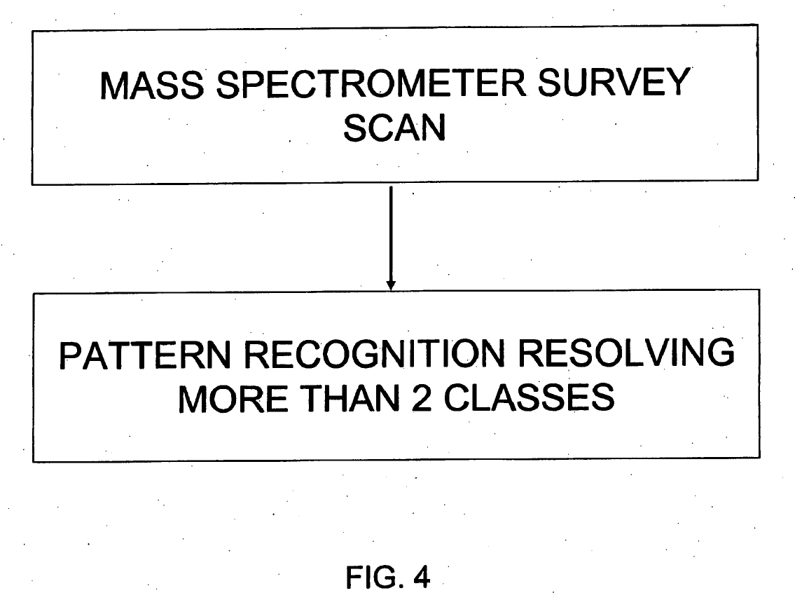

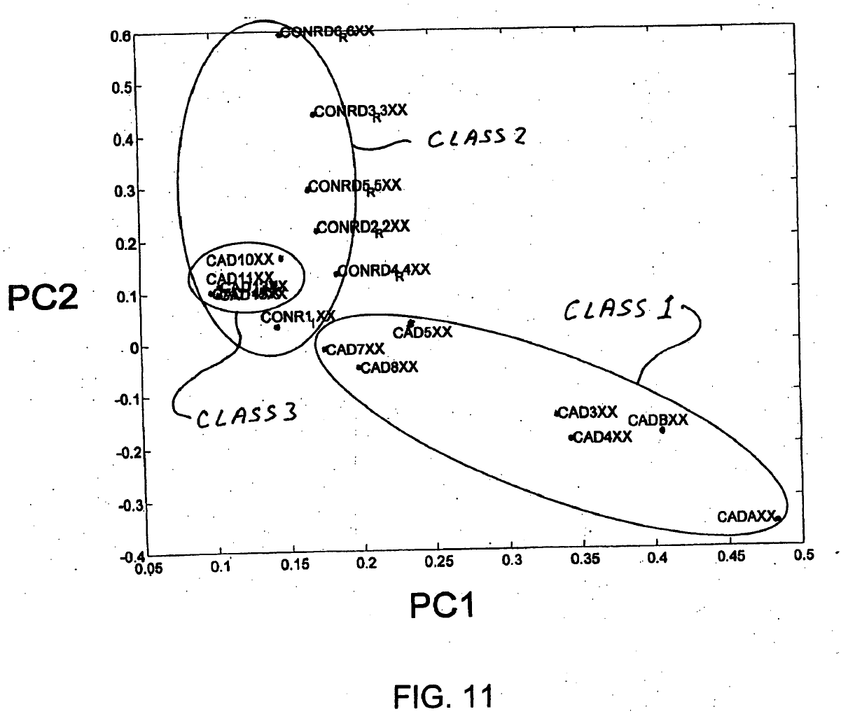

In various embodiments, sample data can be classified based on the analysis of the data produced via separations (chromatography) and mass spectrometry, as well as with other analytical techniques. FIG. 4 illustrates a flow diagram to resolve samples into more than two classes utilizing pattern recognition according to one embodiment of the invention. Classifying more than two classes is described more fully below in conjunction with FIG. 11 through FIG. 13.

FIG. 5 illustrates a flow diagram to process and analyze blood samples, according to various embodiments of the invention. In one embodiment, pattern recognition is performed on summarized spectra of processed blood sample data. Samples of blood were fractioned by ultracentrifugation to obtain high density lipoprotein (HDL). Embodiments of the present invention are not limited to samples processed via ultracentrifugation to separate or fraction the HDL, any method can be used. For example, HDL could be fractioned from the blood sample using a typical purification technique operated in reverse: antibodies that are usually used to remove Apolipoprotein A1 could instead be used to purify Apolipoprotein out of the blood. Other techniques can be applied as well.

After extracting the blood fraction of interest, a preparative chemistry is usually applied to the sample. Generally, this step is necessitated by the limitations of currently available mass spectrometers. For example, in MudPIT experiments, the fraction is digested with trypsin or a similar digest to cut the proteins into pieces (called peptides) which are small enough to be analyzed with a mass spectrometer. Other purification and processing steps typical in biochemistry may be applied to the sample, as required, consistent with the experimental configuration used for analysis.

The samples were subjected to mass spectrometer survey scans alternating with tandem scans, and the resulting survey scan spectra were summarized utilizing the techniques described above resulting in the summarized spectrum illustrated in FIG. 6. In various embodiments, pattern recognition is applied to the summarized spectrum illustrated in FIG. 6. In various embodiments, the tandem spectra are not generated, or are generated for only some samples.

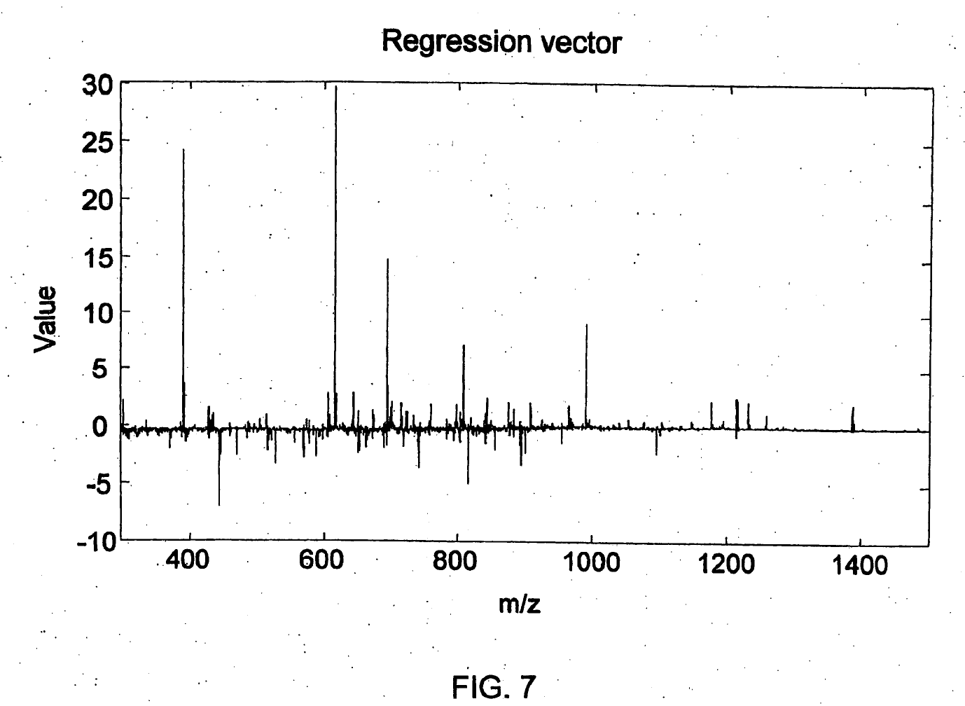

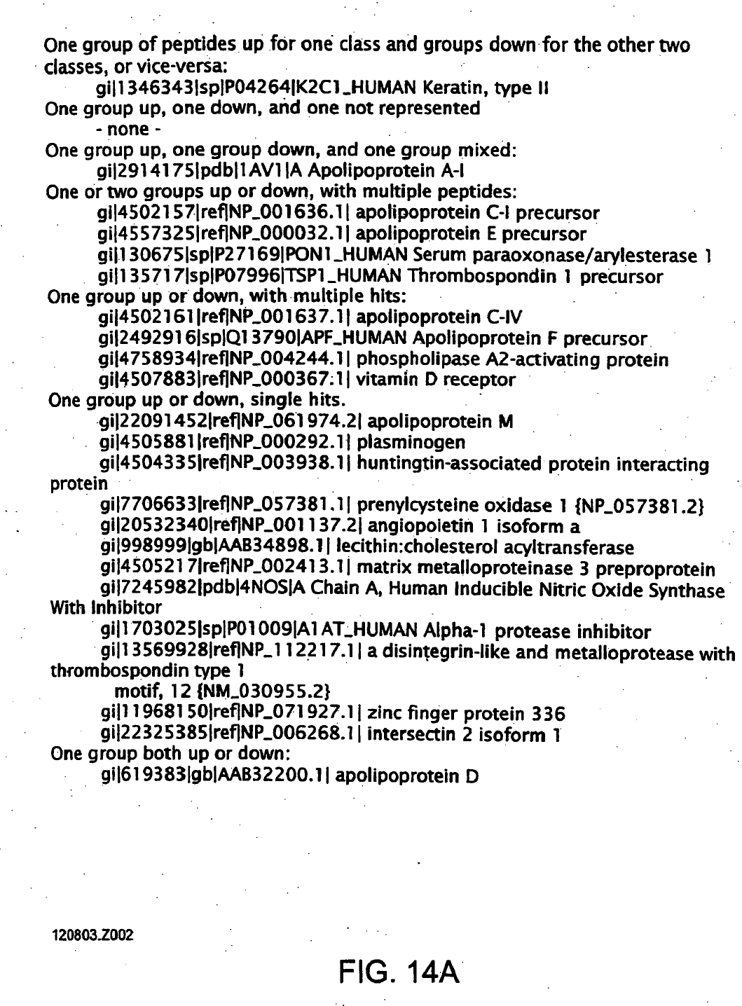

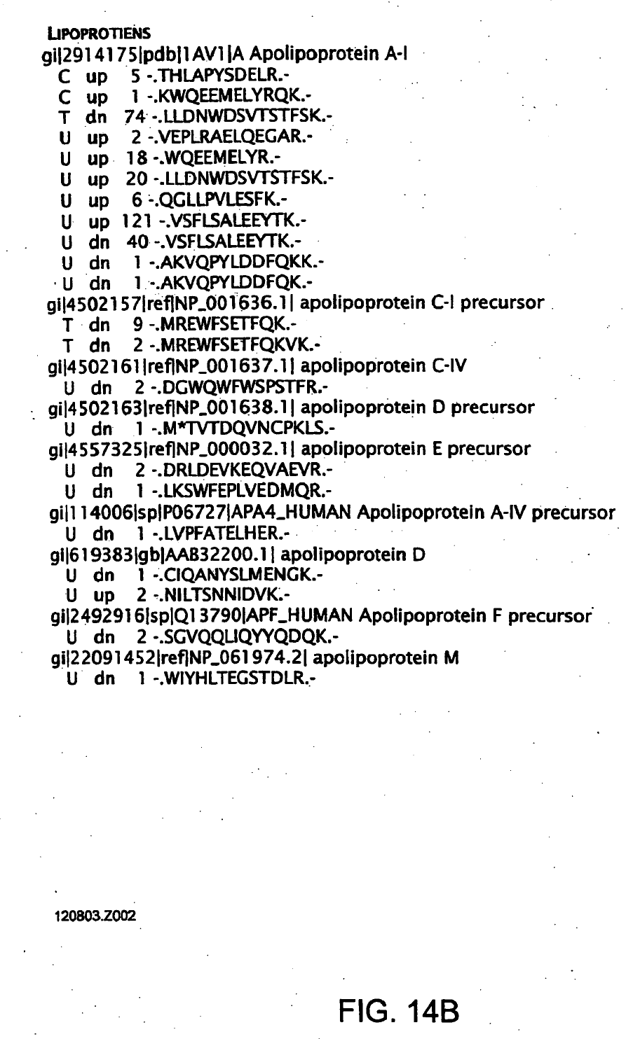

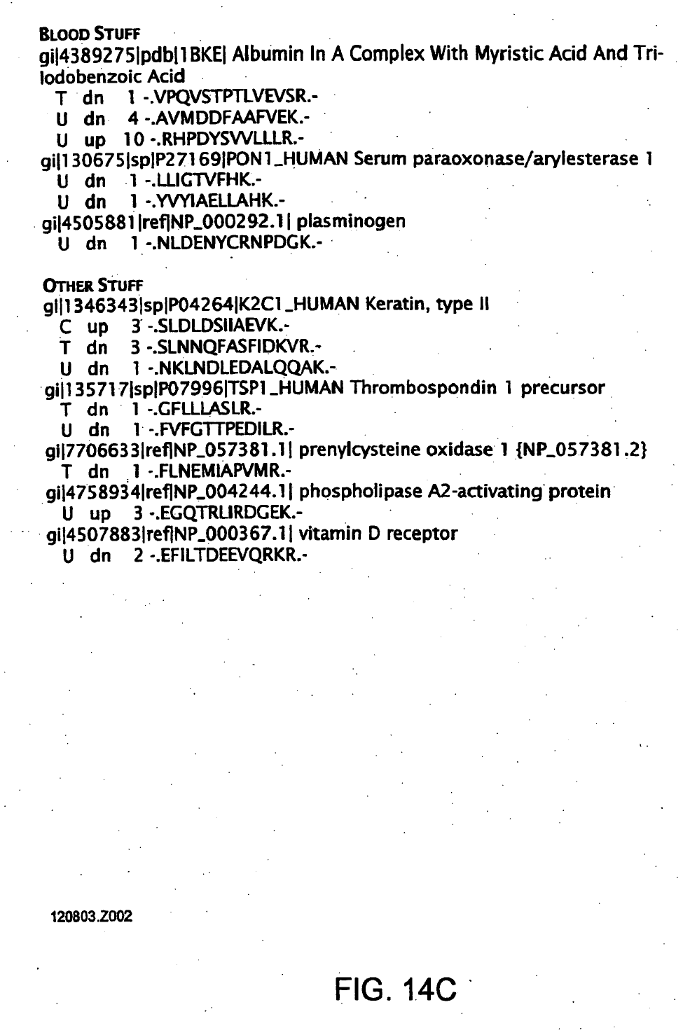

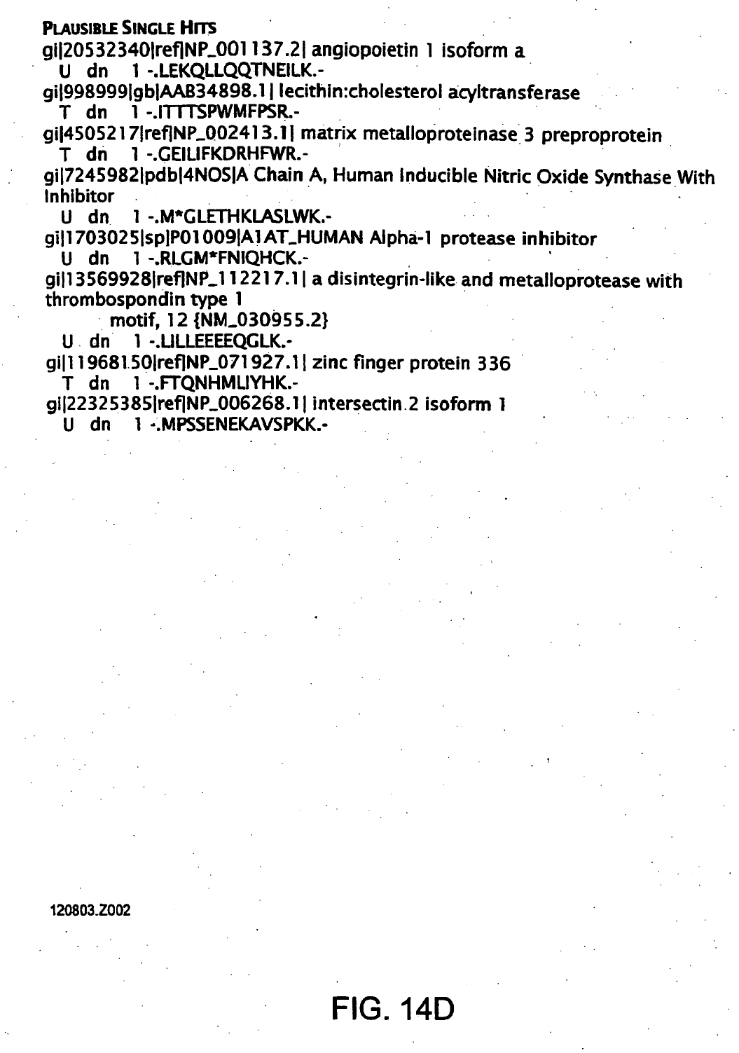

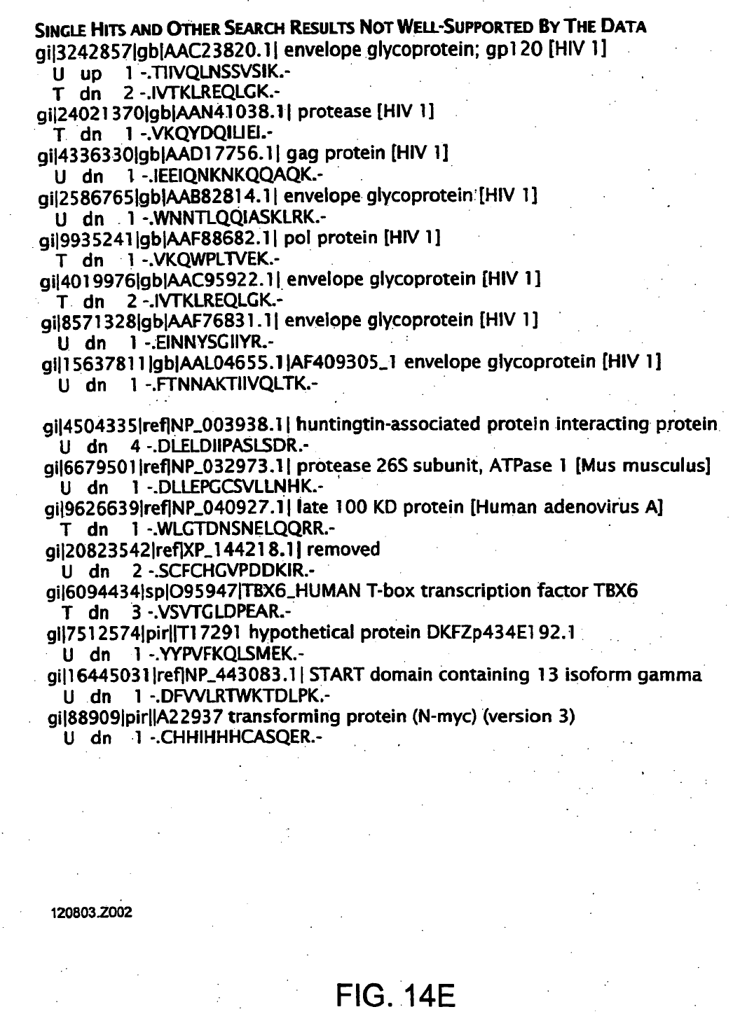

FIG. 7 displays a regression vector, which is related to the pattern recognition model used to analyze the data shown in FIG. 6. The mass peaks in the regression vector of FIG. 7, are analyzed to determine the mass values that explain the differences between sample classes. These mass peaks can be used, depending on the experiment either by themselves or in conjunction with tandem mass spectrometry scans and/or other information, to identify peptides and proteins that the peaks in individual samples are comprised of, and hence can be used to identify the peptides and proteins that individual mass peaks in the regression vector are caused by, as described below in conjunction with FIG. 14A through FIG. 16H.

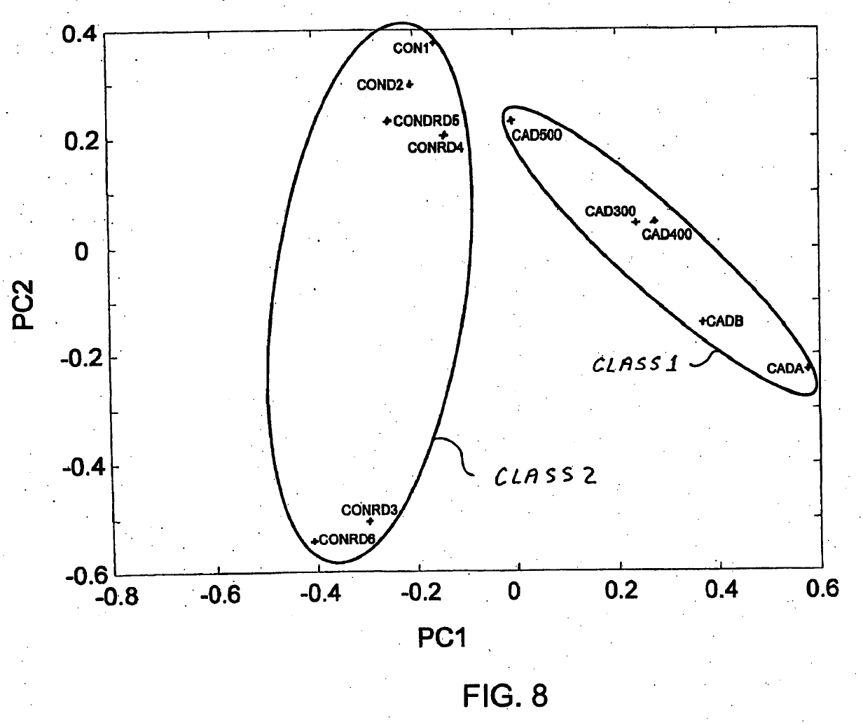

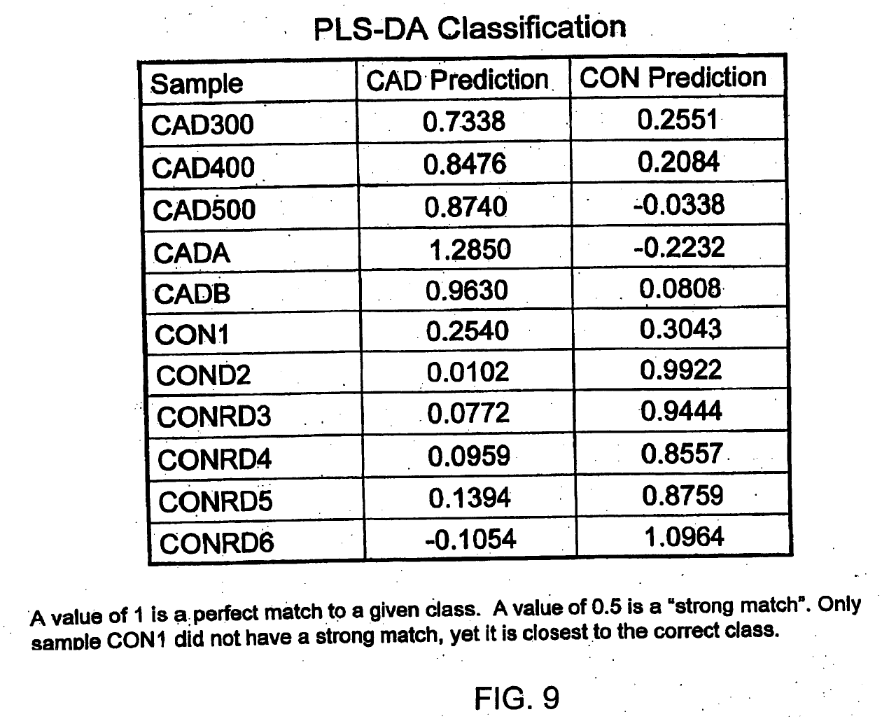

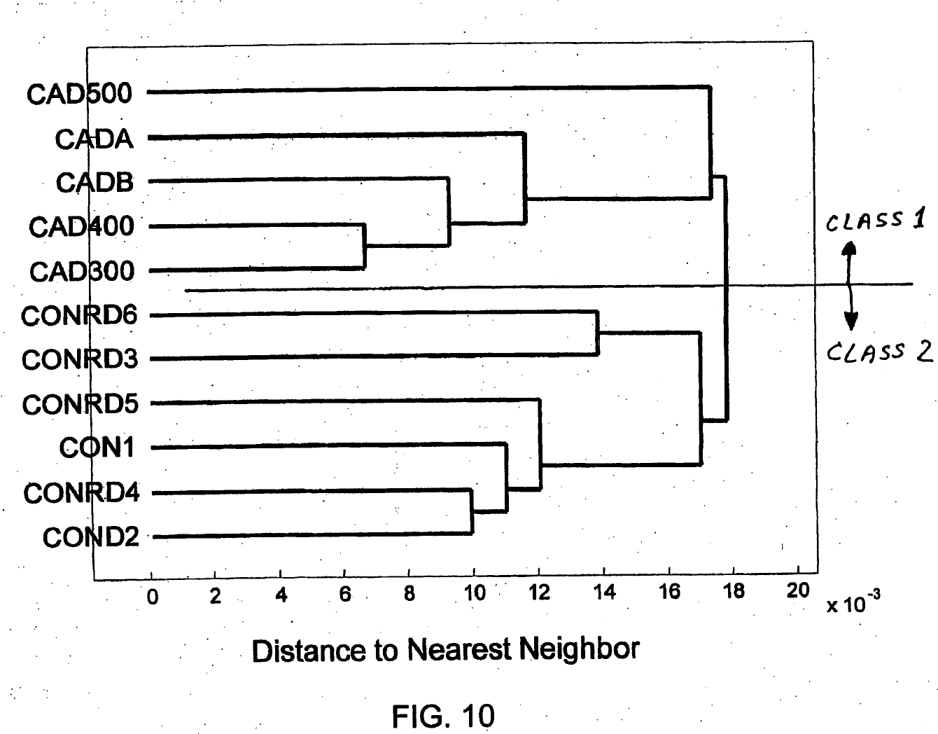

FIG. 8 shows a result of applying pattern recognition to the data of FIG. 6 utilizing principal component analysis (PCA), according to some embodiments. Two classes are evident in FIG. 8, Class 1 and Class 2. Class 2 consists of blood samples taken from people who were diagnosed with coronary artery disease (CAD). Class 2 represents the control group. People in the control group have not been diagnosed with CAD. Samples of blood were collected from the people and the analysis of the samples was performed at the time of diagnosis. The pattern recognition applied to the samples of people within the two groups has resulted in a two class designation utilizing an unsupervised model for pattern recognition. Supervised models are equally applicable as demonstrated below in conjunction with FIG. 9 and FIG. 10.

FIG. 9 shows a result of applying pattern recognition to the data of FIG. 6 utilizing a supervised model according to one embodiment. In FIG. 9, partial least squares (PLS) analysis has provided a grouping of the samples into two classes. A value of 1 indicates a perfect match to a given class. A value of 0.5 indicates a “strong match.” The control samples are indicated with the prefix “CON” applied to the sample name. All of the control samples provided a strong match, except for sample CON1 which was close to its class. The diseased samples are indicated with the prefix “CAD” and all indicate a strong match having a value greater than 0.5.

Another supervised pattern recognition model was used to classify the data represented by FIG. 6. In FIG. 10, the K-Nearest neighbor algorithm classified the two groups successfully as shown, with Class 1 members falling above the horizontal line and Class 2 members falling below the horizontal line. FIG. 11 shows identification of three classes from a data set using principal component analysis (PCA) for pattern recognition according to one embodiment. Within respect to FIG. 11, blood samples from three groups of people were analyzed. People in Class 1 were diagnosed with CAD. People in Class 2 are the control group. People in the control group have not been diagnosed with CAD. Class 3 represents blood samples taken from the people of Class 1 after one year of treatment with statins. From FIG. 11 it is noted that after one year of treatment, the people from Class 1 have undergone changes that have resulted in the classification of their blood as more resembling the “healthy” condition than before treatment. Thus, the techniques taught by embodiments of the present invention lend themselves to diagnostic methods and apparatuses for the quantification of a medical treatment regimen, diagnostic testing, etc.

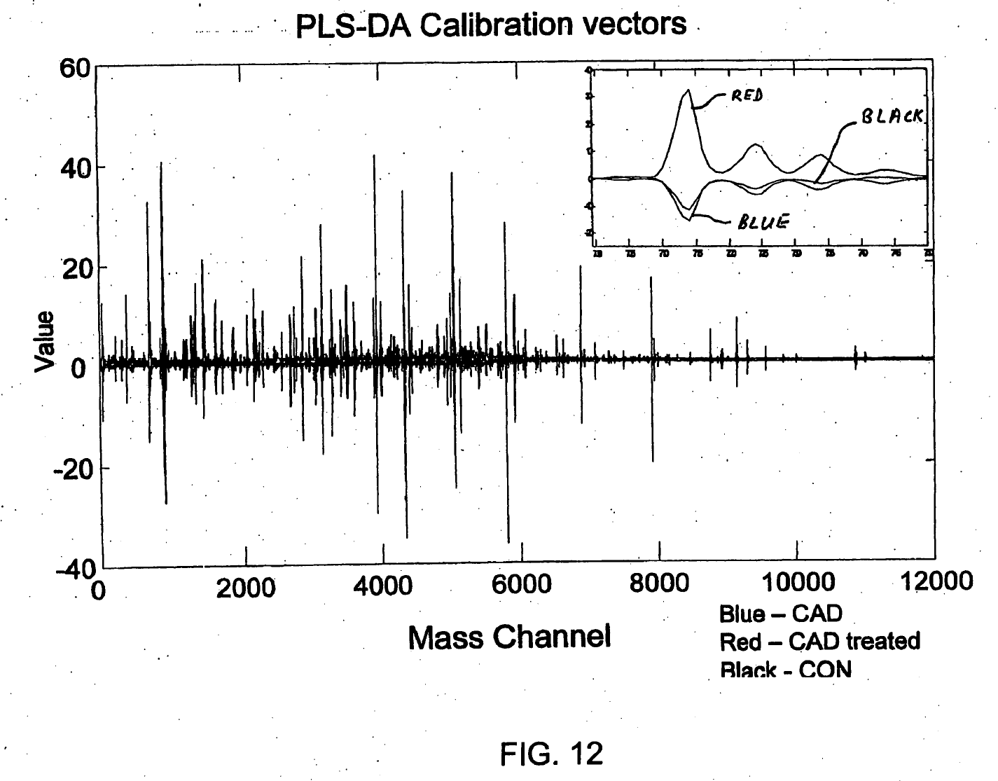

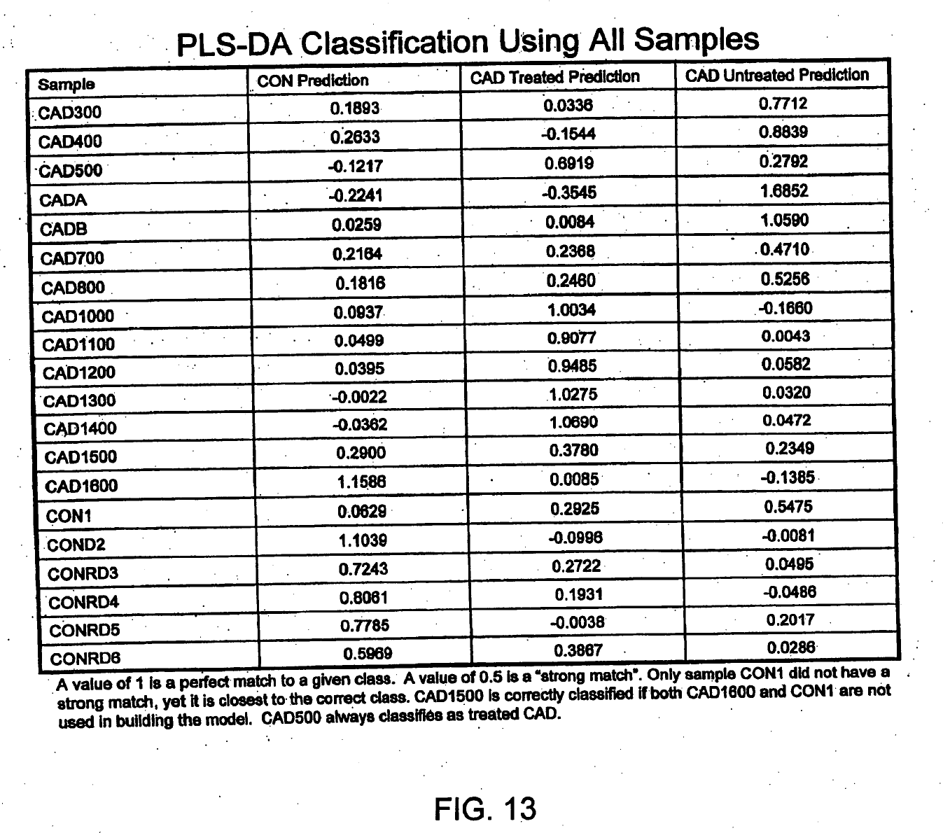

Supervised models can be used to classify the data set used for FIG. 11. FIG. 12 shows a calibration vector for a partial least squares (PLS) pattern recognition analysis of the data of FIG. 11. FIG. 13 shows identification of three classes from the data of FIG. 11 using a PLS pattern recognition analysis according to one embodiment. Utilizing the techniques herein in various embodiments, the speed at which proteomics and similar experiments such as MudPIT-type experiments can be performed can be increased appreciably. For example, the separations are performed as usual, except the mass spectrometer is operated only in survey mode. This permits the separation to be run much faster, gaining more productivity from a given mass spectrometer. Pattern recognition is then applied to the summarized data from multiple samples, producing classes.

The techniques herein can be extended in a variety of ways, such as but not limited to, summing spectra over various regions of the data. The technique has application to biological research as well as diagnostic testing. In biological research, the technique is useful for very fast assessment of sample data. Also, a very large number of samples can be quickly explored. In various embodiments, the techniques can be used to obtain over an order of magnitude more productivity from mass spectrometers for biological research; the mass spectrometer is run to conduct survey scans only, analyzing a sample in approximately an hour that would have taken approximately a day using tandem mass spectrometers. The resulting spectra are summed and pattern recognition techniques, such as examination of the loadings for Partial Least Squares (PLS), are applied to identify mass peaks of interest. Then, one or more of the samples (or a mixture of them) are run using conventional tandem mass spectrometers, selecting the previously-identified mass peaks further fragmentation to identify differentially regulated peptides in the samples.

If too many mass peaks are identified, due to limitations of currently available mass spectrometers, then the technique can be modified. Pattern recognition can be applied to the whole data without summing the mass spectra, but typically after alignment of the chromatography. Or the data may be partly summed, typically with correspondingly less alignment. Regression vectors can then be used to identify mass peaks of interest at particular times, which can be used to select ions for further fragmentation at various times in the separation. Information from the pattern recognition model, such as the loadings matrix or, as it is also known in the art, the regression vector is examined to identify peaks that contribute to the class structure. The identity of molecules producing peaks can be identified using several different methods.

In one method, mass fingerprinting is applied to mass peaks in the loadings matrix. In another method, the experiment is repeated with a tandem mass spectrometer and at a slower elution time. The mass peaks (and optionally elution times) are used to develop a list of mass peaks to select for further fragmentation. This list is presented to the mass spectrometer, either as a script list or via a similar automated method or manually or with multiple manual steps throughout the mass spectrometer run to change the peaks selected. The choice of approach depends on the volume of experiments to be conducted and what data the mass spectrometer will accept. Peptides in peaks are then identified using conventional proteomics or a conventional search combined with a statistical weighting for elution times.

In various embodiments, following summation of a mass spectrometer survey scan, as mentioned above, the proteins that constitute the mass peaks can be identified by various means. One method correlates tandem MS spectra of peptides against sequence databases, resulting in peptide and corresponding protein identifications. Because this is a peptide sequencing method, complex mixtures of proteins can be directly interrogated as the mass spectrometer automatically isolates and analyzes the individual peptide components. This approach is also applicable to peptides that have undergone post-translational modifications. All sequence databases (including raw genomic, transcript, and Expressed Sequence Tag) can be searched against.

For FIG. 14A-14E, this was done by looking at the survey scan m/z values which were determined to be of interest by the summing technique and PCA, then selecting all tandem scans with a precursor mass (m+H) value which could reasonably derive from such m/z values (2+ and 3+parent charge states were assumed). As it is possible for an m/z value to result in multiple plausible m+H values, the list of tandem scans can be considered to present a reduced list of tandem scans worthy of investigation. Due to duty cycle restrictions, the tandem MS scans may not normally contain enough information to comprehensively identify all of the peptides corresponding to the identified mass channels. The traditional approach is to repeat the MudPIT experiment. Another approach is to use mass fingerprinting. In some embodiments, the methods described below to develop a fast “diagnostic technique” are used to do the tandem scans more comprehensively after identifying precursors masses of interest.

In the case of the figures herein, the tandem scans were used to produce SEQUEST dta files and out files, then mass values from the regression vectors were used to select “.out” files of interest. It is also possible, of course, to select only the most likely “.dta” files for submission to SEQUEST, thus saving considerable search time. As is known to those of skill in the art, SEQUEST is a search engine for identifying peptides and proteins from tandem mass spec data, “.dta” is the input file format to SEQUEST, it contains a tandem scan, “.out” is the resulting file which contains info on which peptide SEQUEST thinks the tandem data probably represents. FIG. 14A-14E shows a list of proteins organized by their pattern of regulation, according to some embodiments.

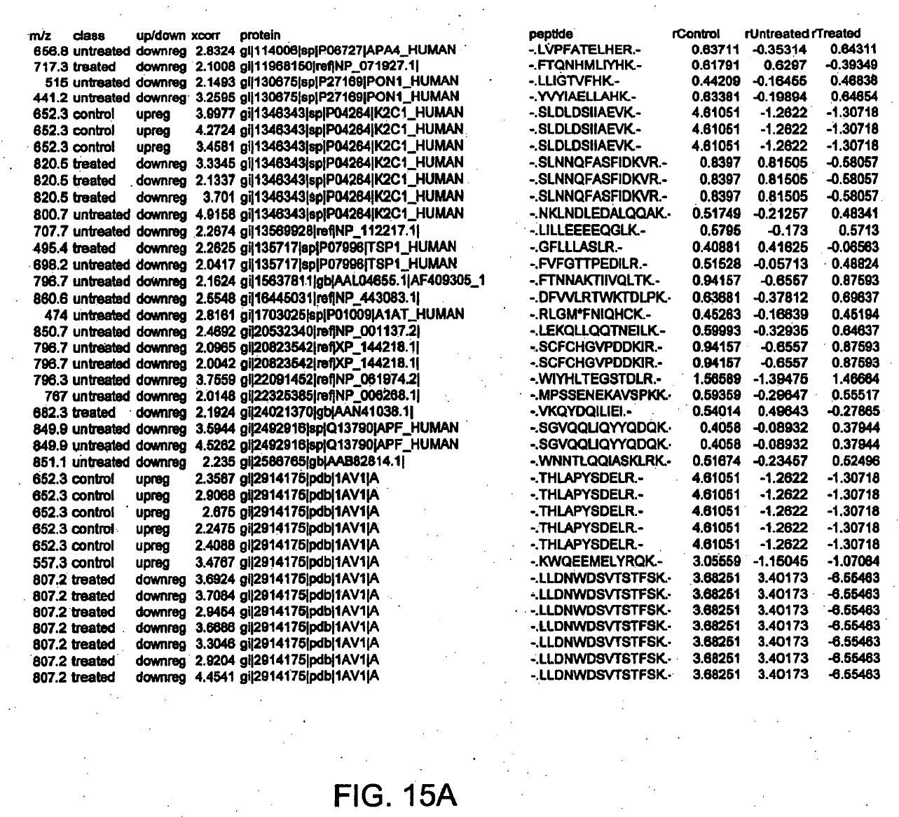

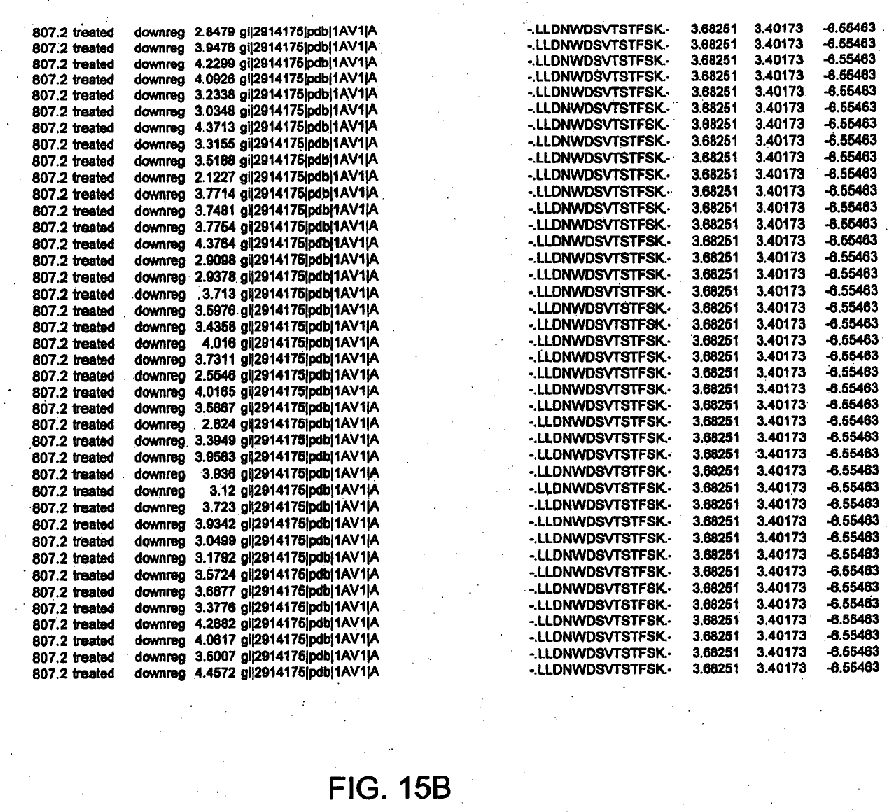

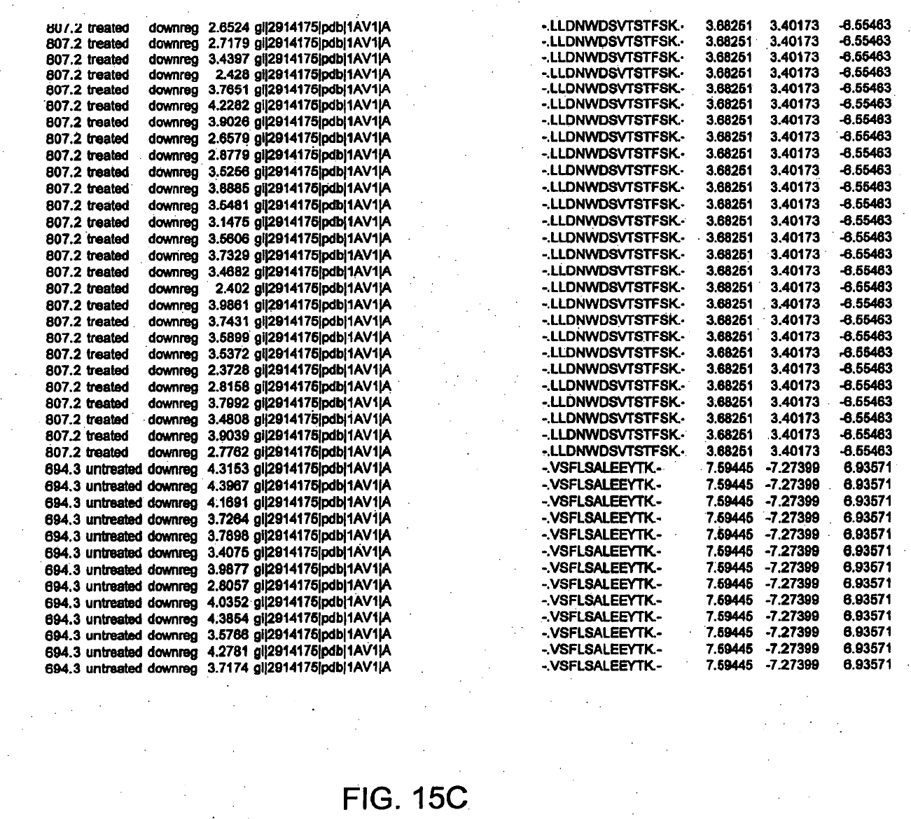

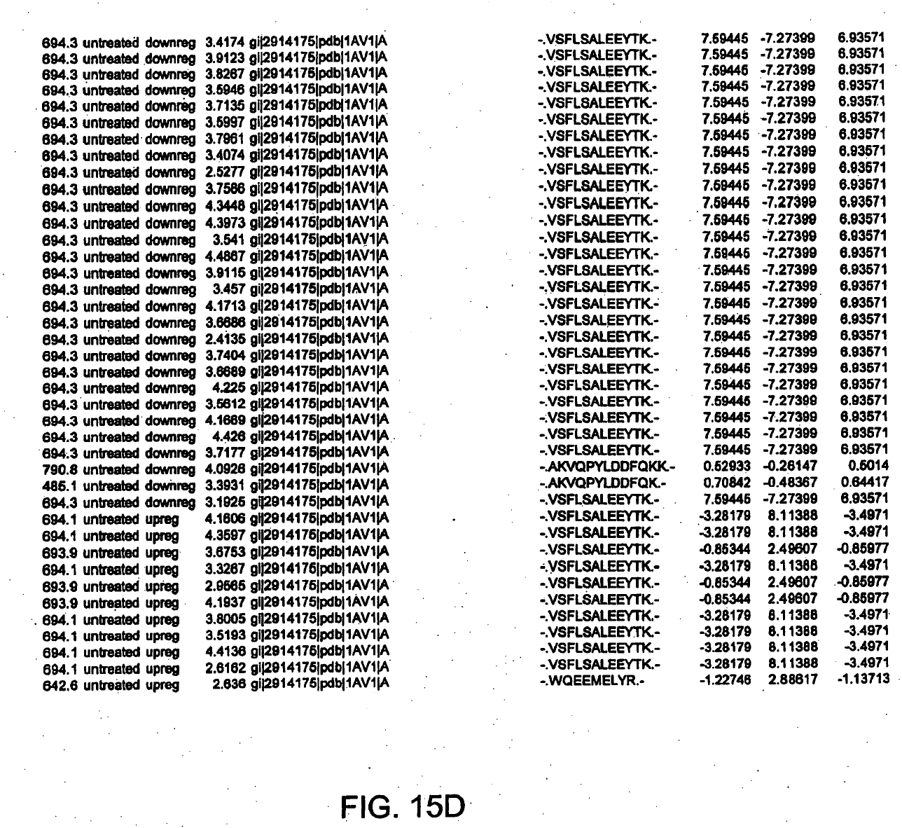

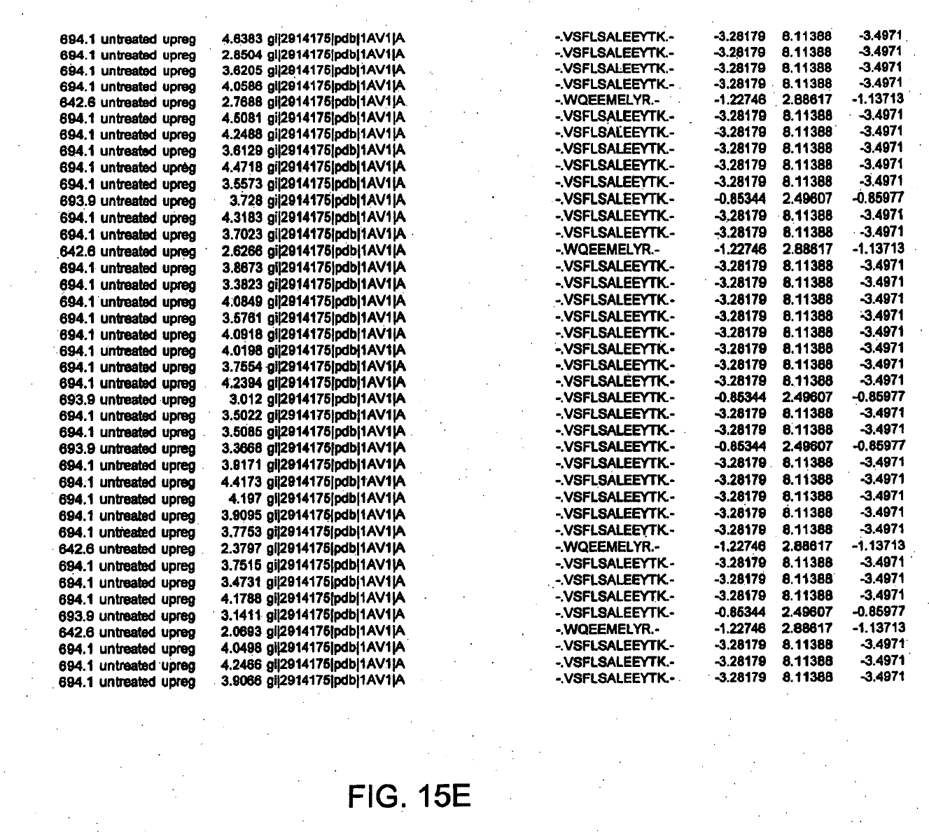

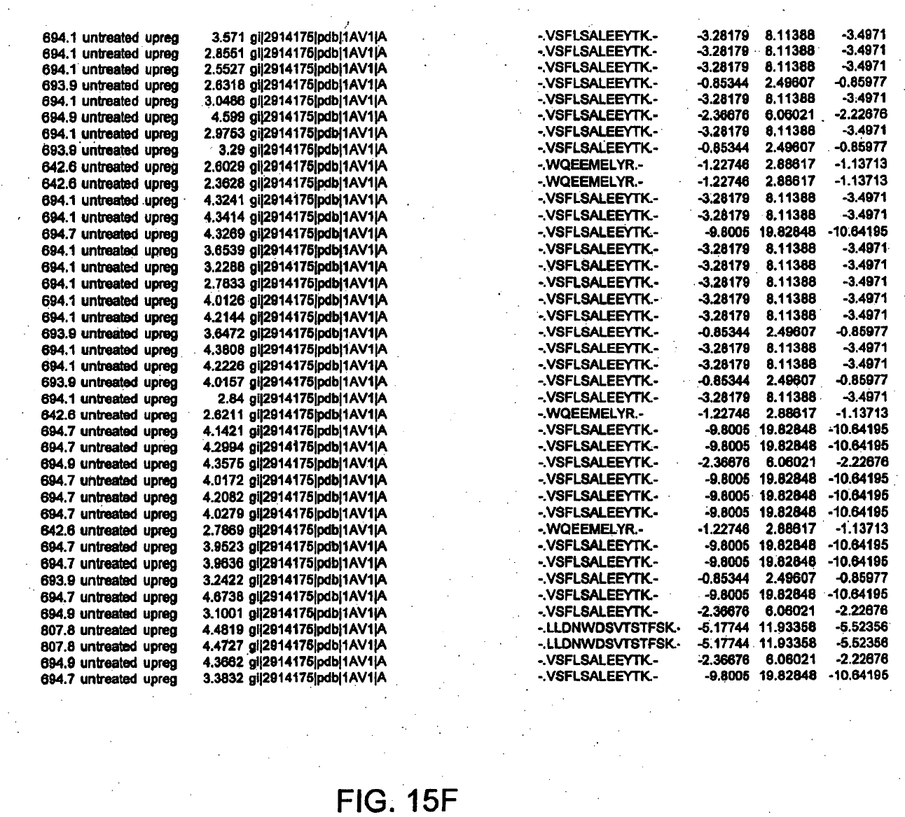

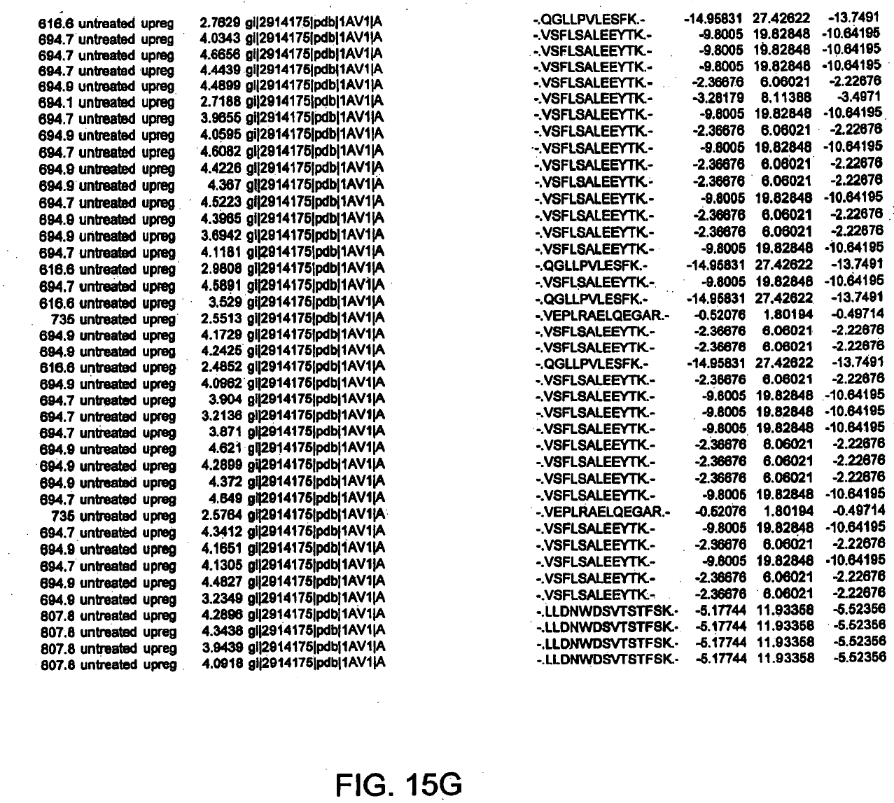

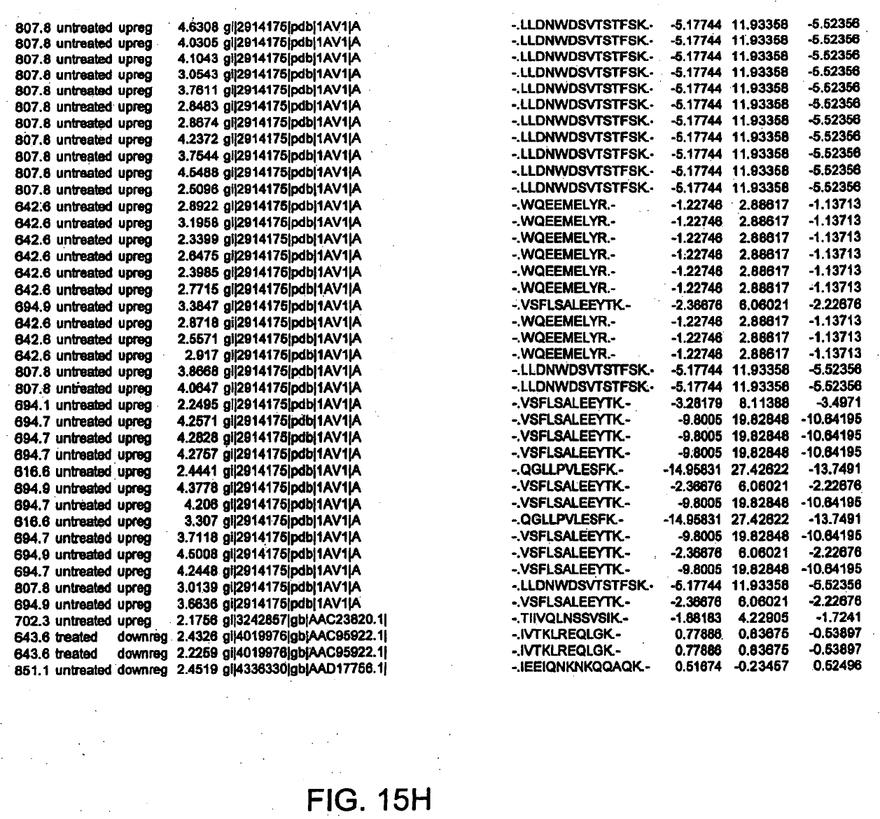

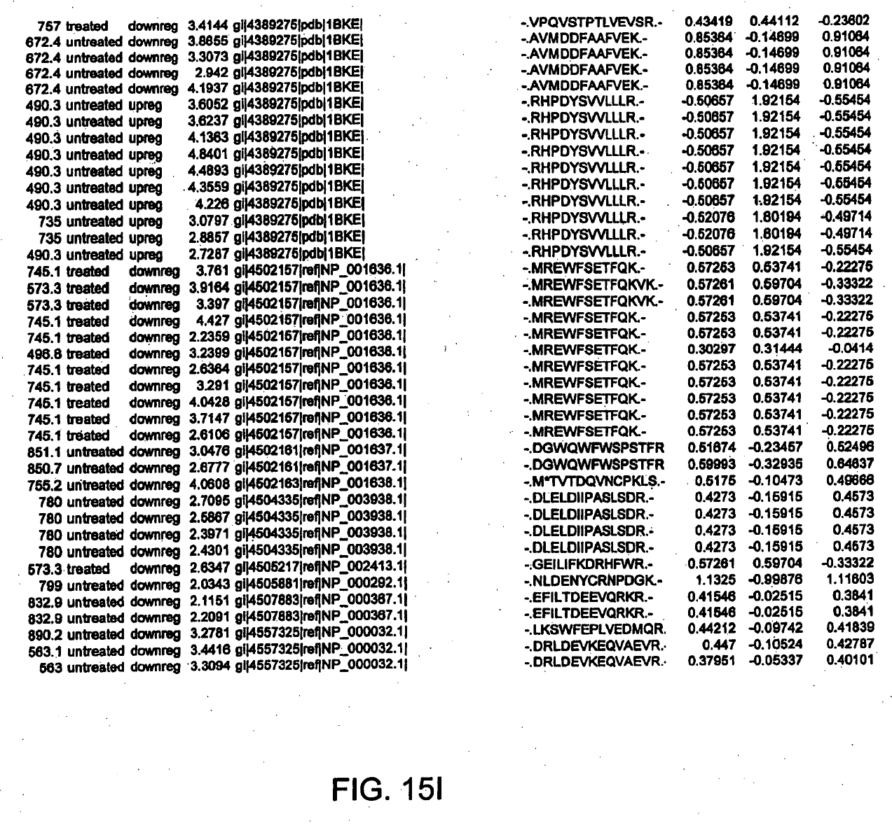

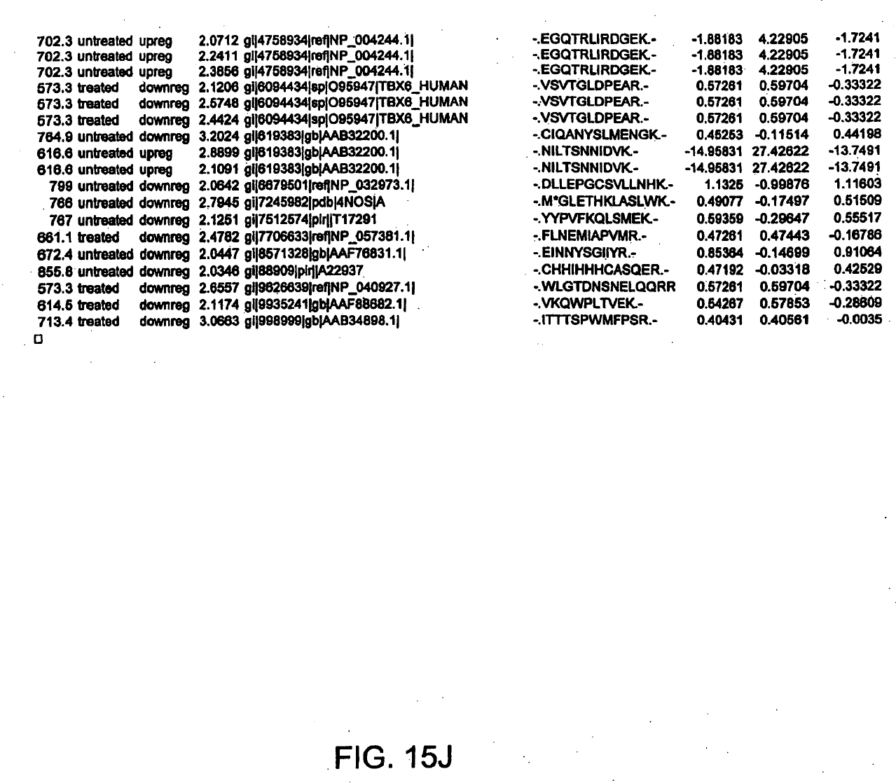

FIG. 15A-15J shows a list of proteins and the corresponding mass peaks and peptides representative of the data from FIG. 11, according to some embodiments. The m/z value in the leftmost column corresponds to the peptide mass in the rightmost column. The protein column shows the protein, the search engine SEQUEST assigned to the peptide. Class indicates the group (controls, before treatment, or after treatment) that showed a difference relative to the other two classes. Up/down shows whether the class had more of this peptide compared to the other two classes (up) or whether the class had less of this peptide relative to the other two classes (down). Xcorr is a value from SEQUEST estimating the confidence of the identification. The rControl, rUntreated, and rTreated columns show the value of the regression vectors for each class.

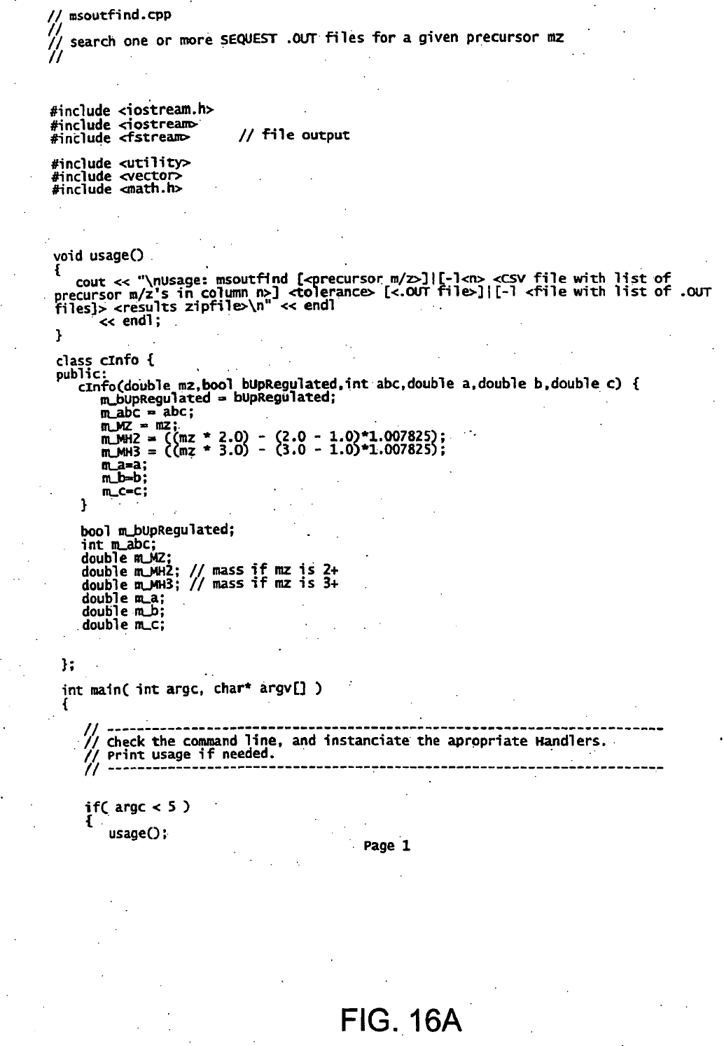

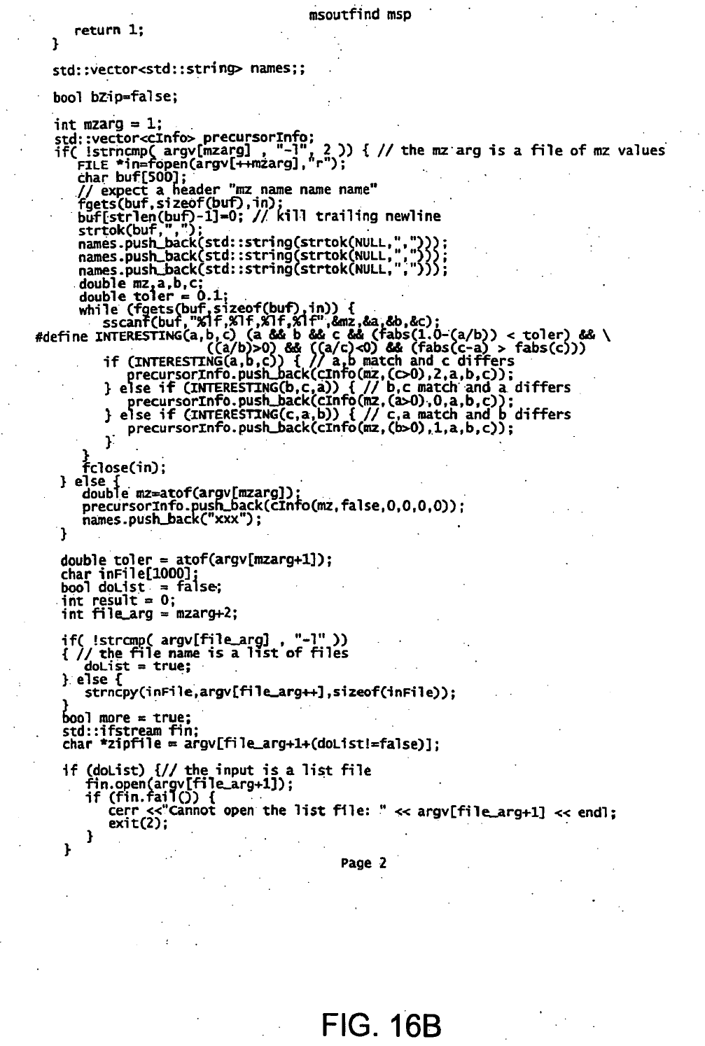

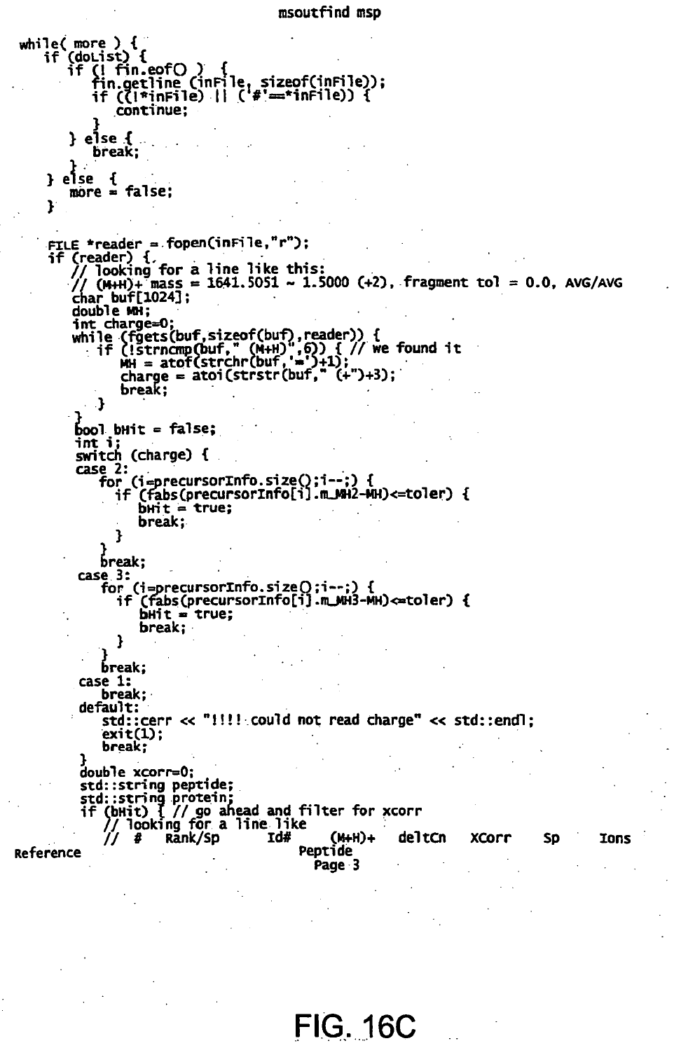

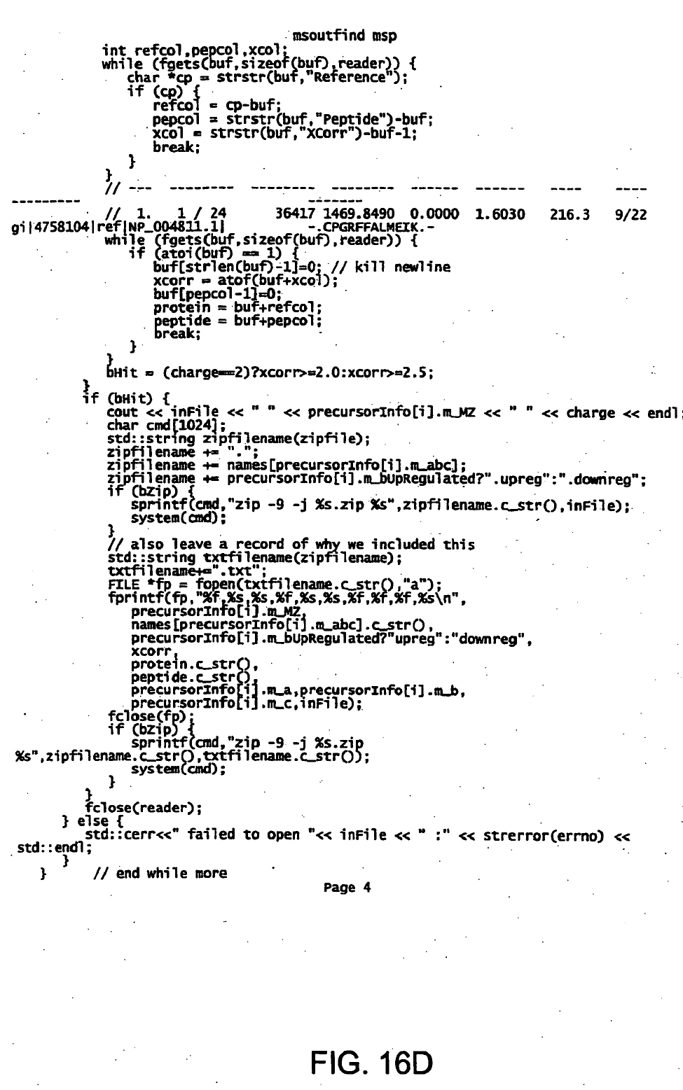

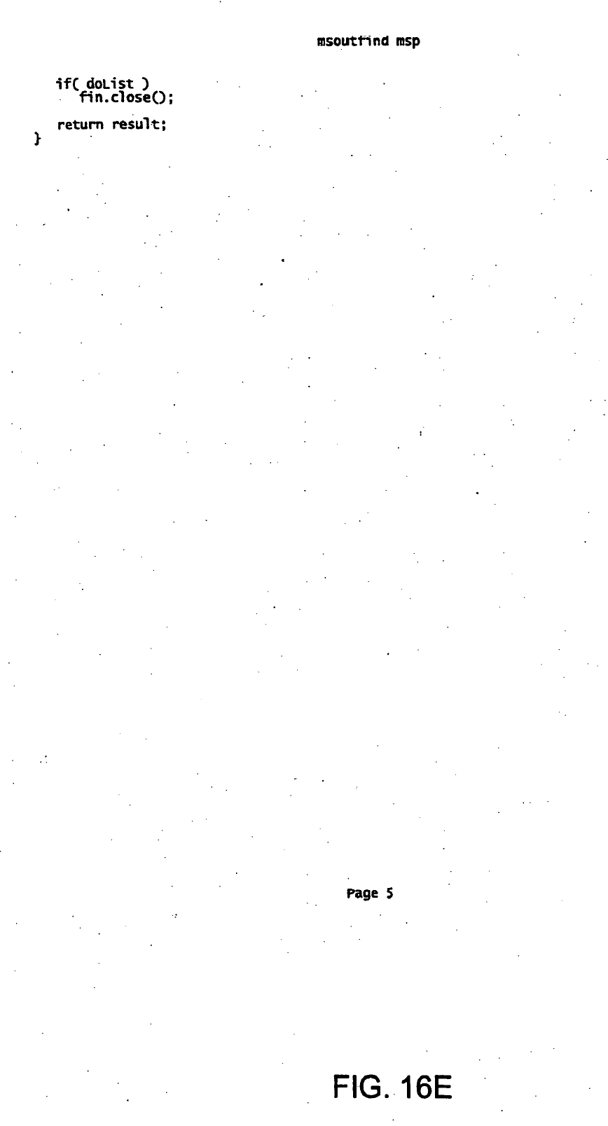

FIG. 16A-16E shows a listing of the program used to produce the protein information shown in FIG. 14A through FIG. 15J, according to some embodiments. Processing blood samples to extract High Density Lipoprotein (HDL) was described above in relation to the samples that were classified. In some embodiments, lipoproteins of other densities can be extracted and used in classification methodologies. In some embodiments, the techniques herein can be used to diagnosis diseases other than coronary artery disease. In some embodiments, the techniques herein can be used to determine the severity of diseases in humans, animals, or other biological systems. In some embodiments, the techniques here can be used to determine treatment response, and design therapies in humans, animals or other biological systems.

Embodiments of the present invention can be used to develop very fast diagnostic techniques. Diagnostic tests can be developed for model systems, clinical trials, or the routine clinical setting. Using the methods described above, in various embodiments, samples are sorted into classes and the critical data aspects necessary for determining a patient's state (healthy vs. diseased, therapeutic drug response vs. pathological response, etc.) can be identified. This information can then be used to determine a small set of information that is needed to determine the state. In some embodiments, a procedure for operating the mass spectrometer can then be determined for quickly gathering the required information. For example, only survey scans might be required, so the entire separation can be run very quickly. It might be that much of the separation is unneeded, so the separation can be optimized for only the required elution period. Or, tandem data may be required, but only on specific parent masses at specific times, so the separation can still be run very quickly. Ideally, the procedure for operating the mass spectrometer would be a script or program for automatically controlling the mass spectrometer to produce the desired data.

For example, a test is developed in a test development phase and is then used in a production phase. The production phase can be a diagnostic test for disease, but also can be for any other kind of biomedical testing or analysis. In the test development phase, the summation techniques are used with pattern recognition to determine differentiating peaks, such as is shown, for example, in FIG. 7. If tandem mass spectrometry is used, then the tandem mass spectra can be used to confirm the identity of peptides causing the differentiating peaks.

In the production phase, the model produced by pattern recognition and the list of differentiating peaks are used to develop a very fast diagnostic test, using mass spectrometry and pattern recognition. The faster test is produced by running the separation step faster, eliminating separations dimensions, or even eliminating chromatographic separation altogether. The resulting data set is smaller than that produced for the initial analysis and can, in many cases, be smaller yet by the summarization techniques described herein. If tandem mass spectrometry is not used, a less expensive mass spectrometer can be used for the diagnostic test.

For example, conventional MudPIT analysis can be performed on a set of samples. The survey scans are then analyzed with summarization, to identify the range of masses that contribute significantly to differences in classes. The data can also be examined to determine when in chromatographic time that specific mass values contribute to the ability to distinguish classes. From this information, a smaller range of mass and chromatographic time for each chromatography dimension can be calculated. The analysis can then be performed with only survey scans, and with unnecessary areas of the chromatography skipped over, for example by increasing the pump pressure on a liquid chromatographic column, so that the stream is emitted more quickly, and for a narrower mass range. These three optimizations combine to make the analysis run more quickly. Another example is to use the method of the preceding example, but to use the first experiment to guide the operation of a MALDI (Matrix Assisted Laser Desorption and Ionization) mass spectrometer for the diagnostic test. It is also possible to use MALDI in both the preliminary experiments and the diagnostic test.

In the description, for purposes of explanation, some specific details are set forth in order to provide understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver etc.), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “some embodiment” or “an embodiment” or similar phrases means that the feature(s) being described are included in at least one embodiment of the invention. References to “some embodiment” in this description do not necessarily refer to the same embodiment; however, neither are such embodiments mutually exclusive. Nor does “some embodiment” imply that there is but a single embodiment of the invention. For example, a feature, structure, act, etc. described in “some embodiment” may also be included in other embodiments. Thus, the invention may include a variety of combinations and/or integrations of the embodiments described herein.

Summary Survey Scan Mass Spectrum and Data Analysis

Preferably, pattern recognition is done on the summary survey scan mass spectrum. The summary scan mass spectrum is the average of the survey scan mass signals along both axes of the 2-dimensional separation. Thus, converting multidimensional separation MS data into a simpler format that is easily and quickly analyzed with well-understood pattern recognition techniques such as PCA and PLS-DA. To make measurements directly comparable the mass axis is typically reduced to 0.1 Da per data point over an m/z range of 400-1500 Da. Preferably, the summary survey scan mass spectrum does not contain tandem mass spectral information.

Preprocessing: Preferably, preprocessing includes baseline correction and normalization. Baseline correction can be done with a simple subtraction or addition of all points in the spectrum such that the minimum value in the signal is zero. Normalization can be done by multiplying each spectrum by a value so that the total summary survey scan spectrum signal is the same for each sample.

Not intending to be limited to one mechanism of action, the summary scan mass spectrum approach works because pattern recognition analysis requires precise data, but does not necessarily require completely selective signals. The signals of individual peptides can be overlapped, as long as the signal for a given peptide is the same from sample to sample. The survey scan mass spectral signals are the most precise, so they are preserved. The retention-time variation of SCX and reversed phase HPLC results in lower precision, so those signals are summarized. Although pattern recognition of the summary survey scan mass spectra does not take advantage of the selectivity in the SCX and reversed phase HPLC data, this method does use the separation of the sample to increase the dynamic range of the survey scan information and to improve the ionization characteristics of the mass spectrometer. MS/MS scan acquisition has low reproducibility of precursor ion selection, so typically MS/MS information is not included in the summary.

Pattern Recognition: PCA and PLS separate the m/z regions that distinguishes samples from the m/z regions that contain noise by focusing on m/z regions that have large signal changes and signal changes that are redundant in the spectra. Thus, these techniques are a good match for summary survey scan mass spectra analysis because summary survey scan signals of isotopes, peptides of a single protein and biologically related proteins have redundant changes from sample to sample.

The PCA and PLS-DA are well documented data analysis techniques. For example, see K. R. Beebe, R. J. Pell and M. B. Seasholtz Chemometrics: A practical Guide; Wiley-Interscience: New York, 1998. The unique part of this analysis is the use of summary survey scan mass spectra and the application of these pattern recognition techniques to MudPIT proteomic data. PLS-DA models are built with dummy response matrix containing discrete numerical values (zero or one) and one variable for each class. One for the class that the sample was a member of and zero for classes that the sample was not a member of. For the classification of a sample by PLS-DA a value for each class was derived. By comparing the values to threshold values it was determined if the sample was a member of anyone of the classes or not classifiable. Threshold values were calculated though cross validation. Samples were determined to be not classifiable if they did not exceed the threshold of any class or exceeded the threshold of multiple classes.

The techniques described herein employ the relevant protein for the disease being studied. The complexity of such an analysis is reduced by focusing on the most relevant subset of blood proteins.

For example, to discover specific proteins that might be important in the pathogenesis—and therefore the diagnosis—of cardiovascular disease, HDL is analyzed. Not intending to limit the mechanism of action, the hypothesis is that the protein content of HDL from patients with premature coronary artery disease (CAD) would differ from that of HDL from healthy subjects. Plasma levels of this HDL lipoprotein associate strongly and inversely with cardiovascular risk, and inherited low levels of HDL cholesterol are frequently found in patients with premature CAD. Moreover, many lines of evidence indicate that HDL directly protects against atherosclerosis by removing cholesterol from artery wall macrophages. Thus, any alteration in the protein content of HDL that affected its efficiency might promote atherosclerosis. Quantifying such changes, moreover, might provide a simple way to predict cardiovascular risk.

Cardiovascular Disease Markers

In the present invention, markers and preferably patterns of biological markers, specifically cardiovascular disease markers, are analyzed. Also, novel cardiovascular disease marker patterns that have been identified are described herein.

In some embodiments, cardiovascular disease markers are identified in a biological sample from an animal subject and these markers are used to make a decision regarding the cardiovascular disease state of the subject. Typically, the animal subject is a human patient. Preferably, the markers used in the analysis are characterized by one or more mass spectral signals. Typically, the mass spectral signals are mass spectrum peaks obtained using a mass spectrometry system and are characterized by m/z values, molecular weights, and/or charge states, and/or migration times.

The cardiovascular disease markers—of the invention are characterized by the mass spectral data provided in the following tables. Tables 1 and 2 list the biomarkers with their corresponding m/z values. One or more of the markers of Tables 1 and/or 2 are preferably utilized in the present invention. The markers utilized are those that produce the approximate m/z values in Tables 1 or 2, assuming the experimental conditions disclosed in the Examples section are utilized;—however, any suitable detection methods other than mass spectroscopy may be utilized to detect these makers—characterized by the m/z values set forth in the tables.

TABLE 1
LEVELS UP IN CARDIOVASCULAR PATIENTS

| | Magnitude in |
|---|---|
| | Regression |
| m/z | Vector |
| 1723.9895 | 36.7981 |
| 1716.9014 | 33.1787 |
| 1728.9617 | 29.7323 |
| 2989.3922 | 19.5376 |
| 3260.7210 | 18.1923 |
| 2408.2839 | 17.4651 |
| 2990.4685 | 16.7632 |
| 2967.4715 | 16.1939 |
| 3261.7646 | 15.2758 |
| 2247.2692 | 14.7722 |
| 1912.0176 | 13.9804 |
| 2407.2245 | 12.9387 |
| 1635.7839 | 11.8718 |
| 1750.9540 | 11.7050 |
| 3262.8085 | 11.3551 |
| 2646.3796 | 10.9542 |
| 1568.8816 | 10.9340 |
| 3033.5993 | 10.4919 |
| 2536.3179 | 10.2134 |
| 2966.4034 | 10.1871 |
| 2645.3213 | 9.9122 |
| 2969.4900 | 9.4320 |
| 2228.2933 | 9.1356 |
| 2668.2754 | 9.0637 |
| 2669.3429 | 8.7743 |
| 1848.9163 | 8.7698 |
| 1837.8563 | 8.0938 |
| 1433.6803 | 7.7516 |
| 2537.3326 | 7.5292 |
| 1838.8857 | 7.3153 |
| 1745.9186 | 6.6423 |
| 2535.3036 | 6.1656 |
| 1570.4512 | 6.1174 |
| 1907.8922 | 6.0871 |
| 1879.0369 | 5.9580 |
| 1286.2962 | 5.7091 |
| 2410.2112 | 5.5198 |
| 3035.5414 | 5.4473 |
| 1266.5887 | 5.4151 |
| 1746.9665 | 5.3618 |
| 1545.2153 | 5.1425 |
| 1270.5466 | 5.1044 |
| 1636.8311 | 5.0963 |
| 1630.8188 | 5.0357 |
| 1773.8645 | 4.9760 |
| 2279.1339 | 4.9590 |
| 2538.3477 | 4.8629 |
| 1752.9161 | 4.7396 |
| 817.5003 | 4.4699 |
| 2280.1369 | 4.3575 |
| 2992.3830 | 4.3490 |
| 1489.8032 | 4.3413 |
| 3283.7570 | 4.3298 |
| 1435.6888 | 4.3073 |
| 2249.3376 | 4.3003 |
| 3592.9960 | 4.2037 |
| 2670.4109 | 4.1410 |
| 3282.7064 | 4.1217 |
| 1850.9142 | 4.0274 |
| 2017.0538 | 3.9980 |
| 1712.5119 | 3.9868 |
| 1346.6312 | 3.9675 |
| 3492.8114 | 3.7580 |
| 1475.6878 | 3.7195 |
| 1178.6959 | 3.6320 |
| 1843.8942 | 3.6310 |
| 2018.1030 | 3.6221 |
| 1243.5966 | 3.6154 |
| 1274.6188 | 3.5974 |
| 3281.6562 | 3.5669 |
| 1880.0895 | 3.5456 |
| 1656.7898 | 3.5336 |
| 2281.2316 | 3.5293 |
| 1242.5524 | 3.4865 |
| 982.4875 | 3.3709 |
| 1719.9258 | 3.3462 |
| 1490.8166 | 3.3365 |
| 2207.2693 | 3.2870 |
| 1231.1736 | 3.1682 |
| 1738.8795 | 3.1612 |
| 1768.9048 | 3.1396 |
| 1476.6916 | 3.1253 |
| 1795.9251 | 3.0787 |
| 2690.3524 | 3.0645 |
| 3012.4386 | 3.0520 |
| 3723.2081 | 3.0254 |
| 1774.9292 | 3.0220 |
| 2731.4480 | 2.8595 |
| 1477.6961 | 2.8591 |
| 1221.6568 | 2.8380 |
| 1744.8714 | 2.7910 |
| 1732.9774 | 2.7908 |
| 1739.9231 | 2.7781 |
| 2411.2719 | 2.7116 |
| 2671.4792 | 2.7104 |
| 2514.2978 | 2.6658 |
| 1860.8615 | 2.6607 |
| 1591.8911 | 2.6319 |
| 1257.6531 | 2.6316 |
| 1349.5969 | 2.6161 |
| 3036.6343 | 2.6003 |
| 822.3871 | 2.5924 |
| 1200.6803 | 2.5565 |
| 1754.9507 | 2.5386 |
| 3721.1237 | 2.5307 |
| 1284.2912 | 2.5061 |
| 1690.5290 | 2.4940 |
| 1794.9197 | 2.4887 |
| 1546.2664 | 2.4662 |
| 1437.7002 | 2.4612 |
| 1871.8354 | 2.4565 |
| 2888.5388 | 2.4518 |
| 3010.3909 | 2.4352 |
| 2372.1452 | 2.4329 |
| 3276.6719 | 2.4223 |
| 2108.9645 | 2.4221 |
| 1909.8774 | 2.4204 |
| 1287.5831 | 2.4150 |
| 2889.5788 | 2.4147 |
| 2571.2524 | 2.3920 |
| 2269.3095 | 2.3910 |
| 900.4813 | 2.3496 |
| 2993.4604 | 2.2974 |
| 2429.1812 | 2.2770 |
| 1663.8294 | 2.2592 |
| 3596.0154 | 2.2252 |
| 2887.4991 | 2.2138 |
| 2516.3100 | 2.2033 |
| 1364.6333 | 2.1826 |
| 1844.9270 | 2.1299 |
| 1702.8807 | 2.1184 |
| 2229.3631 | 2.1064 |
| 1345.6081 | 2.0920 |
| 3278.6385 | 2.0903 |
| 2572.2811 | 2.0839 |
| 2513.2923 | 2.0776 |
| 968.5576 | 2.0762 |
| 1268.5661 | 2.0723 |
| 1590.8726 | 2.0697 |
| 915.4439 | 2.0644 |
| 1571.4566 | 2.0587 |
| 2436.2846 | 2.0537 |
| 909.4219 | 2.0503 |
| 2431.2225 | 2.0263 |
| 885.3736 | 2.0025 |

TABLE 2
LEVELS DOWN IN CARDIOVASCULAR PATIENTS

| | Magnitude in |
|---|---|
| | Regression |
| m/z | Vector |
| 1900.0480 | −22.9042 |
| 1708.9536 | −18.4467 |
| 2779.3902 | −13.5695 |
| 2056.1547 | −12.8436 |
| 2780.3909 | −12.2297 |
| 2420.2584 | −11.5954 |
| 927.5334 | −9.3536 |
| 2421.3235 | −9.3167 |
| 1641.8802 | −9.2032 |
| 2778.3898 | −8.9579 |
| 2179.0226 | −8.4921 |
| 1709.9793 | −8.2974 |
| 1670.8320 | −7.7388 |
| 2781.3920 | −7.2161 |
| 2583.3138 | −7.1328 |
| 1671.8348 | −6.7492 |
| 2586.2087 | −6.1136 |
| 2180.1559 | −5.8400 |
| 1914.0071 | −5.7899 |
| 2584.3473 | −5.6396 |
| 2587.2434 | −5.5780 |
| 1526.8450 | −5.4521 |
| 2663.3704 | −5.4354 |
| 1550.8501 | −5.2314 |
| 2662.3053 | −5.2059 |
| 2349.2941 | −5.1362 |
| 1525.8071 | −4.9190 |
| 1902.0250 | −4.8213 |
| 2177.9769 | −4.6892 |
| 2254.2013 | −4.6652 |
| 2675.4359 | −4.4827 |
| 2348.2607 | −4.2936 |
| 1884.0040 | −4.2286 |
| 1311.7558 | −3.7434 |
| 2046.1453 | −3.5817 |
| 928.5356 | −3.5739 |
| 2058.1295 | −3.4643 |
| 2782.3935 | −3.4210 |
| 2622.2499 | −3.2096 |
| 2674.3659 | −3.0780 |
| 1915.9987 | −3.0324 |
| 1451.4521 | −2.8842 |
| 2600.4197 | −2.8367 |
| 1019.6012 | −2.7973 |
| 2091.0728 | −2.7144 |
| 2677.3628 | −2.6842 |
| 1672.8382 | −2.5303 |
| 2601.4601 | −2.4844 |
| 1882.9493 | −2.4261 |
| 1083.6017 | −2.4257 |
| 2182.1625 | −2.3857 |
| 1595.9077 | −2.2000 |
| 2045.0816 | −2.2000 |
| 1554.6387 | −2.1397 |
| 1885.9644 | −2.0674 |
| 2090.0693 | −2.0250 |

The m/z values are as indicated or the closest nominal mass.

The m/z values provided in the above Tables 2 and 3 are peaks that are obtained for the markers using mass spectrometry system under the conditions disclosed in the Examples section. Tables 1 and 2 indicate whether the levels of the markers were up or down in cardiovascular disease states. It is intended herein that the methods of the invention are not limited to the up or down levels indicated in the Tables. The invention encompasses the determination of the differential presence of one or more biomarkers of Tables 1 and/or 2 for the diagnosis of cardiovascular diseases. The differences in the levels of biomarkers are typically obtained by comparison to samples from normal subjects. The presence, absence, and/or levels of the biomarkers can be used in the diagnosis of cardiovascular disease.

A marker may be represented at multiple m/z points in a spectrum. This can be due to the fact that multiple isotopes of the marker are observed and/or that multiple charge states of the marker are observed, or that multiple isoforms of the marker are observed. An example of different isoforms of the same marker is a protein that exists with and without a post-translational modification such as glycoslyation. These multiple representation of a marker can be analyzed individually or grouped together. An example of how multiple representations of a marker may be grouped is that the intensities for the multiple peaks can be summed.

It is intended herein that the methods include identification of the markers of Tables 1 and/or 2 and also any suitable different forms of the markers. For example, proteins are known to exist in a sample in a plurality of different forms characterized by different mass. These forms can result from either, or both, of pre- and post-translational modification. Pre-translational modified forms include allelic variants, slice variants and RNA editing forms. Post translationally modified forms include forms resulting from proteolytic cleavage (e.g., fragments of a parent protein), glycosylation, phosphorylation, lipidation, oxidation, methylation, cystinylation, sulphonation and acetylation. Thus, the invention includes the use of modified forms of the markers of Tables 1 and/or 2 to diagnose cardiovascular diseases.

The markers that are characterized by the mass spectral data provided in Tables 1 and 2 above can be identified using different techniques that are known in the art. These techniques are not limited to mass spectrometry systems and include immunoassays, protein chips, multiplexed immunoassays, and complex detection with aptamers and chromatography utilizing spectrophotometric detection.

The markers of Tables 1 and 2 can be further characterized using techniques known in the art. For example, polypeptide markers can be further characterized by sequencing them using enzymes or mass spectrometry techniques. For example, see, Stark, in: Methods in Enzymology, 25:103-120 (1972); Niall, in: Methods in Enzymology, 27:942-1011 (1973); Gray, in: Methods in Enzymology, 25:121-137 (1972); Schroeder, in: Methods in Enzymology, 25:138-143 (1972); Creighton, Proteins: Structures and Molecular Principles (W. H. Freeman, NY, 1984); Niederwieser, in: Methods in Enzymology, 25:60-99 (1972); and Thiede, et al. FEBS Lett., 357:65-69 (1995), Shevchenko, A., et al., Proc. Natl. Acad. Sci. (USA), 93:14440-14445 (1996); Wilm, et al., Nature, 379:466-469 (1996); Mark, J., “Protein structure and identification with MS/MS,” paper presented at the PE/Sciex Seminar Series, Protein Characterization and Proteomics: Automated high throughput technologies for drug discovery, Foster City, Calif. (March, 1998); and Bieman, Methods in Enzymology, 193:455-479 (1990).

Typically, when patterns of cardiovascular disease markers are used to determine the cardiovascular disease state, the pattern from a patient, also referred to as test pattern, is compared mathematically to a set of reference patterns. The reference patterns can be derived from the same patient, different patient, or group of patients. In some embodiments, the reference patterns are obtained from normal subjects, i.e. subjects who do not have cardiovascular disease, as well as from subjects having cardiovascular disease.

The patterns from a subject suspected of having cardiovascular disease, in some embodiments, can be compared to reference patterns, which are typically obtained from one or more normal subjects. Also, patterns from the same patient can be compared to each other. Typically, these patterns are obtained at different time points and are used to evaluate the status of cardiovascular disease in the patient.

In some embodiments, subsets of cardiovascular disease markers identified herein are used in the classification of cardiovascular disease states. These subsets can comprise one or more markers described herein. Preferably the subset comprises one marker, preferably about 2 to about 10 markers, more preferable about 10 to about 50 markers, and even more preferably about 50 to about 150 markers.

In other embodiments, the markers described herein are used in combination with known cardiovascular disease markers. In yet other embodiments, the methods described herein are used in combination with known diagnostic techniques for cardiovascular diseases.

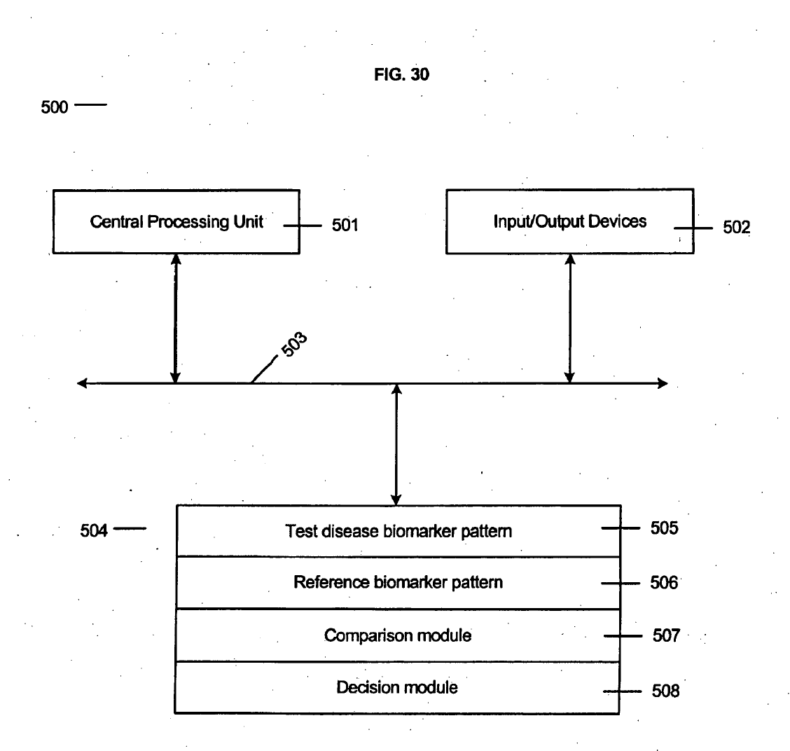

In some embodiments, the methods of the present invention are performed using a computer as depicted in FIG. 30. FIG. 30 illustrates a computer for implementing selected operations associated with the methods of the present invention. The computer 500 includes a central processing unit 501 connected to a set of input/output devices 502 via a system bus 503. The input/output devices 502 may include a keyboard, mouse, scanner, data port, video monitor, liquid crystal display, printer, and the like. A memory 504 in the form of primary and/or secondary memory is also connected to the system bus 503. These components of FIG. 30 characterize a standard computer. This standard computer is programmed in accordance with the invention. In particular, the computer 500 can be programmed to perform various operations of the methods of the present invention, for example, the processing operations of FIGS. 1 to 5.

In some embodiments, the memory 504 of the computer 500 stores test 505 and reference 506 biomarker patterns. The memory 504 also stores a comparison module 507. The comparison module 507 includes a set of executable instructions that operate in connection with the central processing unit 501 to compare the various biomarker patterns. The executable code of the comparison module 507 may utilize any number of numerical techniques to perform the comparisons.

The memory 504 also stores a decision module 508. The decision module 508 includes a set of executable instructions to process data created by the comparison module 507. The executable code of the decision module 508 may be incorporated into the executable code of the comparison module 507, but these modules are shown as being separate for the purpose of illustration. In preferred embodiments, the decision module 508 includes executable instructions to provide a decision regarding a disease state of a patient.

Therapeutic and Diagnostic Uses of Lipoprotein Complexes as Marker

The complement of proteins, protein fragments, peptides, or other analytes present at any specific moment in time defines who and what an individual organism is at that moment, as well as the state of health or disease: the biological state. The biological state of a patient reflects not only the presence and nature of the disease, but the more general state of health and response of the affected individual to the disease.

The identification and analysis of markers herein, especially HDL markers, have numerous therapeutic and diagnostic purposes. Clinical applications include, for example, detection of disease; distinguishing disease states to inform prognosis, selection of therapy, and/or prediction of therapeutic response; disease staging; identification of disease processes; prediction of efficacy of therapy; monitoring of patients trajectories (e.g., prior to onset of disease); prediction of adverse response; monitoring of therapy associated efficacy and toxicity; prediction of probability of occurrence; recommendation for prophylactic measures; and detection of recurrence. Also, these markers can be used in assays to identify novel therapeutics. In addition, the markers can be used as targets for drugs, and therapeutics, for example antibodies against the markers or fragments of the markers can be used as therapeutics.

The methods described herein can be used to identify the state of disease in a patient, for example, CVD or AD or cancer. For example, the methods can be used to categorize the cancer based on the probability that the cancer will metastasize. Also, these methods can be used to predict the possibility of the cancer going into remission in a particular patient. In certain embodiments, patients, health care providers, such as doctors and nurses, or health care managers, use the patterns of markers to make a diagnosis, prognosis, and/or select treatment options.

In other embodiments, the methods described herein can be used to predict the likelihood of response for any individual to a particular treatment, select a treatment, or to preempt the possible adverse effects of treatments on a particular individual (e.g. monitoring toxicology due to chemotherapy). Also, the methods can be used to evaluate the efficacy of treatments over time. For example, biological samples can be obtained from a patient over a period of time as the patient is undergoing treatment. The patterns from the different samples can be compared to each other to determine the efficacy of the treatment. Also, the methods described herein can be used to compare the efficacies of different therapies and/or responses to one or more treatments in different populations (e.g., different age groups, ethnicities, family histories, etc.). In a preferred embodiment, a mass spectrometry system is used to analyze one or more markers of to evaluate the disease state of a patient.

In addition to being used for clinical purposes, the markers and patterns of markers have many other applications. The markers identified herein may be entire proteins or fragments of proteins or other analytes. It is intended herein that a particular marker not only encompass the protein fragment, but also the entire parent protein.

The markers and their patterns described herein can be used in the prognosis and treatment of cardiovascular diseases and also in assays to identify and develop novel therapies for cardiovascular diseases. In some embodiments, the biomarkers are used in assays to develop cardiovascular disease treatments. These treatments include, but are not limited to, antibodies, nucleic acid molcules (e.g., DNA, RNA, RNA antisense), peptides, peptidomimetics, and small molecules.

The markers found in the invention can be used to enable or assist in the pharmaceutical drug development process for therapeutic agents for use in cardiovascular diseases. The markers can be used to diagnose disease for patients enrolling in a clinical trial. The markers can indicate the cardiovascular disease state of patients undergoing treatment in clinical trials, and show changes in the cardiovascular disease state during the treatment. The markers can demonstrate the efficacy of a treatment, and be used as surrogate endpoints for clinical trial outcome. The markers can be used to stratify patients according to their responses to various therapies.

One embodiment includes antibodies that bind to, and thereby affect the function of, these biomarkers. In other embodiments, cellular expression of the target marker can be modulated, for example, by affecting transcription and/or translation. Suitable agents include anti-sense constructs prepared using antisense technology or gene transcription constructs, such as using RNA interference technology. Also, DNA oligonucleotides can be designed to be complementary to a region of the gene involved in transcription thereby preventing transcription and the production of one or more of the biomarkers. Therapeutic and/or prophylactic polynucleotide molecules can be delivered using gene transfer and gene therapy technologies.

Still other agents include small molecules that bind to or interact with the biomarkers and thereby affect the function thereof, such as an agonist, partial agonist, or antagonist, and small molecules that bind to or interact with nucleic acid sequences encoding the biomarkers, and thereby affect the expression of these protein biomarkers. These agents may be administered alone or in combination with other types of treatments known and available to those skilled in the art for treating cardiovascular diseases.

One aspect of the invention is therapeutic agents for use in cardiovascular disease patients. The therapeutic agents can be used either therapeutically, prophylactically, or both. Preferably, the therapeutic agents have a beneficial effect on the cardiovascular disease state of a patient. Even more preferably, the markers in Tables 1 and/or 2 are used as targets for therapeutic agents. For markers that are polypeptides, the therapeutic agents may target the polypeptide or the DNA and/or RNA encoding the polypeptide. The therapeutic agent either directly acts on the markers or modulates other cellular constituents which then have an effect on the markers. In some embodiments, the therapeutic agents either activate or inhibit the activity of the markers. In other embodiments, a marker listed in Table 1 or 2 or an antibody to a marker listed in Table 1 or 2 is used as the therapeutic or prophylactic agent. In these embodiments, the markers or antibodies used as the active agent may be modified to improve certain physical properties in order to improve their therapeutic or prophylactic activities. For example, the marker maybe chemically modified to improve bioavailability or its pharmacokinetic properties.

The cardiovascular disease therapeutic agents of the present invention can be co-administered with other active pharmaceutical agents that are used for the therapeutic and/or prophylactic treatment of cardiovascular diseases. This co-administration can include simultaneous administration of the two agents in the same dosage form, simultaneous administration in separate dosage forms, and separate administration. The two agents can be formulated together in the same dosage form and administered simultaneously. Alternatively, they can be simultaneously administered or separately administered, wherein both the agents are present in separate formulations. In the separate administration protocol, the two agents may be administered a few minutes apart, or a few hours apart, or a few days apart.

The term “treating” as used herein includes having a beneficial effect, i.e., achieving a therapeutic benefit and/or a prophylactic benefit. By therapeutic benefit is meant eradication, amelioration, or prevention of the underlying disorder being treated. For example, in a cancer patient, therapeutic benefit includes eradication or amelioration of the underlying cancer. Also, a therapeutic benefit is achieved with the eradication, amelioration, or prevention of one or more of the physiological symptoms associated with the underlying disorder such that an improvement is observed in the patient, notwithstanding that the patient may still be afflicted with the underlying disorder. For prophylactic benefit, the therapeutic agents may be administered to a patient at risk of developing a cardiovascular disease or to a patient reporting one or more of the physiological symptoms of a cardiovascular disease, even though a diagnosis of a cardiovascular disease may not have been made.

The therapeutic agents of the present invention are administered in an effective amount, i.e., in an amount effective to achieve therapeutic or prophylactic benefit. The actual amount effective for a particular application will depend on the patient (e.g., age, weight, etc.), the condition being treated, and the route of administration. Determination of an effective amount is well within the capabilities of those skilled in the art. The effective amount for use in humans can be determined from animal models. For example, a dose for humans can be formulated to achieve circulating and/or gastrointestinal concentrations that have been found to be effective in animals.

Preferably, the agents used for therapeutic and/or prophylactic benefit can be administered per se or in the form of a pharmaceutical composition. The pharmaceutical compositions comprise the therapeutic agents, one or more pharmaceutically acceptable carriers, diluents or excipients, and optionally additional therapeutic agents. The compositions can be formulated for sustained or delayed release. The compositions can be administered by injection, topically, orally, transdermally, rectally, or via inhalation. Preferably, the therapeutic agent or the pharmaceutical composition comprising the therapeutic agent is administered orally. The oral form in which the therapeutic agent is administered can include powder, tablet, capsule, solution, or emulsion. The effective amount can be administered in a single dose or in a series of doses separated by appropriate time intervals, such as hours.

Pharmaceutical compositions for use in accordance with the present invention may be formulated in conventional manner using one or more physiologically acceptable carriers comprising excipients and auxiliaries which facilitate processing of the active compounds into preparations which can be used pharmaceutically. Proper formulation is dependent upon the route of administration chosen. Suitable techniques for preparing pharmaceutical compositions of the therapeutic agents of the present invention are well known in the art.

In yet another aspect, the invention provides kits for diagnosis of cardiovascular and brain diseases, wherein the kits can be used to detect the markers of the present invention. For example, the kits can be used to detect any one or more of the markers described herein, which markers are differentially present in samples of a cardiovascular disease patient and normal subjects.

In one embodiment, a kit comprises a substrate comprising an adsorbent thereon, wherein the adsorbent is suitable for binding a marker, and instructions to detect the marker or markers by contacting a sample with the adsorbent and detecting the marker or markers retained by the adsorbent. In another embodiment, a kit comprises (a) an antibody that specifically binds to a marker; and (b) a detection reagent. In some embodiments, the kit may further comprise instructions for suitable operation parameters in the form of a label or a separate insert. Optionally, the kit may further comprise a standard or control information so that the test sample can be compared with the control information standard to determine if the test amount of a marker detected in a sample is a diagnostic amount consistent with a diagnosis of a cardiovascular disease.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### EXAMPLES

### Example 1

Proteomics Analysis of HDL Proteins

Isolation of HDL. Blood anticoagulated with EDTA was collected from healthy adults and patients with clinically and angiographically documented CAD who had fasted overnight. HDL (d=1.063-1.210 g/ml) and HDL₃ (d=1.110-1.210 g/ml) were prepared from plasma by sequential ultracentrifugation. The Human Studies Committees at University of Washington School of Medicine and Wake Forest University School of Medicine approved all protocols involving human material.

Analysis of the HDL proteome. HDL proteins were reduced, alkylated, and digested with trypsin. Desalted peptide digests were subjected to MudPIT with a Finnigan DECA ProteomeX LCQ ion-trap instrument. The MudPIT system used a quaternary HPLC pump interfaced with the mass spectrometer, which in turn was interfaced with a strong cation exchange resin and a reverse-phase column. A fully automated 10-cycle chromatographic run was carried out on each sample. The SEQUEST program was used to interpret MS/MS spectra. Matches were validated by inspection when a protein was identified by three or fewer unique peptides possessing highly significant SEQUEST scores.

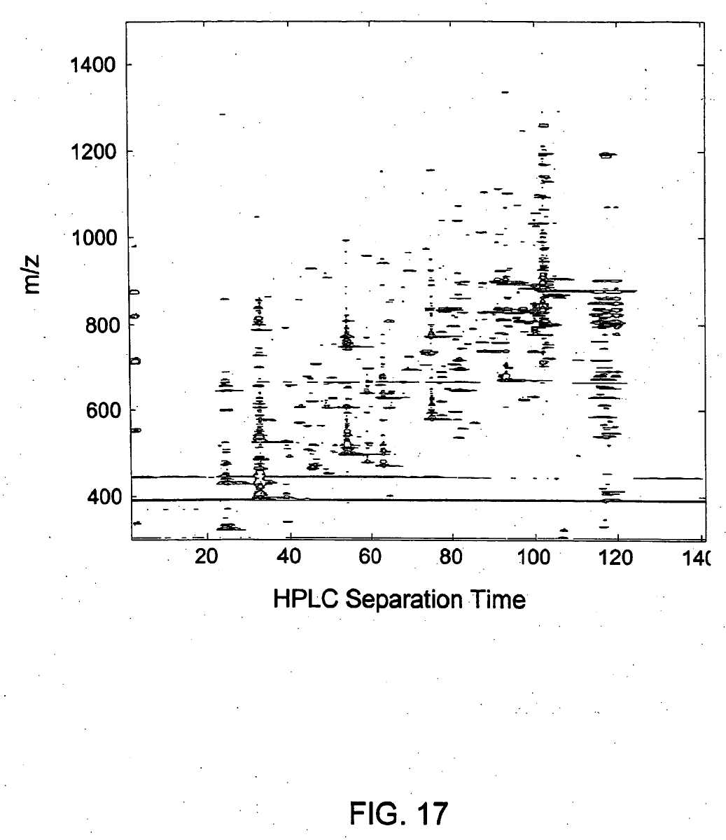

FIG. 17 shows the survey scan data from a single strong cation exchange (SCX) fraction of the preliminary ESI experiments. The samples analyzed in this study were separated by SCX into 10 fractions. A reverse-phase HPLC separation, such as that shown in FIG. 17, was performed for each SCX fraction.

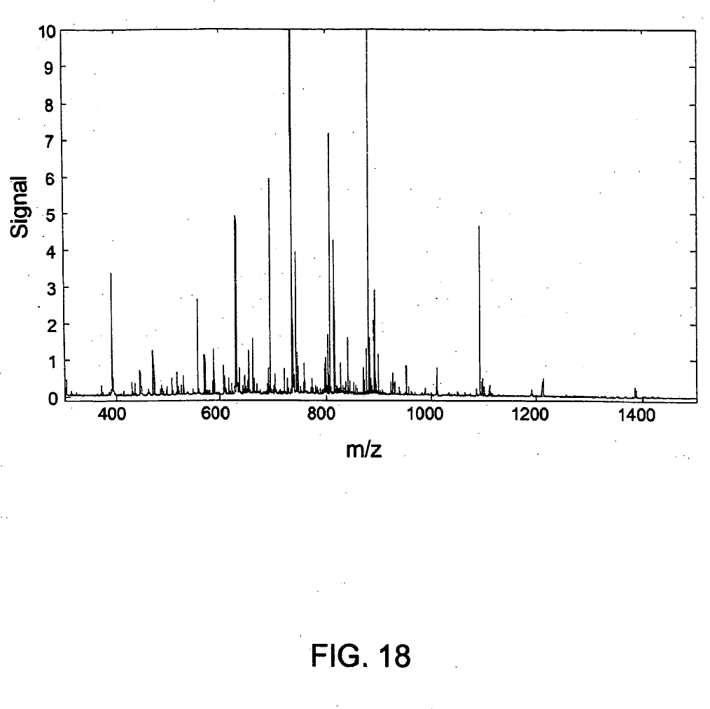

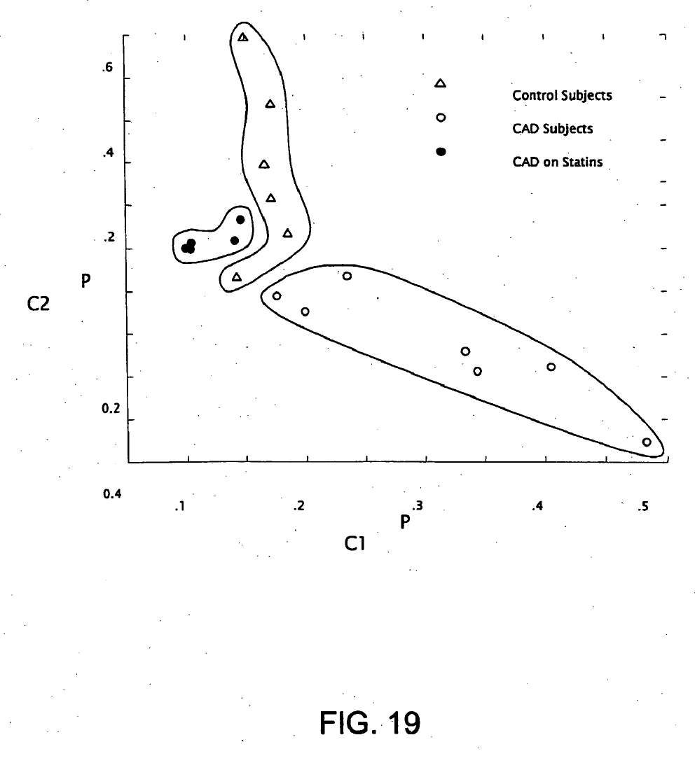

PATTERN-RECOGNITION APPLIED TO BIOSAMPLES: Data is first integrated into a summary survey scan mass spectrum (FIG. 18), as described above. The summary scan mass spectrum is the average of the survey scan mass signals along both axes of the 2-dimensional separation. These spectra were created by combining the HPLC chromatographic profiles of SCX scans 2-10. After condensing the data in this way, PCA was applied. The PCA analysis (FIG. 19) completely distinguished between the protein components of HDL isolated from healthy subjects and those of HDL isolated from patients with established CAD. Moreover, HDL from hyperlipidemic patients with CAD who were being treated with statins from HDL from the same patients prior to treatment were distinguishable. In fact, the post-treatment data clustered more readily with the control data than with the pre-treatment data.

PLS-DA was also used to analyze these data. When only CAD subjects and control subjects were included, PLS-DA correctly classified 12 of 13 samples. When samples from CAD subjects, control subjects, and CAD subjects treated with statins were analyzed, 18 of the 20 samples were correctly classified.

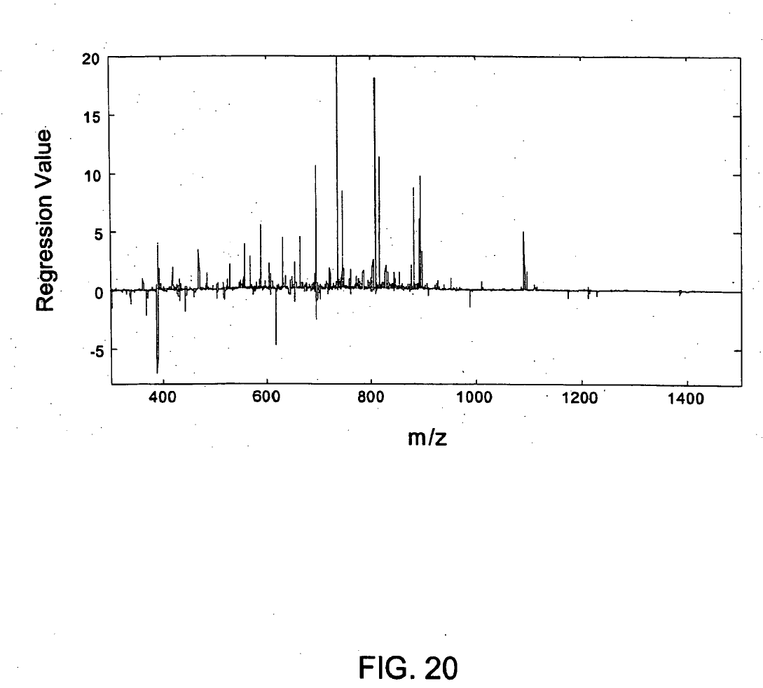

A regression vector from the PLS analysis is shown in FIG. 20. A regression vector is made for each class of samples being classified. The peaks in this vector indicate the m/z values that were most important in classifying the samples. Positive peaks are m/z that increased in samples for that class. Negative peaks are mass channels that decreased in samples for that class. In the preliminary data, there was a large positive peak at 735.3 m/z on the regression vector for control samples (see FIG. 20) suggesting a peptide with 735.3 m/z is higher in concentration in the control samples than the CAD or statin/CAD samples. Using this information, the proteins that distinguish the three classes can be identified.

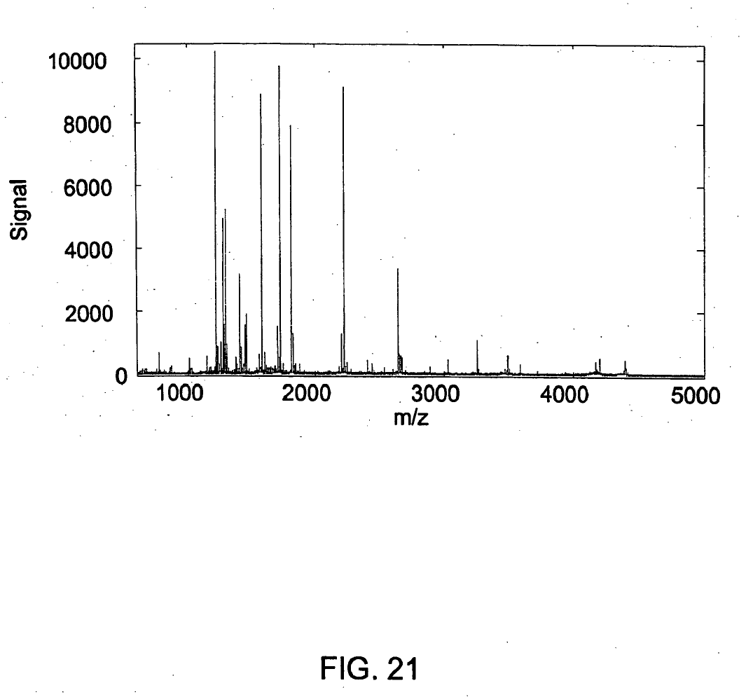

MALDI ANALYSIS OF HDL Preliminary pattern recognition of HDL samples was done using LC-ESI-MS. Similar pattern recognition method was applied to the data from MALDI TOF-TOF-MS from an Applied Biosystems 4700 MALDI-TOF-TOF Proteomics Analyzer capable of MS and MS/MS analysis. This system is interfaced with an off-line capillary LC coupled with a 2-D MALDI plate spotter. Preliminary data showing the measurement of an HDL sample with this instrument is shown in FIG. 21.

### Example 2

Predict MI Cases Via PEPI ESI-MS Analysis of HDL Protein Composition

HDL from 30 MI subjects and 30 control subjects of the Fletcher Challenge study will be analyzed via ESI-MS. We plan to initially study HDL isolated from 2 classes: (i) subjects who suffered from myocardial infarction within the first 3 years of the study; (ii) subjects who remained free of clinically significant cardiovascular disease for the 7 year duration of the study. Subjects within the two classes will be matched for age, gender, and BMI. ESI-MS data will be analyzed using the pattern recognition methods described above and subjects who suffered an MI during the Fletcher Challenge study will be predicted.

THE FLETCHER CHALLENGE STUDY In 1992-93, the Fletcher Challenge-University of Auckland Heart and Health Study recruited 10,525 participants in New Zealand. These subjects included employees of the Fletcher Challenge Group and residents of Auckland. They completed a medical history questionnaire and had a physical exam, including height, weight, and blood pressure. They also gave blood samples, which were frozen and stored.

Beginning in 2003, 283 study participants who had suffered an MI since the study began were identified through medical records (114 had died from sudden death). Each of these MI cases was matched (by age, sex, and whether or not they were Fletcher Challenge employees) to two controls (with no MI) in a nested case/control study with 879 members. Events have now been verified through at least 1999, giving an average of at least 7 years of follow-up. Blood samples from more than 600 cases and controls will be used in this study. HDL was isolated from these blood samples via ultracentrifugation.

PREPARE SAMPLES The plasma samples are already in hand because they were collected in as part of the Fletcher Heart Study and have been stored at −80° C. All subjects filled out a complete medical history questionnaire that included detailed information on cigarette/tobacco use, family history of cardiovascular disease, history of diabetes, renal disease or liver disease, and medication use. All subjects had baseline measurements of blood pressure, height, weight, waist circumference, and waist-hip ratio; fasting plasma levels of glucose, insulin, total cholesterol, LDL and HDL cholesterol, triglycerides, and apolipoprotein B100. C-reactive protein levels are currently being measured on all the subjects. HDL samples will be prepared according to the protocol in Example 1.

ANALYZE SAMPLES VIA PEPI ESI-MS The samples will first be interrogated using LC and ESI-MS. MS/MS spectra will not be initially collected, to reduce run times as would be required in a high-throughput environment such as diagnosis. Preliminary data indicate that our data analysis methods require less chromatographic separation of peptides than MudPIT-type methods. Also, the survey mass spectrum contains many low abundance mass peaks that are generally ignored in MS/MS peptide search. These peaks may contain considerable biologically relevant information. Mass peaks of interest will be identified from the pattern recognition model. Subsequent MS/MS analysis will identify peptides with precursor masses that are indicated by pattern recognition. Thus, we can decouple the identification of interesting mass peaks from the much more time-consuming MS/MS analysis. With MudPIT, the selection of mass peaks for MS/MS analysis is driven by abundance and noise sources within the experiment. With PEPI, biology will drive the analysis.

PRINCIPAL COMPONENT ANALYSIS Spectra will be summarized via the method described above. PCA will be applied to the summary survey scan mass spectra to identify the two classes of samples (samples from subjects that suffered an MI during the Fletcher Challenge study and samples from subjects that did not suffer an MI during the study). During PCA, we will remain blinded to the case/control status of samples. PCA analysis will be considered successful if a group of MI samples and a group of control samples can be distinguished. Biological variations not studied in this experiment may lead to sub-grouping of the samples in each of the classes. Sub-groups may lead to additional insights and suggest more experiments.

PARTIAL LEAST SQUARES PLS will be applied to the 60 summed spectra, using a leave-one-out approach: one sample is reserved for analysis while the remaining samples are used to build the pattern recognition model. We will thus build 60 PLS models, one to predict the class of each sample. This method will be used to conserve samples. In an application such as disease diagnosis, all calibration samples would be collected before classification of patient samples.

### Example 3

Analysis of HDL Protein Composition

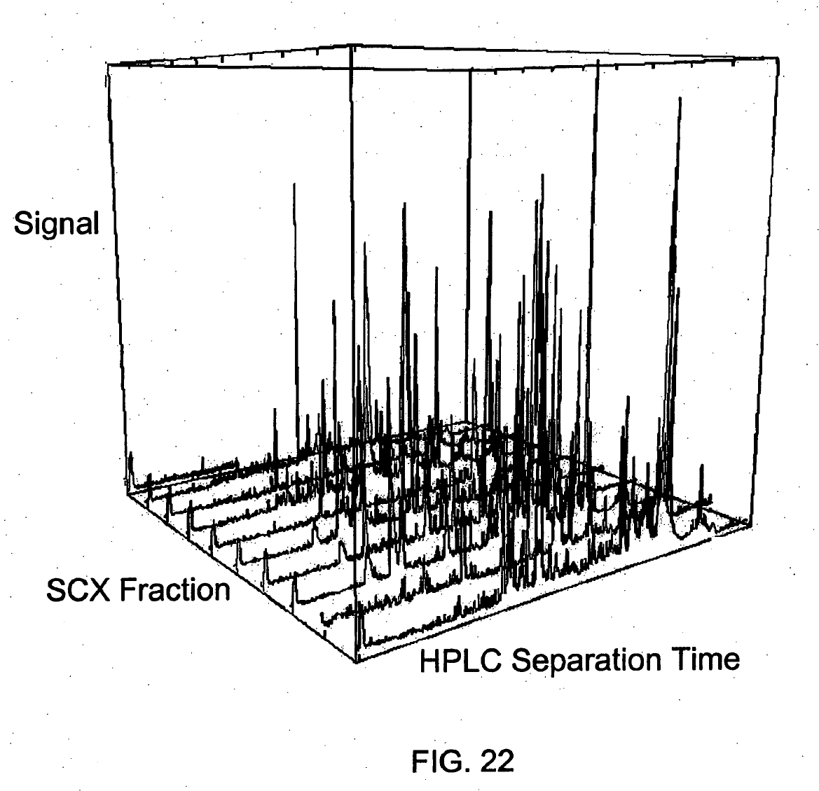

In one embodiment, two forms of separation (SCX and HPLC) were followed by two levels of mass spectrometry: electrospray ionization mass spectrometry (ESI-MS) or survey scan mass spectrometry and collision-induced dissociation mass spectrometry (CID-MS) or tandem mass spectrometry). The large, complex and selective data sets resulting from this analysis contain many opportunities for data mining. FIGS. 22, 17 and 18 are included to illustrate the size and selectivity of these data sets. FIG. 22 shows a total ion current survey scan chromatogram for one sample. In this figure we see the selective information resulting from only the two separation dimensions is evident. FIG. 22 is a 3D trace showing the total ion current survey scan chromatogram for a typical sample.

Moving down through the data dimensions FIG. 17 shows the HPLC separation and survey scan mass spectrometric data from a single SCX fraction. Each sample was separated into 10 SCX fractions. A reversed-phase HPLC separation like the one shown in FIG. 17 was done for each of the ten SCX fractions. As FIG. 22 shows peptides are distributed through the SCX fractions. FIG. 17 shows that there is a great deal of selectivity on the HPLC and survey scan mass spectra axes. Typical data analysis for data of this type utilizes only the selectivity of the tandem mass spectra. The streaks that can be seen on FIG. 17 at mass 391 and 445 are impurities that are found in most of the spectra. These mass channels were removed before pattern recognition analysis, although identifying these channels was not necessary because analysis was equally successful when these mass channels were left in the sample. FIG. 22 and FIG. 17 shows that the signal is very complex despite the fact that only proteins bound to HDL are measured.

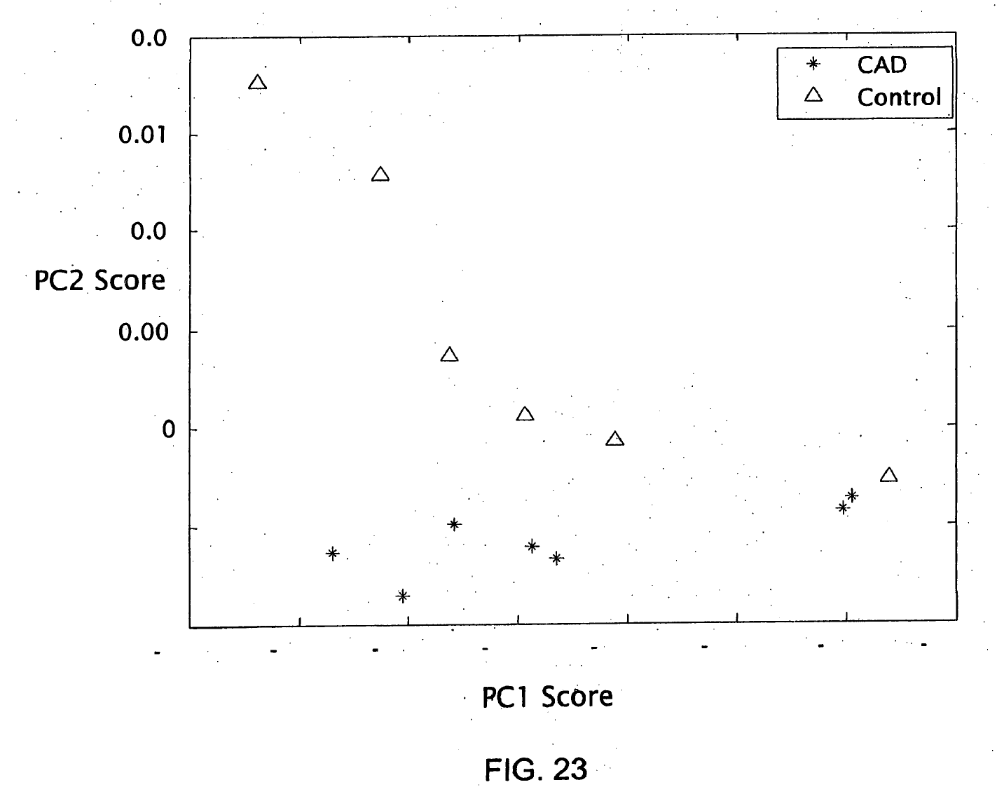

The first step in this data analysis method was to condense the data to the summary survey scan mass spectrum. As the name implies, the summary survey scan mass spectrum is a single MS that describes a sample. A summary survey scan mass spectrum of a CAD sample from this study is shown in FIG. 23. FIG. 23 depicts 2D scores plot showing PCA result from the analysis of CAD samples and control samples. Each sample is represented by a single data point on a plot of this type. PCA determines whether the data cluster or self-organize into meaningful groups. The data sets are plotted according to the first two scores in the PCA model. Remarkably, PC2 completely separates the subjects with CVD from the healthy age- and sex-matched control classes. These classes are circled on the plots. This plot indicates that a strong difference between the classes is present in the data. FIG. 4 also gives an impression of the large amount of information present in only the survey scan portion of this data. Summary survey scan mass spectra were created by combining the signals of SCX scans 2-10 and the HPLC chromatographic profiles like those shown in FIGS. 17 and 22. The first SCX fraction was not used because it contained only the flushing of the system in this particular instrument configuration.

Once the data has been condensed and preprocessed, PCA was applied to the data. The results of a PCA analysis of CAD and control samples are shown in FIG. 10. The 13 data sets are plotted according to the scores on the first 2 principal components. CAD samples are separated from healthy control samples by the 2^{nd} principal component score. Although this class separation is not sufficiently dramatic to visually identify classes without knowledge of the samples, this plot indicates that protein bound to HDL isolated from healthy control subjects and subjects with established CAD might be discernible.

FIG. 23 demonstrates that pattern recognition analysis described can be used as a fast and simple exploratory biology technique for multidimensional-separation MS/MS proteomic data. For instance, both classes cover a large region of the PC1 score in FIG. 23 and samples within cover a range on the PC2 score. This could be an indication of an undefined biological characteristic or a slight inconsistency in sample preparation.

Supervised pattern recognition was done on these same samples using PLS-DA. This analysis used a leave-one-out cross validation in order to apply this data analysis method despite the small number of samples. With PLS-DA 12 of the 13 samples were correctly classified as either CAD or control samples (92% accuracy). The single miss classified sample was a control sample that was classified as a CAD sample. This analysis was done using 5 latent variables in the PLS-DA models for both control and CAD prediction.

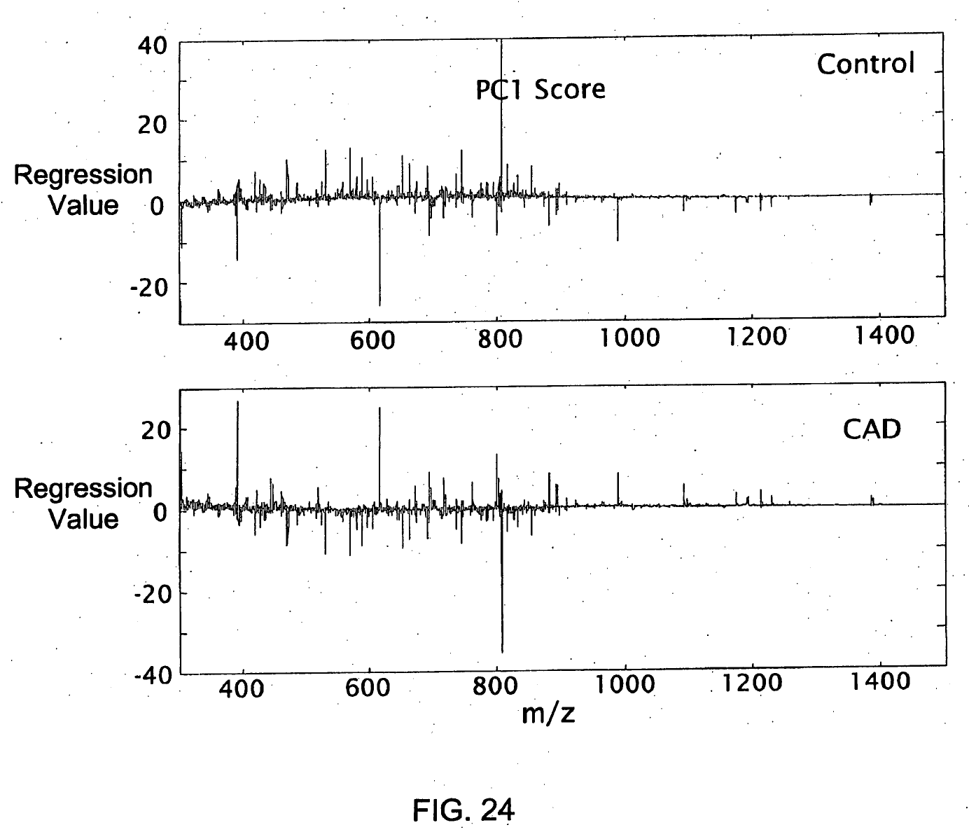

FIG. 24 shows the regression vectors for the CAD/CON classification. Large positive regression vector signals are at masses that are indicators for a given class. Negative large negative signals are at masses that are not indicators of a given class. If the summary survey scan spectrum of an unknown sample multiplied by a regression vector of a class exceeds the decision value the sample is considered a member of the given class. Regression vectors can be used to identify proteins that are indicators of a given class. Masses found in the regression vector can be related to peptide molecular masses which can them be used to identify proteins. In the two-class model the regression vectors are nearly mirror images of each other.

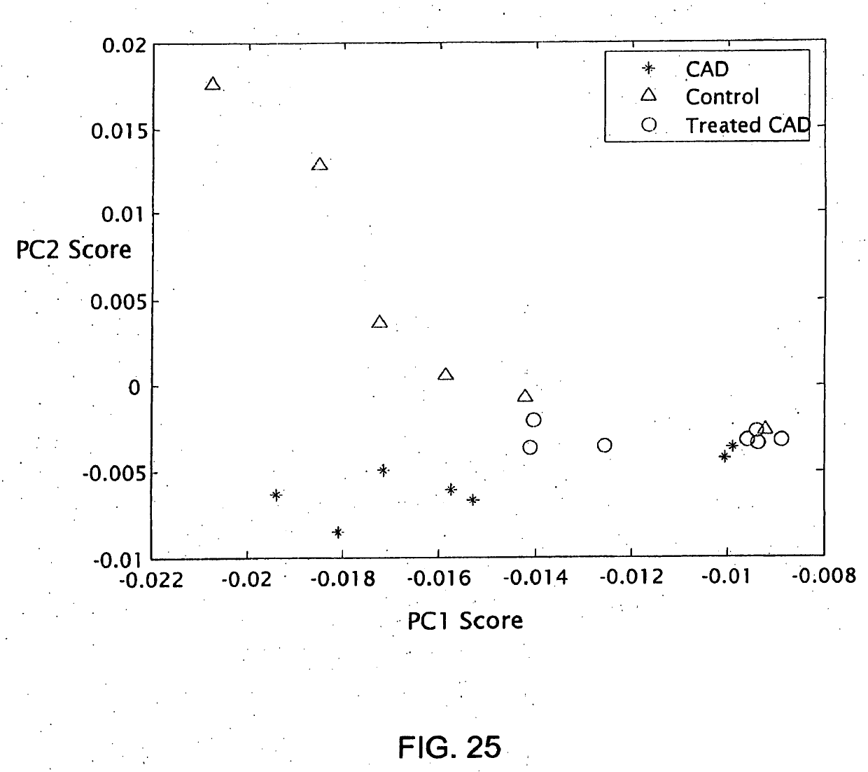

Samples were collected from each of the 7 CAD patients after the patients were treated with statins for one year. FIG. 25 shows the result of projecting these samples onto the first two PC of the CAD/control PCA model shown in FIG. 23. It is intriguing that the post-treatment sample clusters more close to the healthy controls on the second principal component score than the pre-treatment samples.

When treated samples were classified using the PLS-DA model built with pre-treatment and healthy control samples 4 of the seven samples calcified as CAD and 3 of the seven were considered unclassifiable, despite the fact that all of the CAD samples classified as CAD before treatment. This indicates that a change in the proteins bound to HDL occurred after treatment.

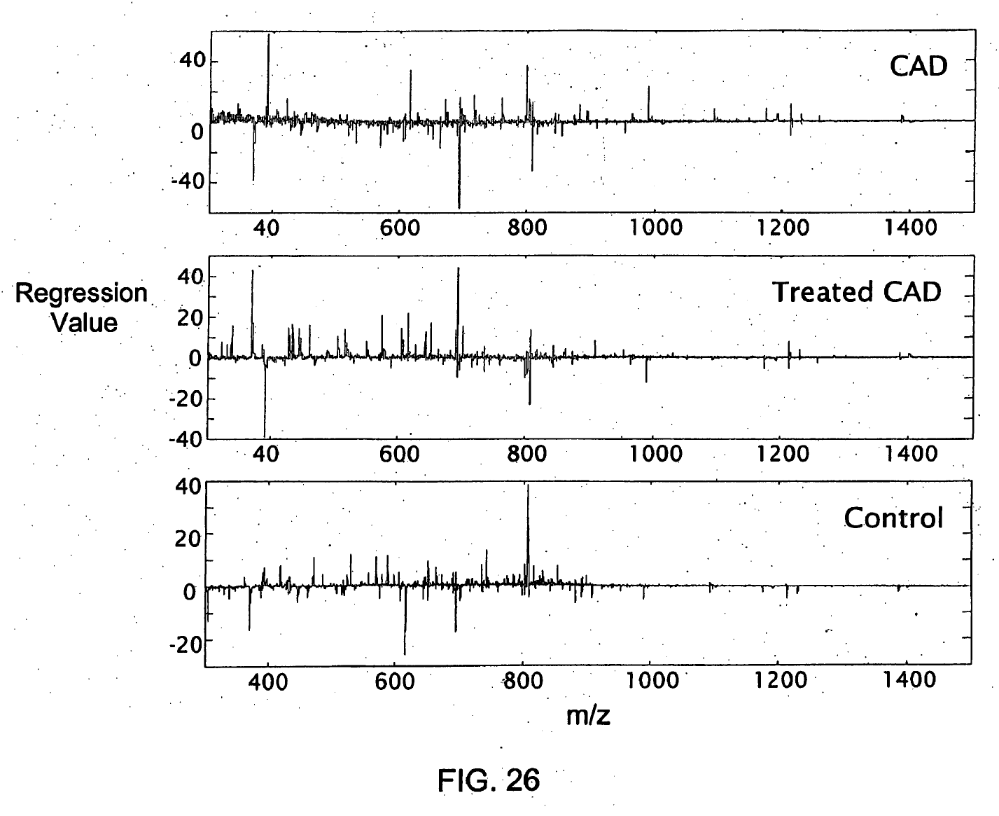

A three-class PLS-DA model was built with all the data. This model contained CAD, control and post-treatment samples (treated) classes. Like previous PLS-DA analysis a leave-one-out system was used to build models that did not contain the data being classified. Using these models all but 2 of the 20 samples classified correctly (90% accuracy). The accuracy of classification is very high given the number of factors that might affect the proteins bound to HLD in blood. The miss-classified samples were one CAD sample that was improperly classified as treated and one control sample that did not meet the threshold of any class and was thus deemed unclassifiable. The regression vectors for this model are shown in FIG. 26. Many of the major masses for the CAD and CON classes of the two-class regression model are also large in the three-component CAD and CON model. The major masses in the three-component model are more refined because the model attempts to distinguish one class from two others. Regression vectors reflect the class being predicted and the classes that are being distinguished. A comparison of the regression vectors from the two-class model and the three-class model might provide novel insights into how treatment with statins affects the proteins bound to HDL in blood.

In summary the data presented here suggests that the combination of pattern recognition and multidimensional separation tandem mass spectrometry can be used to classify samples as being a member of healthy controls, coronary artery disease or coronary artery disease patients treated with statins for a year. We have also showed a means that biomarker proteins, which discriminate the three classes, can be identified.

### Example 4

MALDI-MS Measurements of HDL Samples

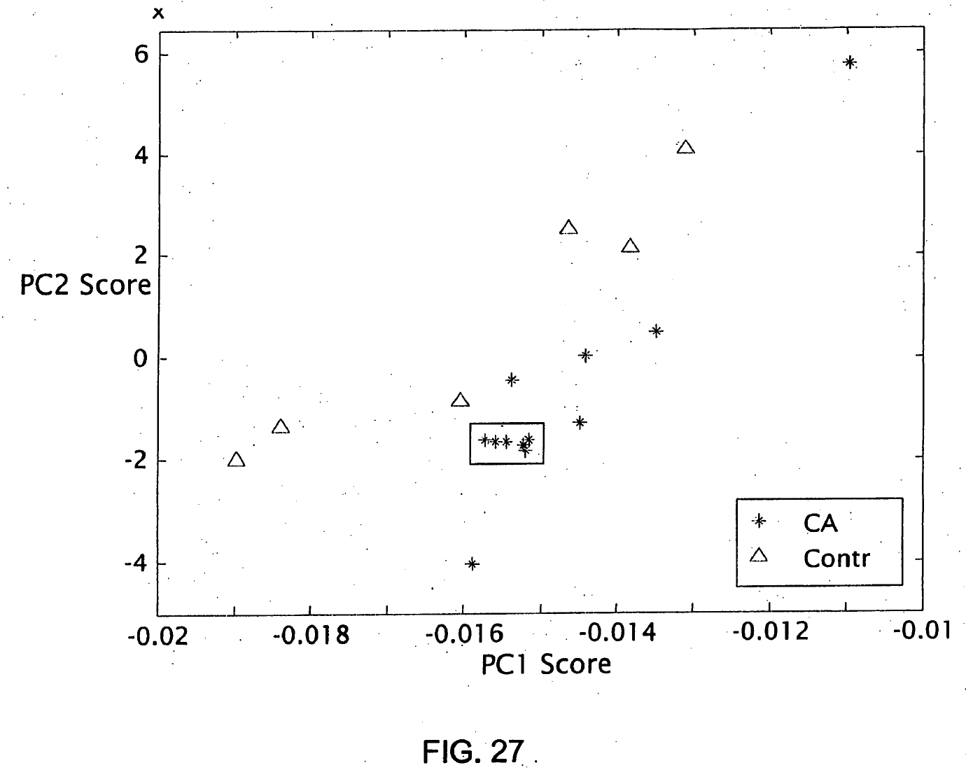

The samples that were measured with LC-ESI-MS/MS were also measured with MALDI-MS. FIG. 27 shows the results of a PCA analysis of CAD and control data from the MALDI-MS experiments. Like the LC-ESI-MS/MS analysis the CAD and control samples are separated on the PCA plot. In FIG. 27 the control samples are in the top-left half of the plot and the CAD samples are in the bottom right half. Reproducibility of the analytical measurement was also tested in the MALDI-MS experiments. The small box in FIG. 27 contains the results of 6 replicate analysis of a single CAD sample, this establishing the reproducibility of results from this type of analysis. The reproducibility of the CAD sample within the MALDI-MS experiment and the consistency of the pattern recognition results between LC-ESI-MS/MS and MALDI-MS verifies the use of pattern recognition with MS to identify CAD.

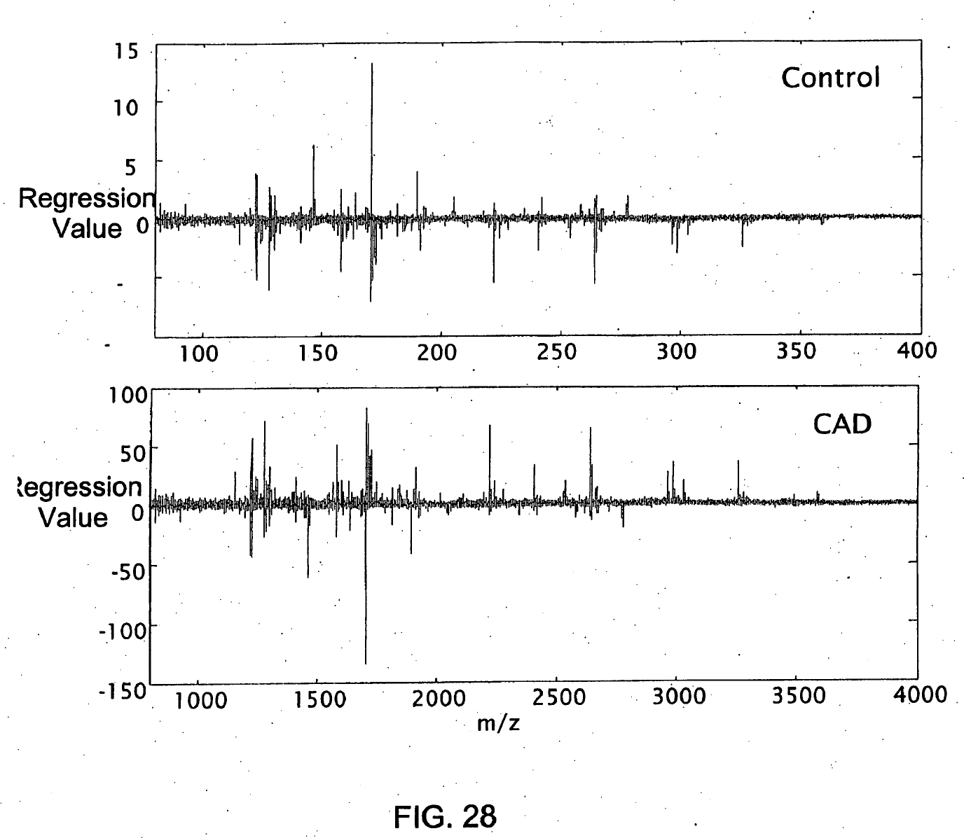

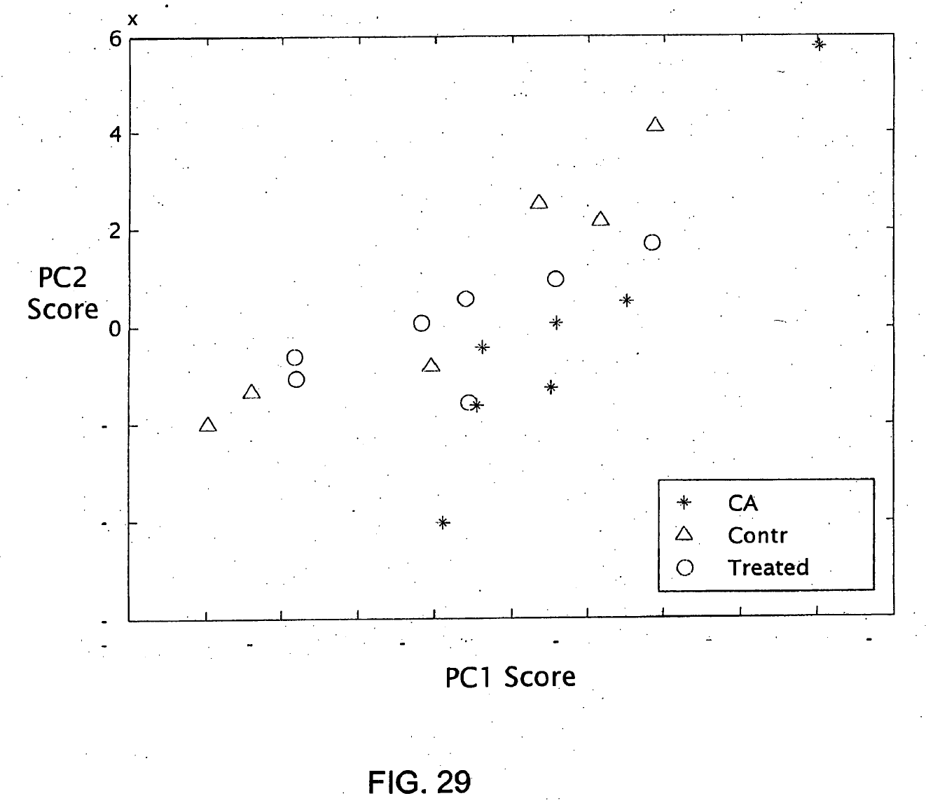

Supervised pattern recognition was done on the MALDI-MS samples using PLS-DA. With PLS-DA 17 of the 18 samples were correctly classified as either CAD or control samples (94% accuracy). The 18 samples were made up of 7 CAD samples, 5 replicates of one CAD sample and 6 control samples. This analysis used a leave-one-out method to build calibration models and replicates were not used in the calibration models. Like the LC-ESI-MS/MS experiments the single miss classified sample was a control sample that was classified as a CAD sample. Regression vectors from these experiments are shown in FIG. 28. Regression vectors from the MALDI-MS experiment can be used to identify masses for MALDI-TOFTOF. Notice that the LC-ESI-MS/MS and MALDI-MS experiments measured complimentary sections of the mass spectrum making it difficult to compare the regression vectors. Also, the differences in ionization energy make it difficult directly compare FIG. 24 and FIG. 28. Like the LC-ESI-MS/MS experiment the CAD and control regression vectors are nearly mirror images. Samples from CAD patients after treated were also analyzed with MALDI-MS. When treated samples were predicted using a PLS-DA model built from only CAD and control samples, four of the treated samples were classified as control samples, two were classified as CAD samples and one was unclassifiable. Thus the MALDI-MS model found the treated samples to be more like the control samples than the LC-ESI-MS/MS model, but both fond the treated samples to be between the CAD and control samples. FIG. 29 shows the result of projecting the treated samples onto the first two PC of the CAD/control PCA model shown in FIG. 27. Like the LC-ESI-MS/MS experiment post-treatment sample from the MALDI-MS experiments fall between the healthy controls and the pre-treatment samples.

### Example 5

Measure the Reproducibility of MALDI Measurements of HDL Samples

Ionization efficiency is known to vary in MALDI, which could confound pattern recognition. Consequently, it is important to measure the degree to which MALDI variability affects HDL protein data. We will address this problem by measuring the variability in the intensities of prominent peaks as well as low intensity peaks across replicate acquisitions from the same spot and from replicate spots. This information will be used to determine the number of replicate spectrum acquisitions and replicate spots required for reproducible MALDI HDL proteomics. We will also investigate the effect of the number of laser shots per spectrum on spectral reproducibility, to determine the least number of laser shots necessary to obtain reproducible spectra while preserving the sample for further analysis by tandem mass spectrometry. We will prepare 30 spots from a single HDL sample. Spectrum acquisitions will be performed at random locations on the spot surface until the spots show clear signs of degrading. The resulting data sets will be used to estimate the reproducibility and useful life of MALDI spots. We are also exploring the potential utility of using internal standard peptides (added to the matrix prior to MALDI) for calibrating the relative ionization efficiency of each analysis.

USEFUL SPOT LIFE The ion intensity of peaks representing high abundance peptides (S/N>100), medium abundance peptides (30<S/N<100) and low abundance peptides (S/N<30) over time will be measured to determine the number of laser shots a MALDI spot can withstand before degradation affects quantitative results. The remainder of the experiment will be conducted using data obtained from spots before degradation becomes apparent.

REPRODUCIBILITY AS A FUNCTION OF THE NUMBER OF LASER SHOTS The variability of peaks representing high abundance peptides (S/N>100), medium abundance peptides (30<S/N<100) and low abundance peptides (S/N<30) will be measured for each MALDI spot as a function of number of laser shots used to acquire the spectrum. Standard statistical measures will be used to determine the least number of laser shots required to adequately account for variability in desorption with acceptable confidence.

REPRODUCIBILITY WITHIN MALDI SPOTS The variability of peaks representing high abundance peptides (S/N>100), medium abundance peptides (30<S/N<100) and low abundance peptides (S/N<30) in replicate spectra acquired from the same spot will be measured. Standard statistical measures will be used to determine the least number of laser shots required to adequately account for variability in desorption with acceptable confidence.

REPRODUCIBILITY BETWEEN MALDI SPOTS The variability of peaks representing high abundance peptides (S/N >100), medium abundance peptides (30<S/N<100) and low abundance peptides (S/N<30) will be measured across several MALDI spots. Standard statistical measures will be used to determine the number of spots required to adequately account for variability in spot composition with acceptable confidence.

### Example 6

Predict MI Cases Via PEPI MALDI-TOF-MS Analysis of HDL Protein Composition

This aim determines whether MALDI is an appropriate ionization technique for pattern recognition of HDL proteins. HDL from Fletcher cases and controls will be spotted on MALDI plates. The plates will be analyzed via MALDI/TOF-MS. The resulting data will be analyzed using pattern recognition methods similar to those described in above.

DIRECT SPOTTING OF HDL DIGEST ON MALDI PLATES HDL samples will be directly spotted on MALDI plates, then analyzed via pattern recognition.

SPOT PLATES 60 HDL samples (30 cases and 30 matched controls) will be digested and desalted. The resulting eluent will be spotted onto a MALDI plate. Each sample will be spotted in replicate, using an optimal number of replicates.

ANALYZE SAMPLES VIA MALDI/TOF-MS Replicate spectra will be acquired from each spot, using an optimal number of acquisitions. Each spectrum will be internally calibrated using known peptides of apolipoprotein A-I, a major protein in HDL, to achieve a better than 5 ppm mass accuracy.

PRINCIPAL COMPONENT ANALYSIS Replicate spectra and spots will be summed. This process will be analogous to the S³MS process used for ESI data. PCA will be applied to the preprocessed spectra. The classification of HDL samples by PCA of MALDI/TOF-MS will be evaluated.

PARTIAL LEAST SQUARES PLS will be applied, using a leave-one-out approach. 60 data sets will be compiled, each containing data from 59 samples but lacking data from one of the samples. For each such data set, a PLS model will be built, predicting membership in classes. PLS using the model will then be used to predict the class of the left-out sample. The classification of samples by PLS of MALDI/TOF-MS will be evaluated.

MEASURE REPEATABILITY OF SPOTS To validate the utility of replicate spots, PCA and PLS will be applied to data from single MALDI spots. Each spot will be treated as a single sample, and all the acquisitions from that spot summed. Tight clustering of each group of replicate spots will suggest that replicate spots are redundant.

MEASURE REPEATABILITY OF SPECTRUM ACQUISITIONS To validate the utility of replicate spectrum acquisitions, we will apply PCA and PLS to subsets of the spectrum acquisitions per spot. Each acquisition will be treated as a single sample. Tight clustering of the replicate acquisitions from a single spot will suggest that replicate acquisitions are redundant.

LC-MALDI OF HDL DIGEST HDL samples will be digested and separated on reverse-phase capillary chromatography with direct deposition of the eluate onto a MALDI sample plate.

LC-MALDI OF HDL DIGEST Thirty-two HDL samples (16 cases and 16 matched controls) will be digested and separated on reverse-phase capillary chromatography with direct deposition of the eluate onto a MALDI sample plate in 5- to 10-second fractions. Chromatographic gradient will be optimized so that maximum resolution of eluting peptides is achieved. Appropriate MALDI matrix containing internal standard peptides will be added by a coaxial flow during the spot deposition. One MALDI plate will be used per sample. Each sample will be analyzed this way in replicate 3 times, for total of 96 plates.

ANALYZE SAMPLES VIA MALDI/TOF From each spot on the plate, replicate spectra will be acquired from each spot. Each spectrum will be internally calibrated using the internal standard peptides to achieve a better than 5 ppm mass accuracy. The spectra will be summed using the method described above. This will result one summary spectrum for each replicate of each sample.

PRINCIPAL COMPONENT ANALYSIS Replicate spectra and chromatographically separated fractions will be summed. This process will be analogous to the S³MS process used for ESI data. PCA will be applied to the preprocessed spectra. The classification of HDL samples by PCA of LC-MALDI/TOF-MS will be evaluated and compared to LC-ESI/MS and direct spotting MALDI/MS.

PARTIAL LEAST SQUARES PLS will be applied to the summed spectra, using a leave-one-out approach. 32 data sets will be compiled. Each data set will contain the data from one randomly selected replicate from 31 of the samples, but will lack any data from one of the samples. For each such data set, a PLS model will be built, predicting membership in classes. PLS using the model will then be used to predict the class of all three replicates of the left-out sample. The classification of samples by PLS of LC-MALDI/TOF-MS will be evaluated and compared to LC-ESI/MS and direct spotting MALDI/MS.

### Example 7

Identify Specific Proteins in HDL as Candidate Biomarkers for Predicting MI

IDENTIFY MASS CHANNELS THAT DIFFERENTIATE SAMPLE CLASSES PLS regression vectors will be examined to identify specific masses that differentiate classes.

IDENTIFY PEPTIDES RESPONSIBLE FOR DIFFERENTIATING MASS CHANNELS We will subject samples to MS/MS experiments, and use the resulting data to identify peptides. We will use the results of Examples 2 and 4 to select the most promising separation and ionization techniques for MS/MS identification of this biochemical system In PEPI, MS/MS will be restricted to the m/z values recognized by pattern recognition as distinguishing classes. Consequently, only peptides with masses corresponding to m/z values that were important in classifying the samples will be identified by MS/MS. Because identification will be restricted to a relatively small number of peptides, MS/MS coverage per run should be very high, and only one or two samples from each class should need to be analyzed. The resulting MS/MS data will be analyzed using SEQUEST or an equivalent peptide search program, and Peptide Prophet.

IDENTIFY PROTEINS CORRESPONDING TO DIFFERENTIATING PEPTIDES Conventional approaches will be used to identify the parent proteins of the identified peptides. The approaches used in the above Examples for cardiovascular disease will be followed herein.

### Example 8

Identification of Biomarkers in CSF

Ventricular or lumbar CSF will be obtained from patients with the disease and from controls. The controls will be CSF from benign tumor patients or from cancer patients, prior to surgery. A lipoprotein fraction of the CSF samples will be collected. Limiting the measurement to proteins from a fraction of the CSF simplifies the sample and improves the results.

Measure the CSF using proteomics techniques: trypsin digestion, SCX separation, μLC separation with survey scan MS detection. Various MS techniques can be used, including ESI and MALDI.

Apply pattern recognition, using PEPI technique described above, to the survey MS data to compare controls, pre-treatment, and post-treatment. There may be both pre- and post-treatment for the controls. Pattern recognition should be able to distinguish disease vs. control, and pre- vs. post-treatment. The pattern-recognition model is used to classify samples not used to build the model.

The model is mined for biological understanding. For example, pattern recognition techniques like PLS-DA produces a regression vector. The regression vector reveals the specific mass values that classify the samples. These mass values can be used directly, but the mass values are used to direct a second analysis of one or more sample from each class with tandem MS, to identify the peptides that explain the differences in samples, and hence the proteins. Chromatographic information can also be used to better direct the selection of MS peaks for tandem MS, and also to more strongly validate that the peptide identified is actually producing the observed peak in the regression vector.

The model can be refined. Knowledge of specific biological mechanisms may make it desirable to remove some mass channels from the model, or to compare the strength of classifications of some parts of the regression vector against other parts. This information can be used to refine the model.

The result of this method is a model that classifies samples and a list of proteins that show differential regulation in the course of disease and treatment. The model can be used to predict disease and treatment response, and may be useful in staging patients, measuring progression, and measuring treatment response. The list of proteins can be used to elucidate mechanisms and pathways by which the disease is expressed, and by which treatment operates. This elucidation can be used to understand why the model is predictive and gain confidence in the diagnostic power of the model. The list of proteins can be used to derive other, normally simpler diagnostics using techniques that are faster or less expensive that MS.

The model and list of proteins identified by the techniques described herein can also be used to evaluate the appropriateness of an animal model in studying a disease. A good animal model should show a similar pattern of disease expression to that in human. A treatment that shows promise in an animal model is more interesting if the affected protein levels are analogous to those involved in human. A promising response in an animal model can be evaluated by looking for a similar pattern of expression change in a phase 0 human trial.

1. A method of diagnosing a cardiovascular disease comprising:
evaluating a characteristic of a lipoprotein complex fraction of a biological sample from a subject, said evaluation comprising running said lipoprotein complex fraction through a matrix assisted laser desorption ionization (MALDI) mass spectrometer to obtain a mass spectrum and performing pattern recognition on said mass spectrum to obtain a biomarker pattern for said characteristic of said lipoprotein complex and
diagnosing a cardiovascular disease, wherein said diagnosis is based on said biomarker pattern.

2. The method of claim 1 wherein said cardiovascular disease is a predisposition to a myocardial infarction, atherosclerosis, coronary artery disease, peripheral artery disease, myocardial infarction, heart failure, or stroke.

3. The method of claim 1 wherein said diagnosis comprises a prediction of a potential response to a therapeutic intervention.

4. The method of claim 1 wherein said characteristic is an oxidative state of said lipoprotein complex.

5. The method of claim 1 wherein said characteristic is a pattern of peptides present on said lipoprotein complex.

6. The method of claim 1 wherein said biological sample is blood, serum, plasma, or urine.

7. The method of claim 1 wherein said lipoprotein complex is a high density lipoprotein, a very high density lipoprotein, a chylomicron, and/or a low density lipoprotein.

8. A method of diagnosing a brain disease comprising:
evaluating a characteristic of a lipoprotein complex fraction of a biological sample and
diagnosing a brain disease, wherein said diagnosis is based on said characteristic of said lipoprotein complex.

9. The method of claim 8 wherein said characteristic is an oxidative state of said lipoprotein complex.

10. The method of claim 8 wherein said characteristic is an oxidative state of high density lipoprotein.

11. The method of claim 8 wherein said characteristic is a pattern of peptides present on said lipoprotein complex.

12. The method of claim 8 wherein said evaluation of said lipoprotein complex fraction is performed with an immunoassay, a protein chip, multiplexed immunoassay, complex detection with aptamers, or chromatographic separation with spectrophotometric detection.

13. The method of claim 8 wherein said biological sample is blood, blood serum, blood plasma, urine, or cerebrospinal fluid.

14. The method of claim 8 wherein said brain disease is a cancer or a neurodegenerative disease.

15. The method of claim 14 wherein said neurodegenerative disease is Alzheimer's disease or Parkinson's disease.

16. The method of claim 14 wherein said cancer is a glioma, medulloblastoma, neuronal cancer, glial cancer, glioblastoma.

17. The method of claim 8 wherein said lipoprotein complex is a high density lipoprotein, a very high density lipoprotein, and/or a low density lipoprotein.

18. The method of claim 8 wherein said evaluation of said lipoprotein complex fraction comprises:
running said lipoprotein complex fraction through a mass spectrometer, wherein said mass spectrometer is run in survey mode;
summarizing two or more mass spectrum measurements from said survey run to obtain a summarized output spectrum;
performing pattern recognition on said summarized output spectrum to evaluate a characteristic of said lipoprotein complex.

19. The method of claim 8 wherein said evaluation of said lipoprotein complex fraction comprises performing MALDI on said lipoprotein complex fraction.

20. A method of identifying a biomarker pattern for a biological state comprising:
obtaining a biological sample, said biological sample obtained from a subject in a first biological state;
running said biological sample through a mass spectrometer, wherein said mass spectrometer collects survey mass spectra;
summarizing two or more survey mass spectra from said run to obtain a summary survey scan mass spectrum;
performing pattern recognition on said summary survey scan mass spectrum to identify a biomarker pattern; wherein said biomarker pattern is suitable for distinguishing said first biological state.

21. The method of claim 20 wherein said biological state is a disease state or a precursor to a disease state.

22. The method of claim 20 wherein said mass spectrometer is run in survey and/or tandem mode.

23. The method of claim 20 further comprising performing MALDI on said biological sample or a portion of said biological sample.

24. The method of claim 20 further comprising use of said pattern recognition information to identify a protein from said biomarker pattern.

25. The method of claim 24 wherein said identification of proteins is performed with tandem mass spectrometer or accurate mass tags.

26. A method of diagnosing a disease state of a subject comprising identifying said biomarker pattern of claim 20 and making a diagnosis of a disease state, wherein said biomarker pattern is suitable for diagnosing said disease state.

27. A method of diagnosing a disease state of a subject comprising identifying a protein of claim 24 and making a diagnosis of a disease state, wherein said protein is suitable for diagnosing said disease state.

28. The method of claim 27 wherein two or more proteins are identified.

29. The method of claim 27 wherein said identification of protein is performed with an immunoassay.

30. The method of claim 20 wherein said biological sample is blood, blood serum, blood plasma, or cerebrospinal fluid.

31. The method of claim 30 wherein said biological sample is a lipoprotein fraction from said subject.

32. The method of claim 32 wherein said lipoprotein fraction is digested prior to running through said mass spectrometer.

33. The method of claim 32 wherein said digestion is performed with an enzyme.

34. The method of claim 20 wherein said biological state is a cardiovascular disease, metabolic disease, or a brain disease.

35. The method of claim 34 wherein said brain disease is a cancer or a neurodegenerative disease.

36. The method of claim 35 wherein said neurodegenerative disease is Alzheimer's disease or Parkinson's disease.

37. The method of claim 35 wherein said cancer is a glioma, medulloblastoma, neuronal cancer, glial cancer, glioblastoma.

38. The method of claim 34 wherein said cardiovascular disease is atherosclerosis, coronary artery disease, peripheral artery disease, myocardial infarction, heart failure, or stroke.

39. A method of diagnosing a cardiovascular disease state of a patient comprising:
extracting high density lipoprotein from a biological sample from a patient;
running said high density lipoprotein through a mass spectrometer to obtain a mass spectrum;
performing pattern recognition on said mass spectrum to identify a biomarker pattern; and
diagnosing a cardiovascular state of said patient based on the identification of said biomarker pattern.

40. The method of claim 39 wherein said diagnosis is a prediction of the occurrence of a myocardial infarction, atherosclerosis, coronary artery disease, peripheral artery disease, myocardial infarction, heart failure, or stroke based on the identification of said biomarker pattern.

41. A diagnostic product for a disease state comprising at least one component adapted and configured for performing the method of claim 1, 8, 20, or 39.

42. A computer-readable medium comprising a medium suitable for transmission of a result of an analysis of a biological sample; said medium comprising an information regarding a state of a subject, wherein said information is derived using the method of claim 1, 8, 20, or 39.

43. A method of diagnosing a cardiovascular or brain disease of a patient comprising:
reviewing a biomarker pattern of a patient, said pattern comprising a characteristic of a lipoprotein complex fraction of a biological sample from said patient; and
providing an information regarding a cardiovascular disease or brain disease state to said patient, a health care provider or a health care manager, said information being based on said review of said biomarker pattern.
